(19) United States
(12) Patent Application Publication
(10) Pub. No.: US 2026/0346865 A1
(43) Pub. Date: Nov. 5, 2026

(54) DISTRIBUTED ARTIFICIAL INTELLIGENCE SYSTEM FOR AUTONOMOUS DRIVING WITH DISTILLATION-BASED RESOURCE ALLOCATION

(71) Applicant: CAVH LLC, Fitchburg, WI (US)

(72) Inventors: Bin Ran, Fitchburg, WI (US); Junwei You, Fitchburg, WI (US); Jingwen Zhu, Fitchburg, WI (US); Rui Gan, Fitchburg, WI (US); Weizhe Tang, Fitchburg, WI (US); Can Wang, Middleton, WI (US); Xiaoying Yi, Fitchburg, WI (US); Sicheng Fu, Fitchburg, WI (US); Yang Cheng, Middleton, WI (US); Junyi Ma, Fitchburg, WI (US); Jiaxi Liu, Fitchburg, WI (US); Yan Zhao, Fitchburg, WI (US); Xueqi Ding, Fitchburg, WI (US)

(21) Appl. No.: 19/645,411

(22) Filed: Apr. 13, 2026

Related U.S. Application Data
(60) Provisional application No. 63/788,588, filed on Apr. 14, 2025.

(51) Int. Cl. B60W 60/00; G06F 9/50; G06N 5/022; G06N 20/00

(52) U.S. Cl. CPC B60W 60/001; G06F 9/5094; G06N 5/022; G06N 20/00

(57) ABSTRACT

A distributed Artificial Intelligence (AI) system for an Autonomous Vehicle (AV) is disclosed. The system is hosted on a vehicle system and comprises an AI Allocation Subsystem and an Operating and Management Subsystem, which provide customized allocation of computing power, data, models, and parameters for vehicle-specific operation. A distillation framework is applied to refine trip parameters and AI driving models for optimized decision-making, efficient resource distribution, and real-time or dynamic updates. In some versions of the system, cloud-based large AI models perform knowledge extraction from extensive sensor data and generate soft labels and inference backups, while compact in-vehicle AI models receive compressed and quantized knowledge for real-time decision-making. This AI system supports personalized deployment, training, updating, and management across multiple system levels, and enables adaptive response to vehicle-specific scenarios, operational design domain (ODD) conditions, and unexpected long-tail events comprising construction and accidents.

### CROSS-REFERENCE TO RELATED APPLICATION

This application claims the benefit of U.S. Provisional Patent Application No. 63/788,588 filed Apr. 14, 2025, which is incorporated by reference herein in its entirety.

### FIELD

Provided herein is technology relating to autonomous driving systems, and more particularly, but not exclusively, to a Distributed Artificial Intelligence (AI) System configured to provide distributed, adaptive, customized, and personalized AI functionalities for autonomous vehicles or connected autonomous vehicles. Specifically, the distributed AI system comprises one or more of an AI model component, a computing power component, and a data component, and the distributed AI system is deployable across one or more of a vehicle system, a roadside unit (RSU) system, an edge system, a traffic control center/traffic control unit (TCC/TCU), and/or a cloud platform to enhance real-time decision-making, situational awareness, and system-wide intelligence.

### BACKGROUND

The evolution of autonomous driving has led to increasing demands on the safety, performance, reliability, and intelligence of onboard and offboard autonomous driving systems. Traditional AI architectures struggle to meet the latency, adaptability, and personalization needs of modern connected and autonomous vehicles (CAVs), especially under constraints such as limited onboard computing power, dynamic driving environments, and varying user preferences.

### SUMMARY

Accordingly, provided herein is a distributed artificial intelligence (AI) system for autonomous driving. The distributed AI system provides a scalable solution by distributing computation, models, and data across various platforms (e.g., from in-vehicle systems to cloud infrastructure) based on operational context and resource availability. By leveraging distributed intelligence and dynamic model allocation strategies, the systems described herein provide context-aware, trip-specific, route-specific, road-specific, operational design domain (ODD)-specific, and vehicle-specific customization of AI models. These features support high-performance execution of key driving functions such as sensing, perception, localization, fusion (e.g., data fusion), prediction, planning, decision, and control. Furthermore, through real-time and dynamic update mechanisms, the system enhances both adaptability and robustness in response to road conditions, traffic events, or system performance shifts. A coordinated allocation of computing power, data, parameters, and AI models ensures efficient resource utilization and fosters collaborative intelligence among vehicles, infrastructure, and cloud-based systems. This distributed AI approach marks a fundamental shift in how autonomous driving systems are designed, deployed, and operated for safety, efficiency, and personalization.

In some embodiments, a distributed Artificial Intelligence (AI) system for autonomous driving comprises one or more of an AI model component, a computing power component, and/or a data component.

In some embodiments, the AI system includes an AI allocation subsystem and an operating and management subsystem. The AI allocation subsystem comprises one or more of a computing allocation module, a data allocation module, a model allocation module, and/or a parameter allocation module. The operating and management subsystem comprises one or more of a coordination and optimization module and an execution module.

In some embodiments, the AI system comprises one or more of the following hardware components: a Communication Component, a Computing Component, a Power Supply Component, and/or a Sensing Component.

In some embodiments, the AI system can be hosted on one or more of the following components: a vehicle system, a roadside unit (RSU) system, an edge system, a traffic control center/traffic control unit (TCC/TCU), and/or a cloud platform.

In some embodiments, the AI system is configured to be customized and/or personalized for a vehicle, incorporating the AI allocation subsystem and the operating and management subsystem tailored for the specific vehicle. The personalized AI system can be trip-specific, route-specific, road-specific, operational design domain (ODD)-specific, and/or vehicle-specific. In some embodiments, the customized AI system applies a data distillation method to refine trip parameters for optimized decision-making. Customization can be based on user or trip priority, including factors such as fee payment and urgency.

In some embodiments, the AI model component comprises one or more of a mini model, a small model, a medium model, and/or a large model, which are determined and allocated based on system capabilities and requirements. The mini model and the small model are deployed in the vehicle system; and the mini model, the small model, and the medium model are deployed in the RSU and/or the edge systems. Furthermore, the mini model, the small model, the medium model, and the large model are deployed in the TCC/TCU and/or the cloud platform.

In some embodiments, the Model Allocation Module is configured to allocate and host these models as needed. The AI model component can be trained and deployed for a vehicle by the Cloud Platform and/or the Edge System using one of the following training and deployment methods: (a) both the trained model and the data are dynamically updated; (b) the trained model is deployed in a vehicle and updated in real-time, while the data are updated using a dynamic update method; (c) the trained model is deployed in a vehicle and updated dynamically, while the data are updated in real-time; and (d) both trained model and the data are updated simultaneously in real-time using an integrated training and deployment method.

In some embodiments, the AI model component supports integrated training and deployment through the RSU System, the Edge System, and/or the Cloud Platform, thereby facilitating personalized AI systems for autonomous vehicles.

In some embodiments, the Computing Power Allocation Module comprises one or more of a Static Computing Power Allocation Submodule and a Dynamic Computing Power Allocation Submodule. In some embodiments, the Computing Power Allocation Module integrates both Static and Dynamic Computing Power Allocation Submodules to achieve a hybrid strategy for computing resource management. The Static Submodule performs pre-trip assessments to identify available computing resources and forecasting expected demand based on planned routes and operational parameters. Complementarily, the Dynamic Submodule responds to real-time internal and external changes during vehicle operation and continuously adjusts allocations based on current computing power availability and situational requirements. This combined approach ensures both anticipatory and adaptive allocation of computing resources, thereby enhancing reliability and efficiency across diverse driving scenarios.

In some embodiments, the Static Computing Power Allocation Submodule conducts a pre-trip or periodically scheduled resource assessment. In some embodiments, the Static Computing Power Identification Unit enumerates all known computing resources that may be available to the vehicle, while in some embodiments the Computing Power Needs Identification Unit calculates the estimated load by analyzing sensor configuration, route complexity, ODD constraints, and any specialized AI algorithms employed by the vehicle.

In some embodiments, the Deficiency Computation Unit quantifies whether the onboard CPU/GPU can handle the load or if off-vehicle resources, such as idle vehicle GPUs or regional edge servers, are necessary; and in some embodiments, the Computing Power Allocation Unit performs a baseline allocation plan.

In some embodiments, the static computing power allocation is complemented by a vehicle-centric or vehicle-based computing platform that serves as the host environment for implementing the Static Computing Power Allocation Submodule, thereby ensuring that the vehicle maintains a functional baseline of computing capacity for safe operation when connectivity to the RSU or the cloud is lost.

In some embodiments, the Dynamic Computing Power Allocation Submodule is activated once the trip commences, and it continuously monitors both internal factors (using the Internal Change Identification Unit to detect variations in sensor states, battery levels, CPU/GPU loads) and external factors (using the External Change Identification Unit to evaluate variations such as traffic congestion, weather changes, and road conditions) to fine-tune the resource distribution.

In some embodiments, the Computing Power Needs Identification Unit recalculates the immediate or near real-time computing requirements of a vehicle autonomy stack. In some embodiments, e.g., if demand outstrips onboard resources, the Deficiency Computation Unit computes the shortfall in GPU cycles, CPU threads, or memory; and in some embodiments the Computing Power Allocation Unit promptly reallocates resources.

In some embodiments, the Distillation Unit personalizes the distribution of computing resources by factoring in route-specific, road-specific, vehicle-specific, trip-specific, and ODD-specific conditions, such that when the route transitions from a straightforward highway to a complex city center, the Distillation Unit redirects additional processing capacity toward advanced computer vision algorithms. In some embodiments, if the ODD expands to include nighttime operation in inclement weather, the Distillation Unit increases sensor data fusion tasks to ensure the GPU and the CPU allocations can handle inputs from thermal cameras, emergency brake assist logic, and overhead from streaming updates via 5G or satellite communication.

In some embodiments, the Vehicle-Specific Computing Power Resource Allocation Unit ensures that vehicles with unique hardware setups or usage profiles receive resource allocations best suited to their tasks; in some embodiments, the Route-Specific Computing Power Resource Allocation Unit optimizes allocations for segments with known complexities, such as mountain passes or busy urban corridors with frequent traffic light changes.

In some embodiments, the Road-Specific Computing Power Resource Allocation Unit manages computing distribution based on real-time feedback about road surface conditions, lane closures, or construction zones. In some embodiments, the ODD-specific Computing Power Resource Allocation Unit tailors computing resources, e.g., by switching from fully autonomous mode to driver-supervised mode in restricted areas when the operational design domain changes or by increasing real-time computations in heavy snow or severely reduced visibility conditions.

In some embodiments, advanced connectivity technologies such as 5G or 6G cellular, Bluetooth, Wi-Fi 6E, or satellite communication are provided to support the real-time reallocation of computing tasks. In some embodiments, e.g., if a sudden event-specific condition arises (e.g., a pop-up street fair blocking several downtown blocks), the External Change Identification Unit flags the situation; and in some embodiments the Distillation Unit quickly determines that GPU overhead (e.g., 5, 15, 20, 25, or 30% GPU overhead) is needed for frequent path recalculations.

In some embodiments, the synergy of the static and dynamic approaches provides a robust operational framework for all levels of autonomy and all ODDs. In some embodiments, by planning a foundational resource distribution (e.g., by verifying for each vehicle a baseline GPU usage, memory reservations, and fallback options to idle vehicle resources) and combining this with agile, on-the-fly adjustments, the system smoothly manages computational surges. In some embodiments, this agile distribution architecture ensures that even in worst-case or unexpected scenarios (e.g., extreme weather conditions or critical sensor malfunctions), no single vehicle is overwhelmed because the system leverages every available platform from the nearest RSU resources to a distant but highly capable cloud HPC service.

In some embodiments, the Data Allocation Module is responsible for managing and distributing two primary data categories: vehicle data and ODD data. The vehicle data encompasses various real-time and historical metrics, including speed, acceleration, braking activity, sensor outputs from LiDAR, radar, cameras, and ultrasonic sensors, and diagnostic insights such as mechanical conditions and predictive maintenance indicators powered by the AI. The ODD data includes environmental and contextual inputs including weather conditions, road surface quality, infrastructure features, and unexpected hazards, all of which influence vehicle operations. The system data contains communication protocols, metadata, transaction logs, and configuration settings that ensure synchronization, traceability, and the integrity of AI-driven decisions.

In some embodiments, the Data Allocation Module is configured for both Off-board and On-board Data Allocation Applications to facilitate efficient data distribution. For Off-board Data Allocation Application, the Data Allocation Module manages the bidirectional flow of data among vehicles, RSUs, edge devices, cloud platforms, and TCC, thereby providing system-wide awareness and coordination. For instance, traffic data collected by RSUs may be sent to the cloud for processing and then redistributed to vehicles via the Data Allocation Module. For On-board Data Allocation Application, the Data Allocation Module operates within individual vehicles and aggregates data from external entities and neighboring vehicles. The Data Allocation Module processes and redistributes this information to provide localized situational awareness, thereby allowing fleets to adjust their behavior dynamically in response to changing road conditions and hazards.

In some embodiments, the Data Allocation Module comprises several dedicated functional units: the Data Collection Unit, the Data Measurement Unit, the Data Allocation Unit, the Big Data Preprocessing Unit, and the Data Distillation Preparation Unit. These functional units provide high-quality, efficient data handling. The Data Collection Unit collects both onboard data and offboard data. The Data Measurement Unit evaluates properties such as data size, model size, update frequency, and detectability, which are important for resource allocation. These metrics are then used by the Data Allocation Unit to adjust allocation strategies dynamically based on real-time system conditions and by prioritizing safety-critical information and optimizing transmission according to network bandwidth, latency, and processing capacity.

In some embodiments, the Big Data Preprocessing Unit enhances data reliability by measuring data quality, cleaning data, removing duplicate data, and integrating inputs from multiple sources. The Data Distillation Preparation Unit further refines data for AI model training and validation through context-specific preparation components tailored to vehicle, route, road, ODD, and trip parameters. In some embodiments, the Data Allocation Module may reside in the vehicle, in the cloud, or across both, leveraging distillation methods to optimize relevance-driven data allocation for enhanced model performance and inference efficiency.

In some embodiments, the AI Model Component comprises a warehouse of AI models that encompasses various functional capabilities including sensing, perception, localization, fusion (e.g., data fusion), prediction, planning, decision-making, and control. The warehouse organizes these models into two primary categories: vehicle-based AI models optimized for onboard deployment and out-of-vehicle-based AI models designed for deployment on external platforms such as roadside units, edge systems, traffic control centers, or cloud platforms.

In some embodiments, the Model Allocation Module allocates AI models according to a mathematical framework expressed as M=F(V,OV), where M represents the output combination of AI models, V represents the set of vehicle-based AI models, OV represents the set of out-of-vehicle-based AI models, and F is a function determining how V and OV cooperate. This allocation framework ensures that the resulting model combination achieves the required level of automation while satisfying both safety requirements and computing resource constraints.

In some embodiments, the Model Allocation Module implements a hierarchical deployment strategy, placing large models on cloud platforms, medium models on edge systems, and small or mini models on vehicles. These models maintain continuous synchronization, with larger models performing comprehensive training and periodically updating the smaller models through knowledge distillation techniques, thereby creating an efficient distributed intelligence system.

In some embodiments, the Model Allocation Module supports distinct allocation methods: e.g., a vehicle-centric method that operates solely with onboard resources, a method for vehicles with out-of-vehicle data, a method for vehicles with out-of-vehicle computing resources, and a method combining both external data and computing resources. This flexibility allows adaptation to various operational scenarios and available infrastructure.

In some embodiments, the Model Allocation Module implements a comprehensive training and deployment method that operates across different host combinations, including vehicle-only, vehicle-cloud, or vehicle-edge-cloud configurations. This framework comprises allocation submodules that manage model deployment and training across these various platforms, thereby providing efficient utilization of distributed computing resources.

In some embodiments, the Model Allocation Module provides customization and personalization of models based on specific contexts, including user preferences, route characteristics, road conditions, vehicle specifications, operational design domains, and trip requirements. This personalization enhances performance and efficiency by tailoring the AI models to specific operational scenarios rather than using generic models for all situations.

In some embodiments, the Model Allocation Module utilizes a distillation method to support hierarchical knowledge transfer from the cloud to the edge and from the cloud/edge to the vehicle. This process begins with knowledge extraction on cloud platforms, progresses through edge model distillation, and culminates in adaptive distillation for vehicle models, with periodic synchronization ensuring that vehicles operate with the most recent, optimized AI configurations while maintaining safety margins.

In some embodiments, a Parameter Allocation Module is provided to facilitate the efficient collection, allocation, and update of parameters used in the distributed AI System for autonomous driving. The module may be hosted on one or more of the vehicle system, road system, edge system, TCC/TCU, and cloud system.

In some embodiments, the Parameter Allocation Module comprises one or more of a Parameter Collection Submodule, a Parameter Allocation Submodule, and a Parameter Update Submodule. This module supports handling of the following main categories of parameters: AI model parameters, vehicle parameters, and operational design domain (ODD) parameters. The AI model parameters include fundamental model parameters, training and optimization parameters, and deployment and adaptation parameters. The vehicle parameters include vehicle status parameters and operation information parameters. The ODD parameters include roadway parameters, objects parameters, and driving environment parameters.

In some embodiments, the Parameter Allocation Module applies customizable and personalized allocation strategies tailored to vehicle-specific, trip-specific, route-specific, road-specific, or ODD-specific driving scenarios. Parameter update and allocation decisions are made based on host system computing resources, operational constraints, user-defined priorities, and trip-specific requirements.

In some embodiments, the Parameter Allocation Module supports both real-time and dynamic parameter update methods, with update intervals ranging from milliseconds to days. A sequential update strategy may be employed to prioritize vehicle parameters, next to prioritize ODD parameters, and then to prioritize AI model parameters. The safety is ensured and prioritized by postponing updates unless the vehicle is in a safe operational state. This module ensures efficient and adaptive parameter management to support accurate perception, decision-making, and control in autonomous driving systems.

In some embodiments, the Operating and Management Subsystem comprises one or more of a Coordination and Optimization Module and an Execution Module. The Coordination and Optimization Module is configured to include a Coordination Submodule that organizes, manages, and sequences the execution of tasks based on the resources allocated to AI models, computing power, and data. The Coordination and Optimization Module also includes an Optimization Submodule to ensure that these allocated resources are used with maximized efficiency and that tasks are executed with maximized performance.

In some embodiments, the Coordination Submodule comprises a Task Management Unit, a Resource Matching Unit, a Priority Handling Unit, a Load Balancing Unit, and a Cluster Management Unit. In some embodiments, the Optimization Submodule comprises a Resource Scaling Unit, an Energy Optimization Unit, a Cost Optimization Unit, and a Performance Tuning Unit.

In some embodiments, the Coordination and Optimization Module is configured for integration into vehicles to manage AI models, computing power, and data to enhance overall system performance. The Coordination Submodule is configured to adjust vehicle AI model execution priorities dynamically based on real-time data from the vehicle operational state, including acceleration, braking, and navigation demands. In some embodiments, the Optimization Submodule is configured to reallocate computing power dynamically between safety-critical AI tasks such as collision avoidance and non-essential tasks, thereby maximizing overall system efficiency.

Some portions of this description describe the embodiments of the technology in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times to refer to these arrangements of operations as modules, without loss of generality. The described operations and their associated modules may be embodied in software, firmware, hardware, or any combinations thereof.

Certain steps, operations, or processes described herein may be performed or implemented with one or more hardware or software modules, alone or in combination with other devices. In some embodiments, a software module is implemented with a computer program product comprising a computer-readable medium containing computer program code, which can be executed by a computer processor for performing any or all steps, operations, or processes described.

In some embodiments, systems comprise a computer and/or data storage provided virtually (e.g., as a cloud computing resource). In particular embodiments, the technology comprises use of cloud computing to provide a virtual computer system that comprises the components and/or performs the functions of a computer as described herein. Thus, in some embodiments, cloud computing provides infrastructure, applications, and software as described herein through a network and/or over the internet. In some embodiments, computing resources (e.g., data analysis, calculation, data storage, application programs, file storage, etc.) are remotely provided over a network (e.g., the internet; and/or a cellular network).

Embodiments of the technology may also relate to an apparatus for performing the operations herein. This apparatus may be specially constructed for the required purposes (e.g., an application-specific integrated circuit or a field-programmable gate array) and/or it may comprise a general-purpose computing device (e.g., a microcontroller, microprocessor, and the like) selectively activated or reconfigured by a computer program stored in the computer. The apparatus may be configured to perform one or more steps, actions, and/or functions described herein, e.g., provided as instructions of a computer program. Such a computer program may be stored in a non-transitory, tangible computer readable storage medium or any type of media suitable for storing electronic instructions, which may be coupled to a computer system bus. Furthermore, any computing systems referred to in the specification may include a single processor or may be architectures employing multiple processor designs for increased computing capability.

Additional embodiments will be apparent to persons skilled in the relevant art based on the teachings contained herein.

### BRIEF DESCRIPTION OF THE DRAWINGS

These and other features, aspects, and advantages of the present technology will become better understood with regard to the following drawings.

FIG. 1 shows the Component Diagram of the AI System for Autonomous Driving.

FIG. 2 shows the Architecture of the AI System for Autonomous Driving.

FIG. 3 shows the Detailed Architecture of AI System for Autonomous Driving.

FIG. 4 shows the System Architecture of AI Allocation System for Autonomous Driving.

FIG. 5 shows the System Architecture of AI Allocation System for Autonomous Driving.

FIG. 6 shows the Diagram of Model Allocation Module.

FIG. 7 shows the Diagram of Model Allocation Module.

FIG. 8 shows the Diagram of Limitation of Vehicle Computing Capability.

FIG. 9A shows the Component Diagram of Communication Component (Advanced).

FIG. 9B shows the Component Diagram of Communication Component (Non-advanced).

FIG. 10A shows the Workflow of AI Model Allocation Module.

FIG. 10B shows the Workflow of AI Model Allocation Module.

FIG. 11 shows the Vehicle-Centric Static Computing Power Allocation Submodule.

FIG. 12 shows the Vehicle-Cloud Static Computing Power Allocation Submodule.

FIG. 13 shows the Vehicle-Road/Edge-Cloud Static Computing Power Allocation Submodule.

FIG. 14 shows the Vehicle-Centric Dynamic Computing Power Allocation Submodule.

FIG. 15 shows the Vehicle-Cloud Dynamic Computing Power Allocation Submodule.

FIG. 16 shows the Vehicle-Road/Edge-Cloud Dynamic Computing Power Allocation Submodule.

FIG. 17 shows the Workflow of Static Computing Power Allocation for Planning Purposes.

FIG. 18 shows the Workflow of Dynamic Computing Power Allocation for Real-Time Vehicle Operation.

FIG. 19 shows the Data Allocation Module in Off-board Data Allocation Application Scenario

FIG. 20 shows the Data Allocation Module in On-board Data Allocation Application Scenario

FIG. 21 shows the Data Collection Unit.

FIG. 22 shows the Data Measurement Unit.

FIG. 23 shows the Data Allocation Unit.

FIG. 24 shows the Big Data Preprocessing Unit.

FIG. 25 shows the Distillation Preparation Unit.

FIG. 26 shows the Data Allocation System Hardware.

FIG. 27 shows the Big Data Preprocessing flow chart.

FIG. 28 shows the Vehicle Cloud Data Allocation flow chart for training.

FIG. 29 shows the Vehicle Road Cloud Data Allocation flow chart for training.

FIG. 30 shows the Vehicle Cloud Data Allocation flow chart for inference.

FIG. 31 shows the Vehicle Road Cloud Data Allocation flow chart for inference.

FIG. 32 shows the Component Diagram of Large AI Driving Model.

FIG. 33 shows the Component Diagram of Medium AI Driving Model.

FIG. 34 shows the Component Diagram of Small AI Driving Model.

FIG. 35 shows the Component Diagram of Mini AI Driving Model.

FIG. 36A shows the General Equation of AI Driving Model Allocation.

FIG. 36B shows the Warehouse of AI models.

FIG. 37 shows the flowchart for AI Model Allocation Module Deployment Process.

FIG. 38 shows the flowchart for AI Model Allocation Module Configuration Process.

FIG. 39 shows the example of AI Model Allocation Module Deployment and Configuration.

FIG. 40 shows the example of AI Model Allocation Module Deployment and Configuration at S1 level.

FIG. 41 shows the components of Small AI Model.

FIG. 42 shows the components of Large AI Model.

FIG. 43 shows the components of Distilled Medium AI Model.

FIG. 44 shows the information flow in the case of Vehicle and Cloud cooperation.

FIG. 45 shows the information flow in the case of Vehicle, Edge and Cloud cooperation.

FIG. 46 shows the Vehicle-centric AI Model Allocation Module for Autonomous Driving.

FIG. 47 shows the Vehicle-centric and Out-of-vehicle data AI Model Allocation Module for Autonomous Driving.

FIG. 48 shows the Vehicle-centric and Out-of-vehicle Computing AI Model Allocation Module for Autonomous Driving.

FIG. 49 shows the Vehicle-centric with Out-of-vehicle Computing and Data AI Model Allocation Module for Autonomous Driving.

FIG. 50 shows the Vehicle Operation Process with Roadside System Integration and Adaptive Cloud-Platform Support.

FIG. 51 shows the Multi-Computing Resource Strategy for Vehicle Operation and Control under Varying Hardware Capabilities.

FIG. 52 shows the Vehicle Operation Process with Roadside and Cloud Computing Integration for Optimal Control.

FIG. 53 shows the Dynamic Vehicle Control System Leveraging Vehicle, Roadside, and Cloud Computing for Efficient Operation.

FIG. 54 shows an example of Dynamic Vehicle Control System.

FIG. 55 shows the Vehicle-centric AI Driving Model Deployment Allocation Subsystem.

FIG. 56 shows the Vehicle-Cloud AI Driving Model Deployment Allocation Subsystem.

FIG. 57 shows the Vehicle-Edge-Cloud AI Driving Model Deployment Allocation Subsystem.

FIG. 58 shows the Vehicle-centric AI Driving Model Training Allocation Subsystem.

FIG. 59 shows the Vehicle-Cloud AI Driving Model Training Allocation Subsystem.

FIG. 60 shows the Vehicle-Edge-Cloud AI Driving Model Training Allocation Subsystem.

FIG. 61 shows the components of Parameter Allocation Module.

FIG. 62 shows the process of using Parameter Allocation Module to provide parameter allocation and update.

FIG. 63 shows the process of using Parameter Collection Submodule to provide collection and statistics of parameters.

FIG. 64 shows the flowchart for Parameter Allocation Submodule.

FIG. 65 shows the exemplary parameter allocation flowchart for parameters with a scale of more than 1 billion.

FIG. 66 shows the exemplary parameter allocation flowchart for parameters with a scale from 100 million to 1 billion.

FIG. 67 shows the exemplary parameter allocation flowchart for parameters with a scale from 5 million to 100 million.

FIG. 68 shows the exemplary parameter allocation flowchart for parameters with a scale of less than 5 million.

FIG. 69 shows the flowchart for Parameter Update Submodule.

FIG. 70 shows the Architecture of the Coordination and Optimization Module.

FIG. 71 shows the Architecture of the Coordination Submodule.

FIG. 72 shows the Architecture of the Optimization Submodule.

FIG. 73 shows the Flowchart of the Coordination and Optimization Module.

NUMBERED FEATURES

101 AI System for Autonomous Driving
102 Computing Power Component
103 AI Model Component
104 Data Component
201 AI System for Autonomous Driving
202 AI Allocation Subsystem
203 Operating and Management Subsystem
301 AI System for Autonomous Driving
302 AI Allocation Subsystem
303 Operating and Management Subsystem
304 Computing Power Allocation Module
305 Data Allocation Module
306 Model Allocation Module
307 Parameter Allocation Module
308 Coordination and Optimization Module
309 Execution Module
401 AI Allocation System for Autonomous Driving
402 Computing Power Allocation Module
403 Data Allocation Module
404 Model Allocation Module
405 Parameter Allocation Module
406 Hosted
407 Vehicle System
408 Cloud Platform
501 AI Allocation System for Autonomous Driving
502 Computing Power Allocation Module
503 Data Allocation Module
504 Model Allocation Module
505 Parameter Allocation Module
506 Hosted
507 Vehicle System
508 RSU System
509 Edge System
510 TCC/TCU
511 Cloud Platform
601 Model Allocation Module
602 Large Model
603 Medium Model
604 Small Model
605 Mini Model
606 Deployed
607 Vehicle System
608 Cloud Platform
701 Model Allocation Module
702 Large Model
703 Medium Model
704 Small Model
705 Mini Model
706 Deployed
707 Vehicle System
708 RSU System and Edge System
709 TCC/TCU and Cloud Platform
801 Limitation of Vehicle Computing Capability
802 Power Supply
803 Cooling System
804 Cost
805 Computing Processing Power
901 Communication Component AI System (with advanced networks)
902 Communication Component AI System (without advanced networks)
903 3G
904 4G
905 5G
906 6G
907 Digital Radio
908 Wi-Fi
909 Bluetooth
910 Satellite
1101 Static Computing Power Allocation Submodule
1102 Static Computing Power Identification Unit
1103 Computing Power Needs Identification Unit
1104 Deficiency Computation Unit
1105 Computing Power Allocation Unit
1106 Vehicle-Centric Computing Platform
1107 Desired Vehicle Computing Resources
1108 Desired RSU Computing Resources
1109 Desired Edge Computing Resources
1110 Desired Cloud Computing Resources
1111 Desired TCC Computing Resources
1112 Ego Vehicle Computing Resources
1113 Idle Vehicle Computing Resources
1114 Host
1115 Allocate
1201 Static Computing Power Allocation Submodule
1202 Static Computing Power Identification Unit
1203 Computing Power Needs Identification Unit
1204 Deficiency Computation Unit
1205 Computing Power Allocation Unit
1206 Vehicle-Based Computing Platform
1207 Cloud-Based Computing Platform
1208 Desired Vehicle Computing Resources
1209 Desired Cloud Computing Resources
1210 Ego Vehicle Computing Resources
1211 Idle Vehicle Computing Resources
1212 Host
1213 Allocate
1301 Static Computing Power Allocation Submodule
1302 Static Computing Power Identification Unit
1303 Computing Power Needs Identification Unit
1304 Deficiency Computation Unit
1305 Computing Power Allocation Unit
1306 Vehicle-Based Computing Platform
1307 RSU-Based Computing Platform
1308 Edge-Based Computing Platform
1309 Cloud-Based Computing Platform
1310 TCC-Based Computing Platform
1311 Desired Vehicle Computing Resources
1312 Desired RSU Computing Resources
1313 Desired Edge Computing Resources
1314 Desired Cloud Computing Resources
1315 Desired TCC Computing Resources
1316 Ego Vehicle Computing Resources
1317 Idle Vehicle Computing Resources
1318 Host
1319 Allocate
1401 Dynamic Computing Power Allocation Submodule
1402 Supply
1403 Internal Change Identification Unit
1404 Usable Computing Power Identification Unit
1405 Demand
1406 External Change Identification Unit
1407 Computing Power Needs Identification Unit
1408 Deficiency Computation Unit
1409 Distillation Unit
1410 Vehicle-Specific Computing Power
Resource Allocation Unit for a Vehicle
1411 Route-Specific Computing Power
Resource Allocation Unit for a Vehicle
1412 Road-Specific Computing Power
Resource Allocation Unit for a Vehicle
1413 Vehicle-Centric Computing Platform
1414 Desired Vehicle Computing Resources
1415 Desired RSU Computing Resources
1416 Desired Edge Computing Resources
1417 Desired Cloud Computing Resources
1418 Desired TCC Computing Resources
1419 Ego Vehicle Computing Resources
1420 Idle Vehicle Computing Resources
1421 Host
1422 Allocate
1501 Dynamic Computing Power Allocation Submodule
1502 Supply
1503 Internal Change Identification Unit
1504 Usable Computing Power Identification Unit
1505 Demand
1506 External Change Identification Unit
1507 Computing Power Needs Identification Unit
1508 Deficiency Computation Unit
1509 Distillation Unit
1510 Vehicle-Specific Computing Power
Resource Allocation Unit for a Vehicle
1511 Route-Specific Computing Power
Resource Allocation Unit for a Vehicle
1512 Road-Specific Computing Power
Resource Allocation Unit for a Vehicle
1513 Vehicle-Based Computing Platform
1514 Cloud-Based Computing Platform
1515 Desired Vehicle Computing Resources
1516 Desired Cloud Computing Resources
1517 Ego Vehicle Computing Resources
1518 Idle Vehicle Computing Resources
1519 Host
1520 Allocate
1601 Dynamic Computing Power Allocation Submodule
1602 Supply
1603 Internal Change Identification Unit
1604 Usable Computing Power Identification Unit
1605 Demand
1606 External Change Identification Unit
1607 Computing Power Needs Identification Unit
1608 Deficiency Computation Unit
1609 Distillation Unit
1610 Vehicle-Specific Computing Power
Resource Allocation Unit for a Vehicle
1611 Route-Specific Computing Power
Resource Allocation Unit for a Vehicle
1612 Road-Specific Computing Power
Resource Allocation Unit for a Vehicle
1613 Vehicle-Based Computing Platform
1614 RSU-Based Computing Platform
1615 Edge-Based Computing Platform
1616 Cloud-Based Computing Platform
1617 TCC-Based Computing Platform
1618 Desired Vehicle Computing Resources
1619 Desired RSU Computing Resources
1620 Desired Edge Computing Resources
1621 Desired Cloud Computing Resources
1622 Desired TCC Computing Resources
1623 Ego Vehicle Computing Resources
1624 Idle Vehicle Computing Resources
1625 Host
1626 Allocate
1901 Off-Board Data Allocation Submodule
1902 Data Collection Unit
1903 Data Measurement Unit
1904 Big Data Preprocessing Unit
1905 Data Allocation Unit
1906 Distillation Preparation Unit
1907 Vehicle
1908 RSU
1909 Edge
1910 Cloud
1911 TCC
1912 Vehicle
1913 RSU
1914 Edge
1915 Cloud
1916 TCC
1917 Allocate
1918 Host
2001 Off-Board Data Allocation Submodule
2002 Data Collection Unit
2003 Data Measurement Unit
2004 Big Data Preprocessing Unit
2005 Data Allocation Unit
2006 Distillation Preparation Unit
2007 Vehicle
2008 Vehicle
2009 RSU
2010 Edge
2011 Cloud
2012 TCC
2013 Allocate
2014 Host
2101 Data Collection Unit
2102 Offboard Data Collection Subunit
2103 Onboard Data Collection Subunit
2201 Data Measurement Unit
2202 Detectable Data Identification Component
2203 Data Sizing Component
2204 Model Sizing Component
2205 Update Frequency Determination Component
2301 Data Allocation Unit
2302 Data Management Component
2303 Data Allocation Strategy Component
2401 Data Preprocessing Unit
2402 Data Quality Measurement Component
2403 Data Preprocessing Component
2404 Data Fusion Component
2501 Distillation Preparation Unit
2502 Vehicle Specific Data Preparation Component
2503 Route Specific Data Preparation Component
2504 Road Specific Data Preparation Component
2505 ODD Specific Data Preparation Component
2506 Trip Specific Data Preparation Component
2601 Data Allocation System Hardware
2602 Data Storage
2603 Ram
2604 CPU
2605 GPU
3201 Large AI model
3202 Perception
3203 Sensing
3204 Localization
3205 Fusion
3206 Prediction
3207 Decision
3208 Planning
3209 Control
3210 Vehicle-specific model allocation unit
3211 Route-specific model allocation unit
3212 Distillation unit
3301 Medium AI model
3302 Perception
3303 Sensing
3304 Localization
3305 Fusion
3306 Prediction
3307 Decision
3308 Planning
3309 Control
3310 Vehicle - specific model allocation unit
3311 Route - specific model allocation unit
3312 Distillation unit
3401 Small AI model
3402 Perception
3403 Sensing
3404 Localization
3405 Fusion
3406 Prediction
3407 Decision
3408 Planning
3409 Control
3410 Vehicle - specific model allocation unit
3411 Route - specific model allocation unit
3412 Distillation unit
3501 Mini AI model
3502 Perception
3503 Sensing
3504 Localization
3505 Fusion
3506 Prediction
3507 Decision
3508 Planning
3509 Control
3510 Vehicle - specific model allocation unit
3511 Route - specific model allocation unit
3512 Distillation unit
3601 Warehouse of AI models
3602 Deep-learning models
3603 AI agents models
3604 Reinforcement learning models
3605 Generative models
3606 Foundation models
3607 Swarm intelligence models
3608 V (vehicle-based AI models)
3609 OV (out-of-vehicle-based AI models)
3901 Vehicle-system
3902 Traffic control center
3903 Edge
3904 RSU-system
3905 Cloud-platform
3906 Sensing
3907 Perception
3908 Localization
3909 Fusion
3910 Prediction
3911 Planning
3912 Decision-making
3913 Control
4001 Vehicle-system
4002 Sensing
4003 Perception
4004 Localization
4005 Fusion
4006 Prediction
4007 Planning
4008 Decision-making
4009 Control
4010 RSU-system
4011 Cloud-platform
4101 Small AI model
4102 Application
4103 Perception
4104 Localization
4105 Prediction
4106 Decision
4107 Control
4108 Fusion
4109 Deployment Location
4110 Vehicle-system
4111 RSU-system
4112 Cloud-platform
4113 Model Parameters
4114 Less than 1 billion
4115 Safety-critical tasks
4116 Priority
4117 Hardware Requirement
4118 Vehicle Computing Platform
4119 Input
4120 Vehicle perception data
4121 Out of vehicle data
4122 Vehicle status data from CAN
4123 Data from cloud communication
4201 Large AI model
4202 Application
4203 Base applications of AI model
4204 Perception
4205 Localization
4206 Prediction
4207 Decision
4208 Control
4209 Fusion
4210 Enhanced applications of Large AI model
4211 Macro prediction
4212 Parallel Decision
4213 Multi-source Data Fusion
4214 Big Data Analysis
4215 Traffic Signal Control
4216 Deployment Location
4217 Cloud-platform
4218 Model Parameters
4219 More than 7 billion
4220 Priority
4221 Agent-based
4222 Hardware Requirement
4223 Cloud clusters
4224 Input
4225 Multi-source detected data
4226 Traffic memories
4227 Human instructions
4228 Cloud built in data
4301 Distilled Medium AI model
4302 Application
4303 Base applications of AI model
4304 Perception
4305 Localization
4306 Prediction
4307 Decision
4308 Control
4309 Fusion
4310 Enhanced applications of medium AI model
4311 Meso Prediction
4312 Parallel Decision
4313 Cooperative control
4314 Cooperative perception
4315 Applications inherited from Large AI model
4316 Parallel Decision
4317 Multi Source Data Fusion
4318 Traffic Signal Control
4319 Deployment Location
4320 Cloud platform
4321 RSU system
4322 Model Parameters
4323 Between 1 billion and 7 billion
4324 Priority
4325 Agent based
4326 Hardware Requirement
4327 Edge platform
4328 Input
4329 Multi source detected data
4330 Knowledge from large model
4331 Human instructions
4332 Edge built in data
4401 Cloud
4402 Large AI model
4403 Real-time data acquisition
4404 Periodic Synchronization
4405 Vehicle
4406 Small AI model
4407 Vehicle perception data, Vehicle status data
4501 Cloud
4502 Large AI model
4503 Inference results backup
4504 Inference correction, Knowledge training
4505 Edge
4506 Distilled medium AI model
4507 Real-time data acquisition
4508 Periodic Synchronization
4509 Vehicle
4510 Small AI model
4511 Model backup when medium model down
4512 Vehicle perception data, Vehicle status data
4601 Vehicle - centric configuration
4602 Perception
4603 Sensing
4604 Localization
4605 Fusion
4606 Prediction
4607 Decision
4608 Planning
4609 Control
4701 Vehicle and Out-of-vehicle data configuration
4702 Perception (on board)
4703 Sensing (on board)
4704 Localization (on board)
4705 Fusion (on board)
4706 Prediction (on board)
4707 Decision (on board)
4708 Planning (on board)
4709 Control (on board)
4710 Out-of-range Sensing
4711 Data Fusion
4712 Prediction
4713 Decision
4714 Planning
4715 Control
4716 Raw Data
4717 Fused Data
4718 Processed Data
4801 Vehicle and Out-of-vehicle computing configuration
4802 Perception (on board)
4803 Sensing (on board)
4804 Localization (on board)
4805 Fusion (on board)
4806 Prediction (on board)
4807 Decision (on board)
4808 Planning (on board)
4809 Control (on board)
4810 Out-of-range Sensing
4811 Data Fusion
4812 Prediction
4813 Decision
4814 Planning
4815 Control
4816 Idle Vehicles (computing resource)
4817 Cloud/Edge servers
4818 Cloud platform
4901 Vehicle and Out-of-vehicle computing/data configuration
4902 Perception (on board)
4903 Sensing (on board)
4904 Localization (on board)
4905 Fusion (on board)
4906 Prediction (on board)
4907 Decision (on board)
4908 Planning (on board)
4909 Control (on board)
4910 Out-of-range Sensing
4911 Data Fusion
4912 Prediction
4913 Decision
4914 Planning
4915 Control
4916 Idle Vehicles (computing resource)
4917 Cloud/Edge
4918 Cloud platform
4919 Raw Data
4920 Fused Data
4921 Processed Data
5401 Extreme Weather
5402 Vehicle Computing
5403 OV Roadside Computing
5404 OV Cloud Computing
5501 Vehicle-centric Model Deployment Allocation Subsystem
5502 Input Analysis Module
5503 Hardware Capability Verification Module
5504 Distillation Unit
5505 Cloud-Edge Coordination Module
5506 Allocation Execution Module
5507 Vehicle-specific model allocation unit
5508 Route-specific model allocation unit
5509 Vehicle Platform
5510 Allocate instruction mechanism
5511 Hosted indicator
5512 Vehicle
5601 Vehicle-Cloud Model Deployment Allocation Subsystem
5602 Input Analysis Module
5603 Hardware Capability Verification Module
5604 Distillation Unit
5605 Cloud-Edge Coordination Module
5606 Allocation Execution Module
5607 Vehicle-specific model allocation unit
5608 Route-specific model allocation unit
5609 Vehicle Platform
5610 Allocate instructions
5611 Cloud Platform
5612 Hosted indicator
5613 Vehicle
5614 Cloud
5701 Vehicle-Edge-Cloud Deployment Allocation Subsystem
5702 Input Analysis Module
5703 Hardware Capability Verification Module
5704 Distillation Unit
5705 Cloud-Edge Coordination Module
5706 Allocation Execution Module
5707 Vehicle-specific model allocation unit
5708 Route-specific model allocation unit
5709 Vehicle Platform
5710 Allocate instructions
5711 Edge Platform
5712 Another Vehicle Platform
5713 Hosted indicator
5714 Vehicle
5715 Edge
5716 Cloud
5801 Vehicle-centric Model Training Allocation Subsystem
5802 Input Analysis Module
5803 Scenario-Aware Model Allocation Module
5804 Vehicle-specific model allocation unit
5805 Hardware Capability Verifier Module
5806 Cloud-Edge Coordination Module
5807 Route-specific model allocation unit
5808 Resource Calling Module
5809 Allocation Execution Module
5810 Distillation Unit
5811 Vehicle Platform
5812 Out-of-range Input
5813 Model allocation instructions
5814 Hosted indicator
5815 Vehicle-based Training
5901 Vehicle-Cloud Model Training Allocation Subsystem
5902 Input Analysis Module
5903 Scenario-Aware Model Allocation Module
5904 Vehicle-specific model allocation unit
5905 Hardware Capability Verifier Module
5906 Cloud-Edge Coordination Module
5907 Route-specific model allocation unit
5908 Resource Calling Module
5909 Allocation Execution Module
5910 Distillation Unit
5911 Vehicle Platform
5912 Out-of-range Input
5913 Cloud Platform
5914 Allocate commands
5915 Hosted indicator
5916 Vehicle-based Training
5918 Cloud-based Training
6001 Vehicle-Edge-Cloud Model
Training Allocation Subsystem
6002 Input Analysis Module
6003 Scenario-Aware Model Allocation Module
6004 Vehicle-specific model allocation unit
6005 Hardware Capability Verifier Module
6006 Cloud-Edge Coordination Module
6007 Route-specific model allocation unit
6008 Resource Calling Module
6009 Allocation Execution Module
6010 Distillation Unit
6011 Vehicle Platform
6012 Edge Platform
6013 Cloud Platform
6014 Out-of-range Input
6015 Allocate instructions
6016 Hosted indicator
6017 Vehicle-based Training
6018 Edge-based Training
6019 Cloud-based Training
6101 Parameter Allocation Module
6102 Parameter Collection Submodule
6103 Parameter Allocation Submodule
6104 Parameter Update Submodule
6105 Parameter Collection Unit
6106 Parameter Statistics Unit
6107 Computing Power Resource Unit
6108 Parameter Allocation Unit
6109 Vehicle Parameter Update Unit
6110 ODD Parameter Update Unit
6111 AI Model Parameter Update Unit
6112 Parameter Update Progress Unit
7001 Coordination and Optimization Module
7002 Coordination Submodule
7003 Optimization Submodule
7101 Coordination Submodule
7102 Task Management Unit
7103 Resource Matching Unit
7104 Priority Handling Unit
7105 Load Balancing Unit
7106 Cluster Management Unit
7201 Optimization Submodule
7202 Resource Scaling Unit
7203 Energy Optimization Unit
7204 Cost Optimization Unit
7205 Performance Tuning Unit

### DETAILED DESCRIPTION

Provided herein is technology relating to autonomous driving systems, and more particularly, but not exclusively, to a Distributed Artificial Intelligence (AI) System configured to provide distributed, adaptive, customized, and personalized AI functionalities for autonomous vehicles or connected autonomous vehicles. Specifically, the distributed AI system comprises one or more of an AI model component, a computing power component, and a data component, and the distributed AI system is deployable across one or more of a vehicle system, a roadside unit (RSU) system, an edge system, a traffic control center/traffic control unit (TCC/TCU), and/or a cloud platform to enhance real-time decision-making, situational awareness, and system-wide intelligence.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless defined otherwise, all technical and scientific terms used herein have the same meaning as is commonly understood by one of ordinary skill in the art to which the various embodiments described herein belongs. When definitions of terms in incorporated references appear to differ from the definitions provided in the present teachings, the definition provided in the present teachings shall control. The section headings used herein are for organizational purposes only and are not to be construed as limiting the described subject matter in any way.

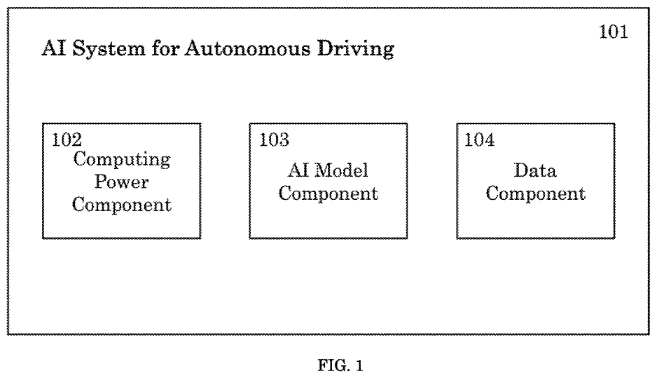

FIG. 1 shows key components of an AI System for Autonomous Driving. The AI System for Autonomous Driving 101 comprises one or more of a Computing Power Component 102, an AI Model Component 103, and/or a Data Component 104.

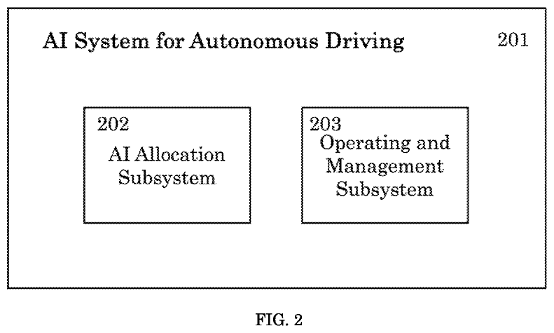

FIG. 2 shows an exemplary structure of an AI System for Autonomous Driving. The AI System for Autonomous Driving 201 comprises one or more of an AI Allocation Subsystem 202, and/or an Operating and Management Subsystem 203.

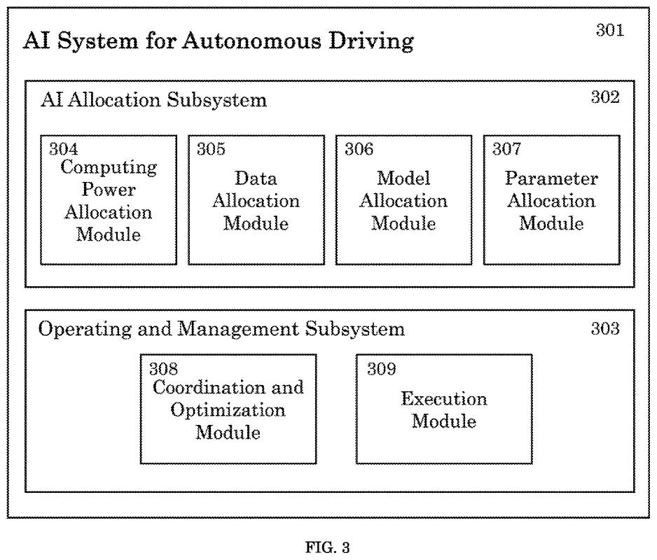

FIG. 3 shows an exemplary structure of an AI System for Autonomous Driving. The AI System for Autonomous Driving 301 comprises one or more of an AI Allocation Subsystem 302 and/or Operation and Management Subsystem 303. The AI Allocation Subsystem 302 comprises one or more of a Computing Power Allocation Module 304, a Data Allocation Module 305, a Model Allocation Module 306, and/or a Parameter Allocation Module 307. The Operation and Management Subsystem 303 comprises one or more of a Coordination and Optimization Module 308, and an Execution Module 309.

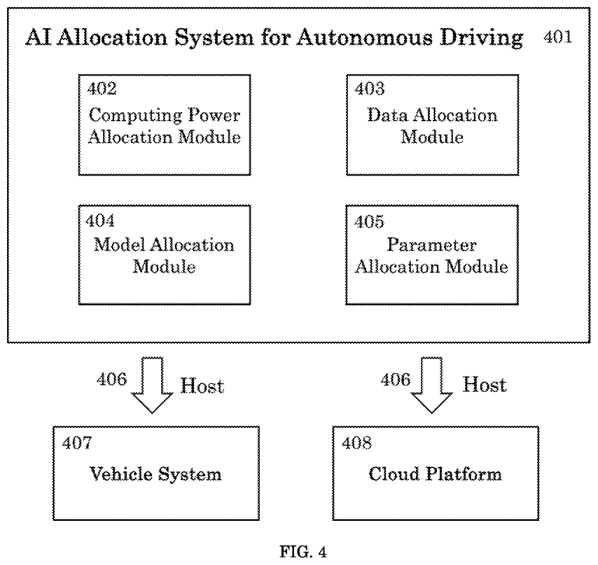

FIG. 4 shows a system structure of an AI Allocation System for Autonomous Driving. The AI Allocation System for Autonomous Driving 401 comprises one or more of a Computing Power Allocation Module 402, a Data Allocation Module 403, a Model Allocation Module 404, and/or a Parameter Allocation Module 405. The AI Allocation System for Autonomous Driving 401 is hosted 406 on one or more of a Vehicle System 407 or a Cloud Platform 408.

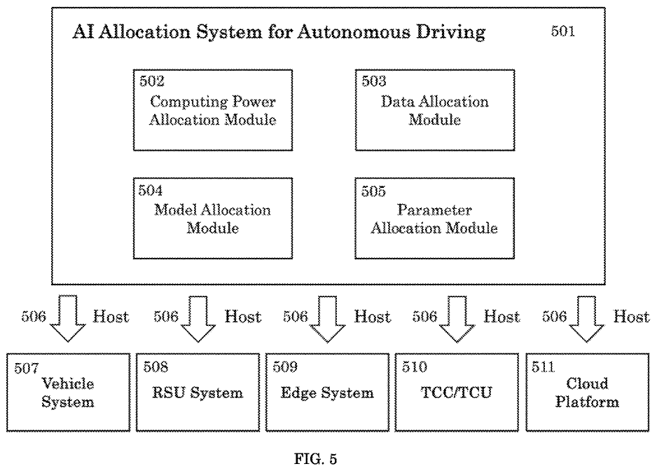

FIG. 5 shows a system structure of an AI Allocation System for Autonomous Driving. The AI Allocation System for Autonomous Driving 501 comprises one or more of a Computing Power Allocation Module 502, a Data Allocation Module 503, a Model Allocation Module 504, and/or a Parameter Allocation Module 505. The AI Allocation System for Autonomous Driving 501 is hosted 506 on one or more of a Vehicle System 507, a RSU System 508, an Edge System, 509, a TCC/TCU 510, and/or a Cloud Platform 511.

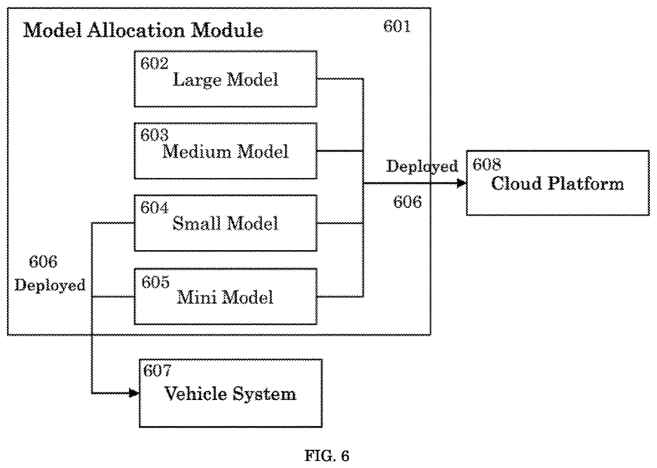

FIG. 6 shows a diagram of a Model Allocation Module. The Model Allocation Module 601 comprises one or more of a Large Model 602, a Medium Model 603, a Small Model 604, and/or a Mini Model 605. The Mini Model 605 and Small Model 604 are deployed 606 in the Vehicle System 607; and the mini model 605, small model 604, medium model 603 and large model 602 are deployed 606 in the Cloud Platform 608.

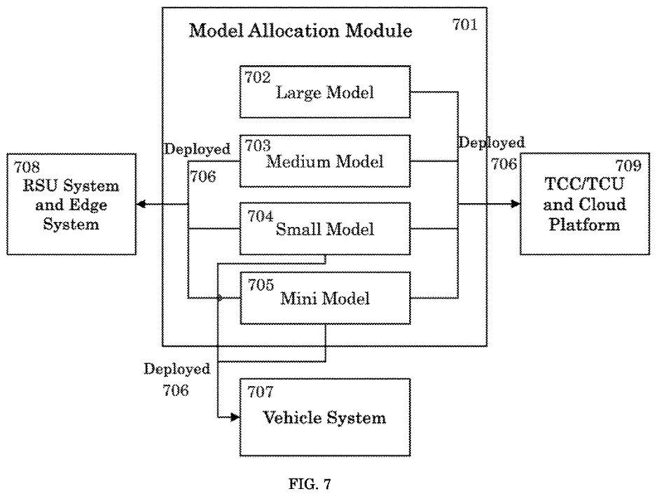

FIG. 7 shows a diagram of a Model Allocation Module. The Model Allocation Module 701 comprises one or more of a Large Model 702, a Medium Model 703, a Small Model 704, and/or a Mini Model 705. The Mini Model 705 and Small Model 704 are deployed 706 in the Vehicle System 707; the mini model 705, small model 704 and medium model 703 are deployed 706 in the RSU System and/or the Edge System 708; the mini model 705, small model 704, medium model 703, and large model 702 are deployed 706 in the TCC/TCU and/or the Cloud Platform 708.

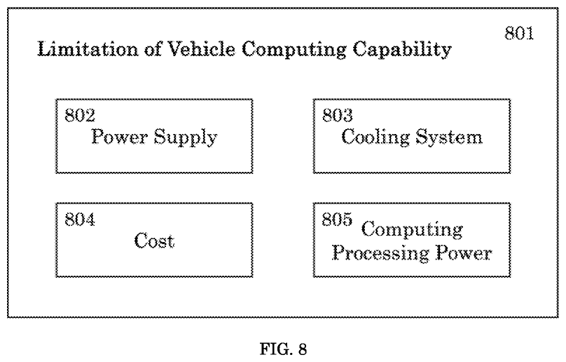

FIG. 8 shows a diagram of Limitation of Vehicle Computing Capability. The Limitation of Vehicle Computing Capability 801 comprises one or more of a Power Supply 802, Cooling System 803, Cost 804 and/or Computing Processing Power 805.

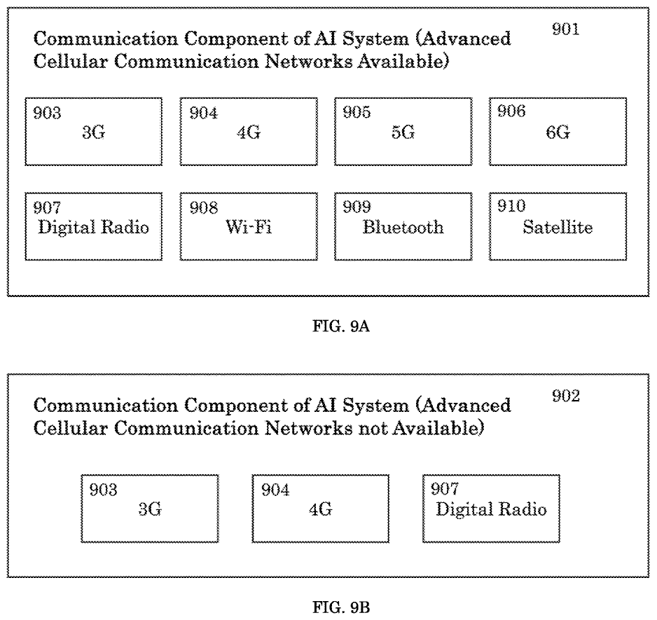

FIG. 9A shows an exemplary structure of a Communication Component of an AI System 901. FIG. 9B shows an exemplary structure of a Communication Component of an AI System 902. The Communication Component of the AI System 901, where advanced cellular communication networks are available, comprises one or more of 3G 903, 4G 904, 5G 905, 6G 906, Digital Radio 907, Wi-Fi 908, Bluetooth 909, and Satellite 910. The Communication Component of the AI System 902, where advanced cellular communication networks are not available, comprises one or more of 3G 903, 4G 904, and Digital Radio 907.

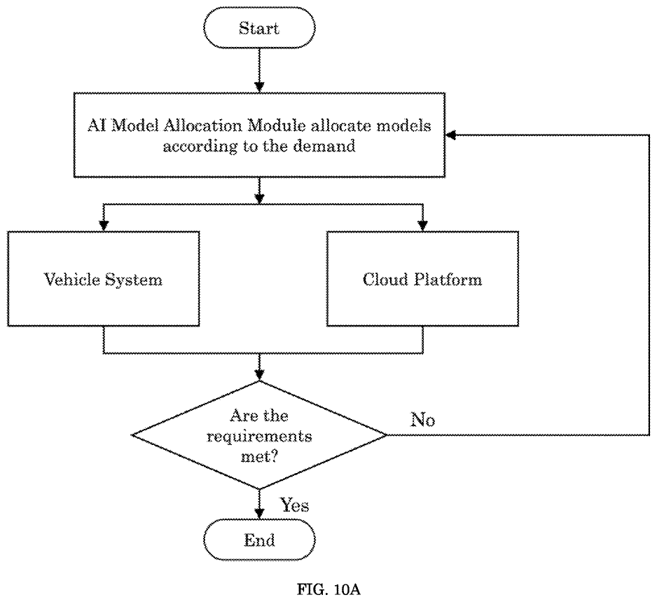

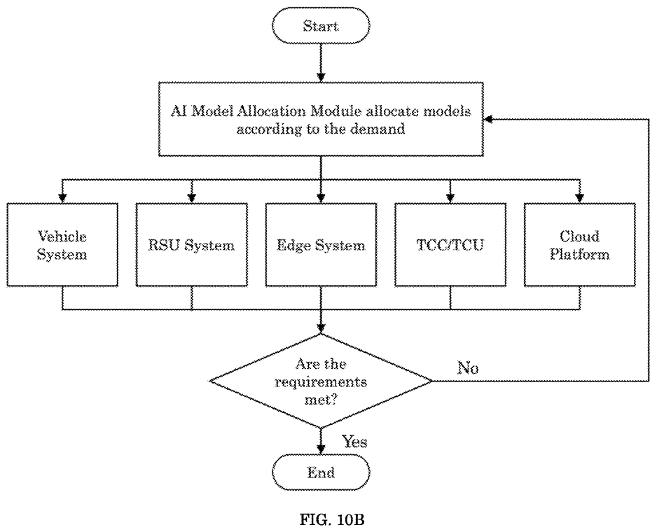

FIG. 10A shows the workflow of the AI Model Allocation Module. The AI Model Allocation Module allocates models based on demand. The allocated models are deployed in one or more of the vehicle system and the cloud platform, wherein they are evaluated to determine if system requirements are met. If the requirements are met, the process ends. If not, the AI Model Allocation Module reassigns models to better satisfy the system demands, repeating the process until all requirements are fulfilled.

FIG. 10B shows the workflow of the AI Model Allocation Module. The AI Model Allocation Module allocates models based on demand. The allocated models are deployed in one or more of the vehicle system, the RSU System, the Edge System, the TCC/TCU, and the Cloud Platform, wherein they are evaluated to determine if system requirements are met. If the requirements are met, the process ends. If not, the AI Model Allocation Module reassigns models to better satisfy the system demands, repeating the process until all requirements are fulfilled.

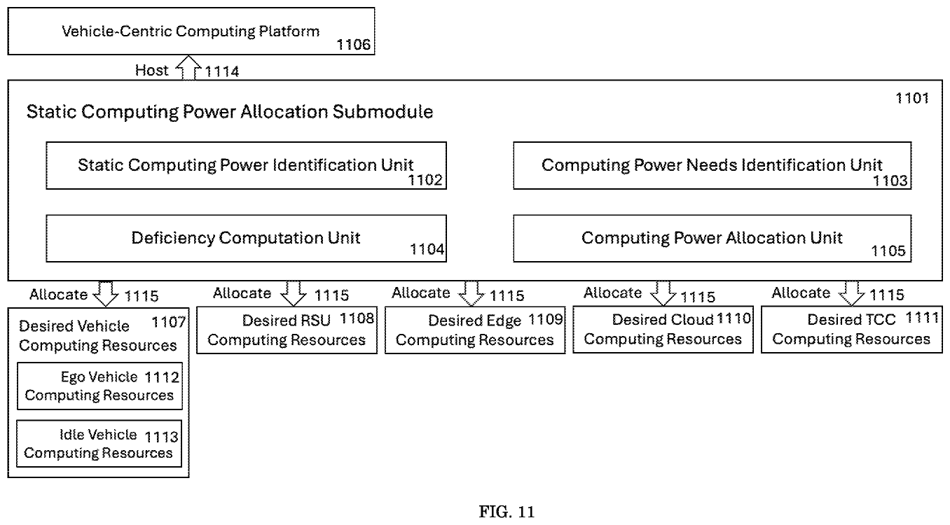

FIG. 11 shows the structure of the Static Computing Power Allocation Submodule 1101 for a Vehicle-Centric System, comprising one or more of a Static Computing Power Identification Unit 1102, a Computing Power Needs Identification Unit 1103, a Deficiency Computation Unit 1104, and a Computing Power Allocation Unit 1105. The Static Computing Power Allocation Submodule 1101 for a Vehicle-Centric System is configured to be hosted 1114 on a Vehicle-Centric Computing Platform 1106, wherein it can allocate 1115 the desired computing resources, such as Desired Vehicle Computing Resources 1107, Desired RSU Computing Resources 1108, Desired Edge Computing Resources 1109, Desired Cloud Computing Resources 1110, and/or Desired TCC Computing Resources 1111. This submodule 1101 further utilizes Ego Vehicle Computing Resources 1112 and/or Idle Vehicle Computing Resources 1113 to compensate for any computed deficiency, thereby ensuring that the vehicle-based platform has sufficient processing capacity to meet static computing power demands.

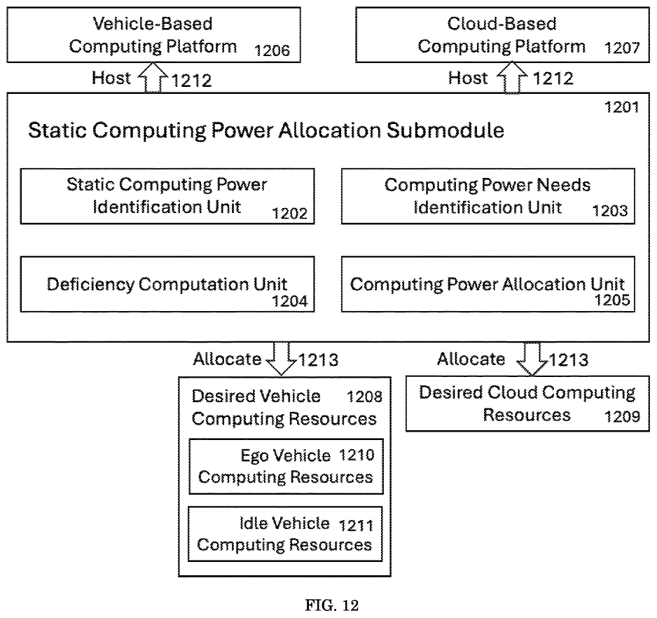

FIG. 12 shows the structure of the Static Computing Power Allocation Submodule 1201 for a Vehicle-Cloud System, comprising one or more of a Static Computing Power Identification Unit 1202, a Computing Power Needs Identification Unit 1203, a Deficiency Computation Unit 1204, and a Computing Power Allocation Unit 1205. The Static Computing Power Allocation Submodule 1201 for a Vehicle-Cloud System is configured to be hosted 1212 on a Vehicle-Based Computing Platform 1206 and/or a Cloud-Based Computing Platform 1207, wherein it can allocate 1213 the desired computing resources, including Desired Vehicle Computing Resources 1208 and Desired Cloud Computing Resources 1209. In some embodiments, the submodule 1201 leverages Ego Vehicle Computing Resources 1210 and/or Idle Vehicle Computing Resources 1211 to meet the computing requirements of a Vehicle-Cloud System.

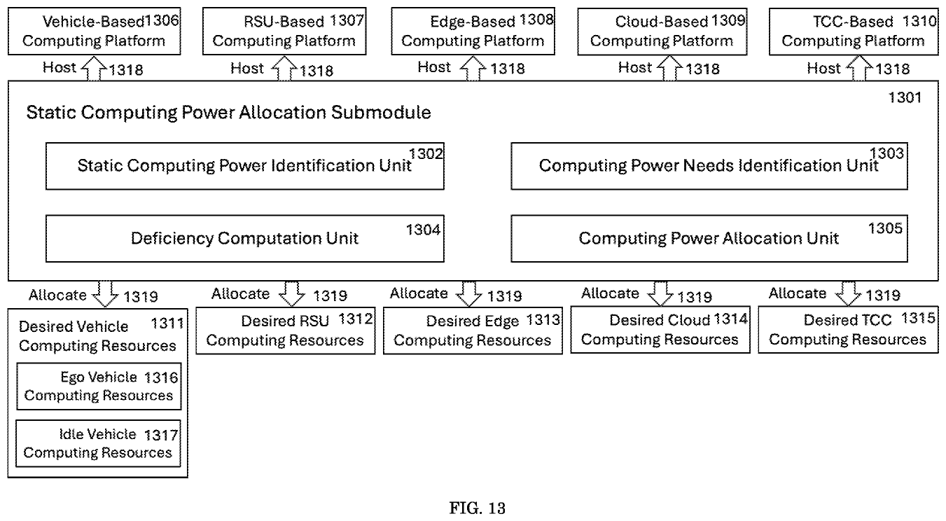

FIG. 13 shows the structure of the Static Computing Power Allocation Submodule 1301 for a Vehicle-Road/Edge-Cloud System, comprising one or more of a Static Computing Power Identification Unit 1302, a Computing Power Needs Identification Unit 1303, a Deficiency Computation Unit 1304, and a Computing Power Allocation Unit 1305. The Static Computing Power Allocation Submodule 1301 can be hosted 1318 on one or more of a Vehicle-Based Computing Platform 1306, an RSU-Based Computing Platform 1307, an Edge-Based Computing Platform 1308, a Cloud-Based Computing Platform 1309, and a TCC-Based Computing Platform 1310, and is configured to allocate 1319 Desired Vehicle Computing Resources 1311, Desired RSU Computing Resources 1312, Desired Edge Computing Resources 1313, Desired Cloud Computing Resources 1314, and/or Desired TCC Computing Resources 1315. The submodule 1301 may further utilize Ego Vehicle Computing Resources 1316 and/or Idle Vehicle Computing Resources 1317 to compensate for any identified deficiency, thereby providing effective static allocation of computing power in a Vehicle-Road/Edge-Cloud System.

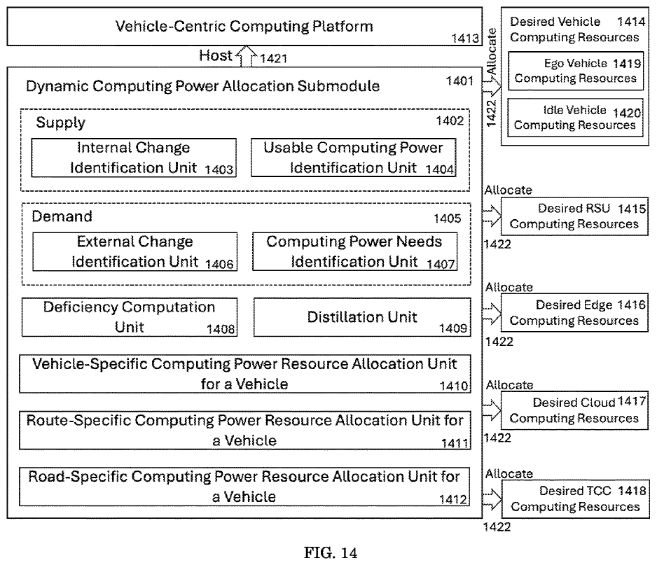

FIG. 14 shows the structure of the Dynamic Computing Power Allocation Submodule 1401 for a Vehicle-Centric System, comprising an Internal Change Identification Unit 140 and/or a Usable Computing Power Identification Unit 1404 from the supply 1402 side, an External Change Identification Unit 1406 and/or a Computing Power Needs Identification Unit 1407 from the demand 1405 side, a Deficiency Computation Unit 1408, a Distillation Unit 1409, a Vehicle-Specific Computing Power Resource Allocation Unit for a Vehicle 1410, a Route-Specific Computing Power Resource Allocation Unit for a Vehicle 1411, and/or a Road-Specific Computing Power Resource Allocation Unit for a Vehicle 1412. It is configured to be hosted 1421 on a Vehicle-Centric Computing Platform 1413, wherein it can allocate 1422 the desired computing resources, including Desired Vehicle Computing Resources 1414, Desired RSU Computing Resources 1415, Desired Edge Computing Resources 1416, Desired Cloud Computing Resources 1417, and/or Desired TCC Computing Resources 1418. The submodule 1401 may also utilize Ego Vehicle Computing Resources 1419 and/or Idle Vehicle Computing Resources 1420 to compensate for any real-time shortfall between supply 1402 and demand 1405.

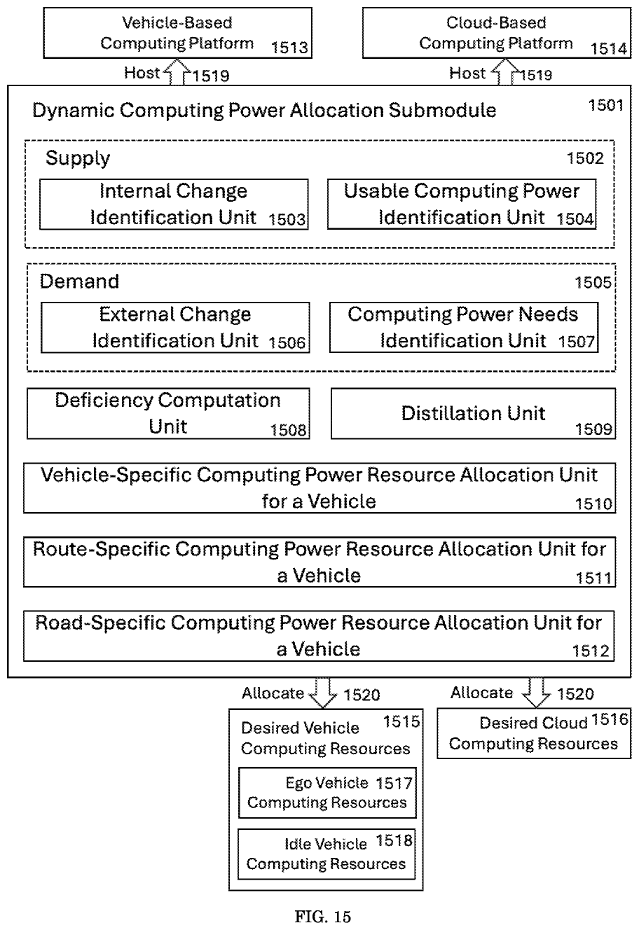

FIG. 15 shows the structure of the Dynamic Computing Power Allocation Submodule 1501 for a Vehicle-Cloud System, comprising an Internal Change Identification Unit 1503 and/or a Usable Computing Power Identification Unit 1504 from the supply 1502 side, an External Change Identification Unit 1506 and/or a Computing Power Needs Identification Unit 1507 from the demand 1505 side, a Deficiency Computation Unit 1508, a Distillation Unit 1509, a Vehicle-Specific Computing Power Resource Allocation Unit for a Vehicle 1510, a Route-Specific Computing Power Resource Allocation Unit for a Vehicle 1511, and/or a Road-Specific Computing Power Resource Allocation Unit for a Vehicle 1512. It is configured to be hosted 1519 on a Vehicle-Based Computing Platform 1513 and/or a Cloud-Based Computing Platform 1514, wherein it can allocate 1520 Desired Vehicle Computing Resources 1515 and/or Desired Cloud Computing Resources 1516. In some embodiments, the submodule 1501 may also draw on Ego Vehicle Computing Resources 1517 and Idle Vehicle Computing Resources 1518 to dynamically meet the gap between supply 1502 and demand 1505 during changing operational conditions.

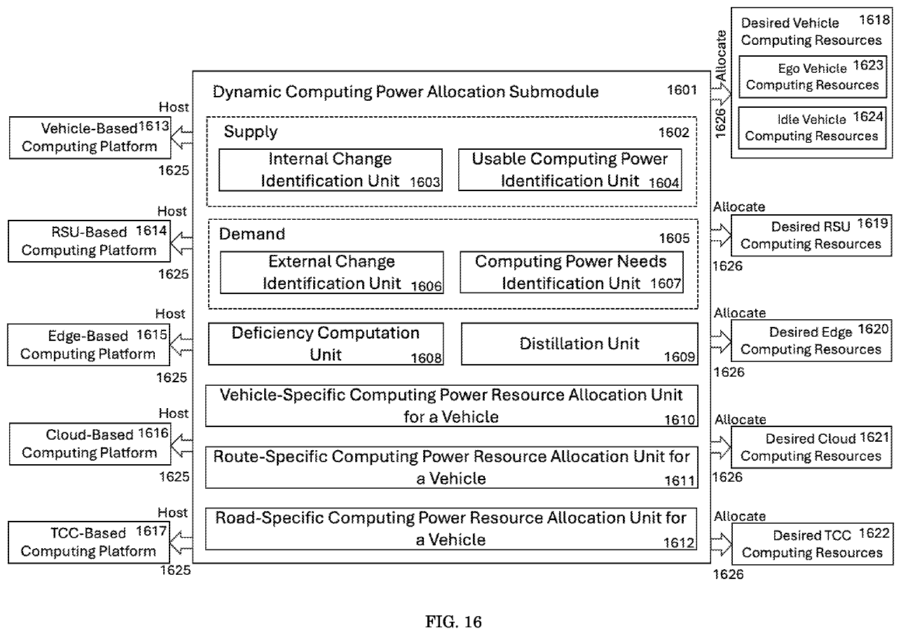

FIG. 16 shows the structure of the Dynamic Computing Power Allocation Submodule 1601 for a Vehicle-Road/Edge-Cloud, comprising an Internal Change Identification Unit 1603 and/or a Usable Computing Power Identification Unit 1604 from the supply 1602 side, an External Change Identification Unit 1606 and/or a Computing Power Needs Identification Unit 1607 from the demand 1605 side, a Deficiency Computation Unit 1608, a Distillation Unit 1609, a Vehicle-Specific Computing Power Resource Allocation Unit for a Vehicle 1660, a Route-Specific Computing Power Resource Allocation Unit for a Vehicle 1611, and/or a Road-Specific Computing Power Resource Allocation Unit for a Vehicle 1612. It is configured to be hosted 1625 on one or more of a Vehicle-Based Computing Platform 1613, an RSU-Based Computing Platform 1614, an Edge-Based Computing Platform 1615, a Cloud-Based Computing Platform 1616, and a TCC-Based Computing Platform 1617, wherein it can allocate 1626 the desired computing resources, including Desired Vehicle Computing Resources 1618, Desired RSU Computing Resources 1619, Desired Edge Computing Resources 1620, Desired Cloud Computing Resources 1621, and/or Desired TCC Computing Resources 1622. In some embodiments, the submodule 1601 may additionally leverage Ego Vehicle Computing Resources 1623 and Idle Vehicle Computing Resources 1624 to handle dynamic fluctuations, ensuring the system can address immediate real-time demands alongside ongoing supply conditions.

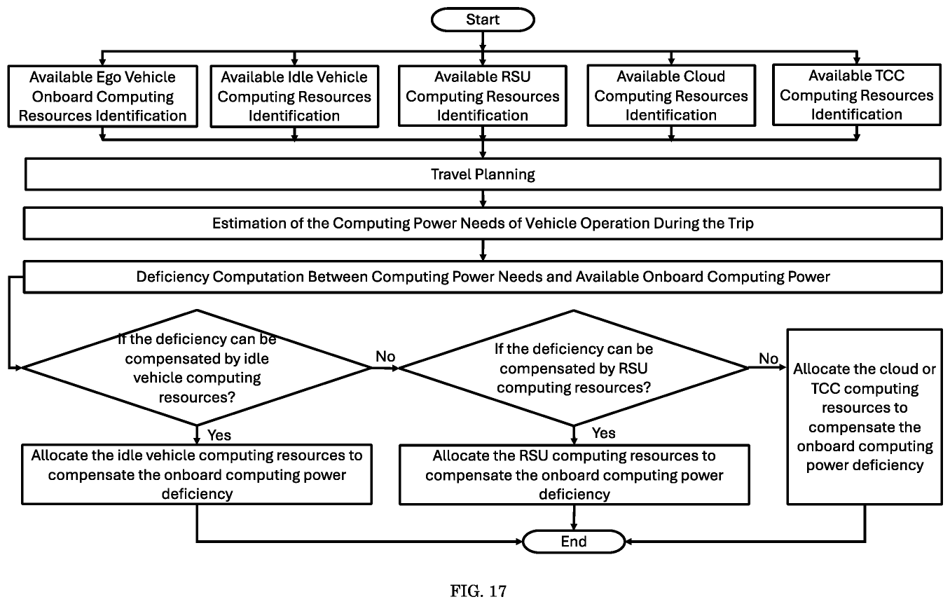

FIG. 17 shows a workflow of Static Computing Power Allocation for Planning Purposes, illustrating a representative sequence of steps used to determine how computing resources are allocated prior to or outside real-time operation. Initially, the system gathers information on all available computing resources, enumerating vehicle-based processing hardware (e.g., CPU, GPU, memory), as well as potential external resources such as RSU-based edge servers or cloud-based clusters. This resource inventory is taken at set intervals or before a trip commences to ensure that known capacities are documented. Next, the system calculates the anticipated computing requirements for the vehicle's operation, considering factors such as route complexity, expected traffic density, weather conditions, and the specific AI models running on-board the vehicle. During this planning phase, the system examines whether standard sensor data streams (e.g., from LiDAR, radar, cameras) will require additional offloading or whether existing vehicle hardware alone can manage these tasks. The workflow then checks for any discrepancy between resource availability and projected demand. If no shortfall exists, the system proceeds with the previously determined allocation plan. However, if a deficit is detected (e.g., indicating that the in-vehicle CPU/GPU or memory are insufficient for the projected workload), the workflow enters a computation step to identify precisely how much additional capacity is needed. Subsequently, the system selects one or more external sources, such as idle vehicle resources, RSU-based compute units, and/or a remote cloud platform, to address the deficiency. At this stage, the Static Computing Power Allocation approach uses a pre-determined or rule-based method to decide how tasks will be distributed, factoring in any cost, bandwidth, or latency constraints established during the planning. Finally, after the reallocation or acquisition of resources is complete, the workflow concludes by confirming that the revised static plan meets the projected demands for the upcoming trip or operational window. Should the journey or operational plan change (e.g., due to altered road conditions or new user requirements), the system may run through this workflow again to re-verify that all identified demands remain covered.

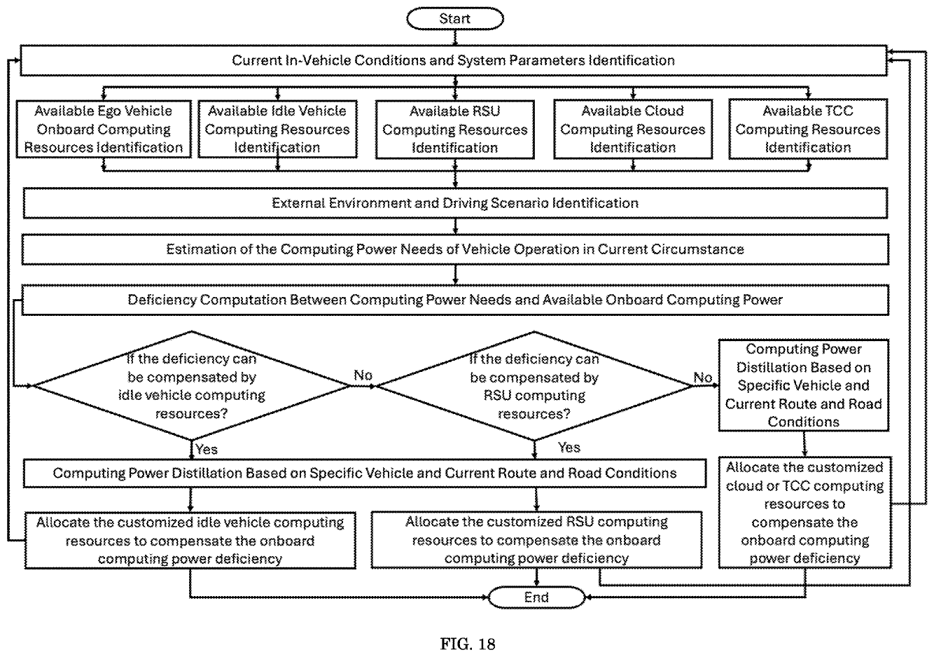

FIG. 18 illustrates a workflow of Dynamic Computing Power Allocation for Real-Time Vehicle Operation, demonstrating how a vehicle addresses computing power deficiencies as conditions change in real time. In this workflow, the system starts by continuously monitoring in-vehicle parameters, such as CPU/GPU utilization, battery status, and sensor health (e.g., LiDAR, radar, camera streams), while also observing external conditions like rapidly changing weather patterns, sudden traffic congestion, or unforeseen road hazards. When the system's internal modules detect a potential load increase such as an extra sensor coming online or more advanced perception tasks triggered by harsh environmental factors, it automatically compares the total computational demand against the currently available onboard resources. If the onboard CPU/GPU capacity is found sufficient, the vehicle continues operating without making changes. However, when the system identifies a computing power deficiency (e.g., real-time sensor fusion requires more GPU and memory than what is presently available), it immediately evaluates which external resources can be leveraged to close the gap. These resources may include specialized RSU-based servers located near the roadway, idle GPUs in other vehicles traveling in the vicinity, edge data centers hosting additional CPU/GPU capacity, or cloud servers capable of handling large-scale inference in near real time. Once the vehicle determines that tapping into customized RSU computing resources (or similar external resources) is the best approach, the system offloads specific tasks such as dense perception, mapping updates, or advanced path planning via wireless communication. This allocation happens dynamically, with minimal disruption to the overall autonomous driving functions. The final step shown in FIG. 18 demonstrates how the system allocates the customized RSU computing resources to compensate for the onboard computing power deficiency, ensuring that the vehicle can maintain safe, responsive operation under evolving operational or environmental scenarios. Following this allocation, the system cycles back into a continuous monitoring loop, ready to detect new deficiencies or release external resources if they become unnecessary. By orchestrating real-time collaboration among the vehicle's own hardware, roadside infrastructure, and potentially even other vehicles, this dynamic workflow provides robust autonomous driving performance despite fluctuating computational demands.

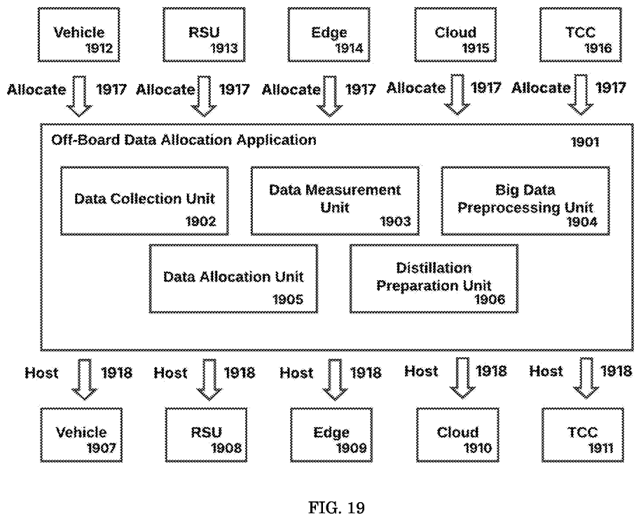

FIG. 19 shows the structure of the Off-board Allocation Submodule 1901 for a Vehicle-Road-Cloud System comprising one or more of a Data Collection Unit 1902, a Data Measurement Unit 1903, a Big Data Preprocessing Unit 1904, a Data Allocation Unit 1905, and a Distillation Preparation Unit 1906. The Off-board Allocation Submodule 1901 is configured to be hosted on Vehicle 1907, RSU 1908, Edge 1909, Cloud 1910, and/or TCC 1911. The Off-board Allocation Submodule 1901 is configured to distribute and integrate data to one or more of Vehicle 1912, RSU 1913, Edge 1914, Cloud 1915, and TCC 1916, from one or more of Vehicle 1907, RSU 1908, Edge 1909, Cloud 1910, and TCC 1911.

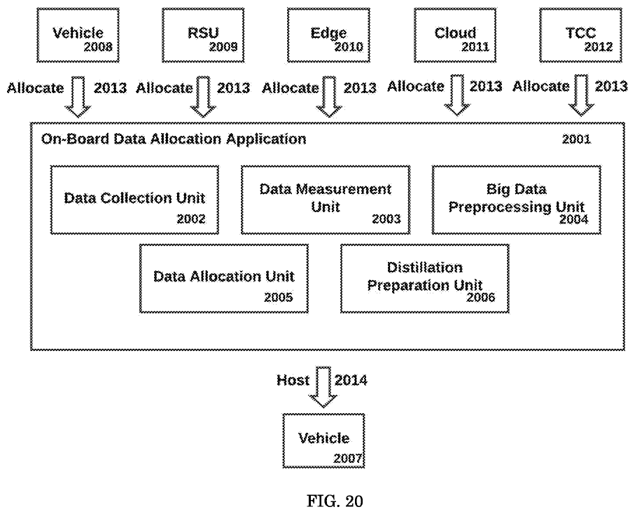

FIG. 20 shows the structure of the On-board Allocation Submodule 2001 for a Vehicle-Centric System, comprising one or more of a Data Collection Unit 2002, a Data Measurement Unit 2003, a Big Data Preprocessing Unit 2004, a Data Allocation Unit 2005, and a Distillation Preparation Unit 2006. The On-board Allocation Submodule 2001 is configured to be hosted on Vehicle 2007. The On-board Allocation Submodule 2001 is configured to distribute and integrate data to one or more of Vehicle 2008, RSU 2009, Edge 2010, Cloud 2011, and TCC 2012, from one or more Vehicles 2007.

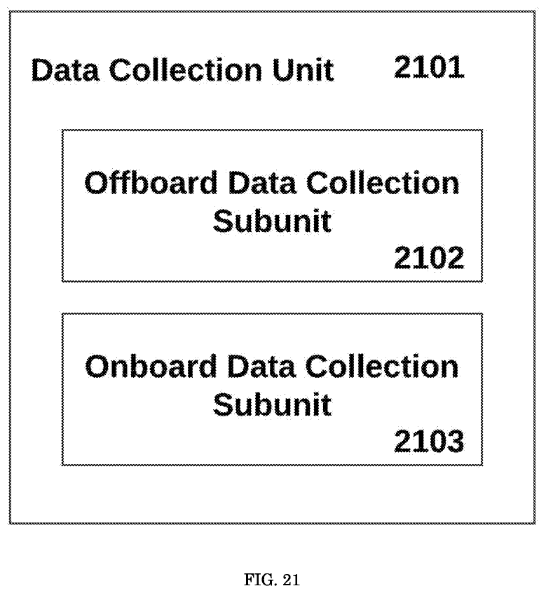

FIG. 21 shows the structure of the Data Collection Unit 2101, comprising one or more of an Offboard Data Collection Subunit 2102, and an Onboard Data Collection Subunit 2103. The Offboard Collection Subunit 2102 is configured to collect onboard sensors data and vehicle condition data. The Onboard Data Collection Subunit 2103 is configured to collect data from other vehicles, RSUs, TCCs, TCUs, and the Cloud.

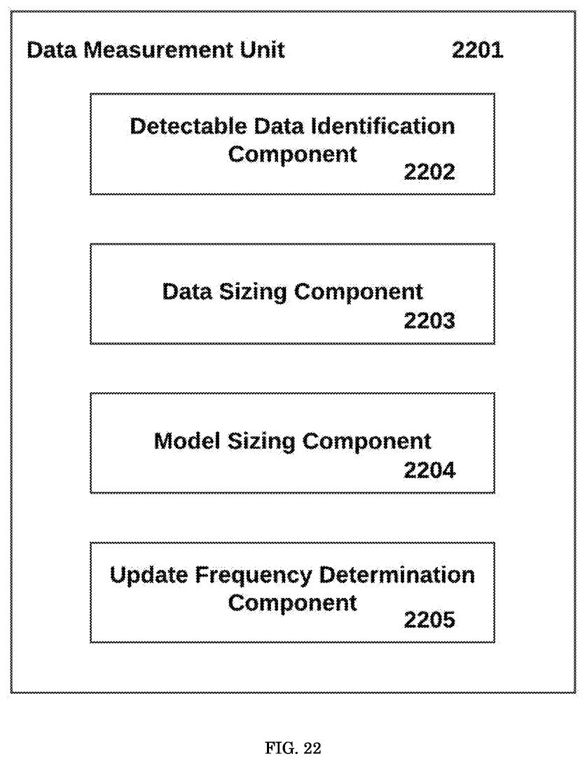

FIG. 22 shows the structure of the Data Measurement Unit 2201, comprising one or more of a Detectable Data Identification Component 2202, a Data Sizing Component 2203, a Model Sizing Component 2204, and an Update Frequency Determination Component 2205. The Detectable Data Identification Component 2202 is configured to identify if the data are detectable. The Data Sizing Component 2203 is configured to determine the size of the data. The Model Sizing Component 2204 is configured to determine the size of the model that the data are used for training or inference. The Update Frequency Determination Component 2205 is configured to determine the update frequency of the data.

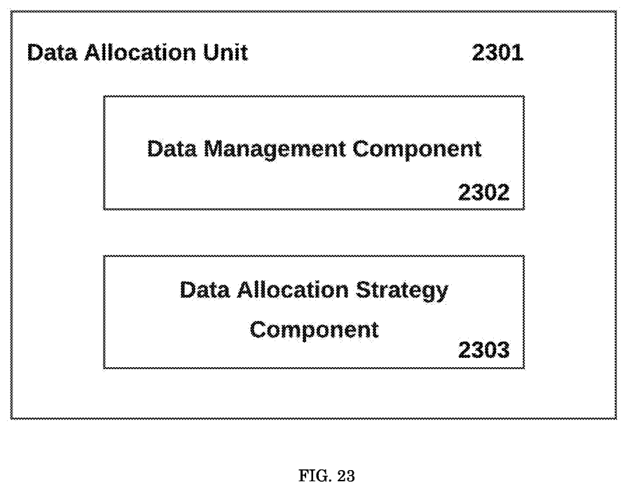

FIG. 23 shows the structure of the Data Allocation Unit 2301, comprising one or more of a Data Management Component 2302 and a Data Allocation Strategy Component 2303. The Data Management Component 2302 is configured to queue all the data that is ready for transmission, ensuring proper organization and prioritization of the data. The Data Allocation Strategy Component 2303 is configured to adjust proper allocation strategy based on the measurements from Data Measurement Unit 2201 and prioritization of the data sent by Data Management Component 2302 to guarantee the granularity of data allocation.

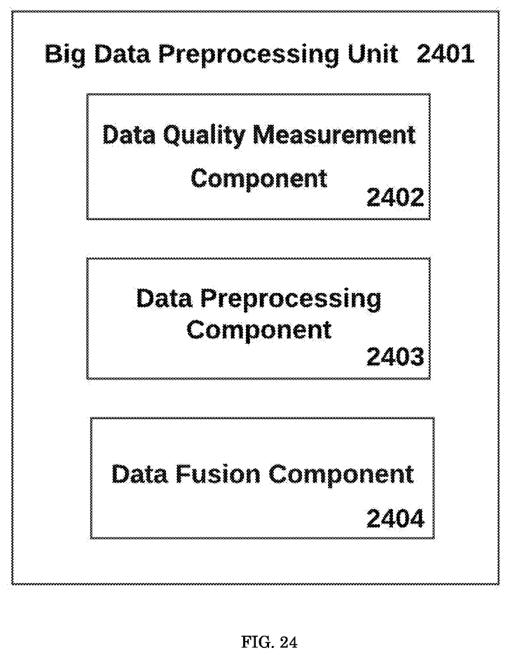

FIG. 24 shows the structure of the Big Data Preprocessing Unit 2401, comprising one or more of a Data Quality Measurement Component 2402, a Data Preprocessing Component 2403, and a Data Fusion Component 2404. The Data Quality Measurement Component 2402 is configured to identify the quality of the data, which includes missing values, duplications, and validity. The Data Preprocessing Component 2403 is configured to receive messages or notifications from Data Quality Measurement Component 2402 and drop or fill the missing values, drop duplicates, and reformat the dataset into a valid format. The Data Fusion Component 2404 is configured to fuse the data after completion of data quality measurement and data preprocessing.

FIG. 25 shows the structure of the Distillation Preparation Unit 2501, comprising one or more of a Vehicle Specific Data Preparation Component 2502, a Route Specific Data Preparation Component 2503, a Road Specific Data Preparation Component 2504, an ODD Specific Preparation Component 2505, and a Trip Specific Preparation Component 2506. The Vehicle Specific Data Preparation Component 2502 is configured to prepare training and validation data for distillation of big models in usage for a specific vehicle. The Route Specific Data Preparation Component 2503 is configured to prepare training and validation data for distillation of big models in usage for a specific route. The Road Specific Data Preparation Component 2504 is configured to prepare training and validation data for distillation of big models in usage for a specific road. The ODD Specific Data Preparation Component 2505 is configured to prepare training and validation data for distillation of big models in usage for a specific ODD. The Trip Specific Data Preparation Component 2506 is configured to prepare training and validation data for distillation of big models in usage for a specific trip.

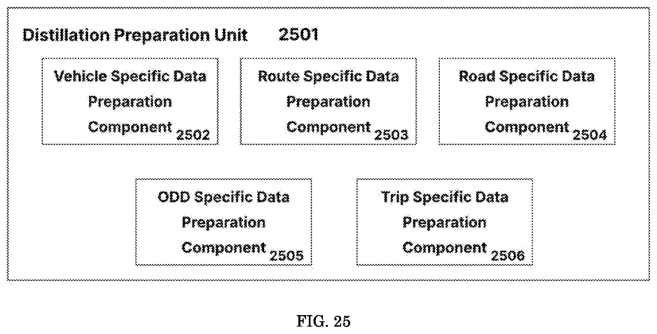

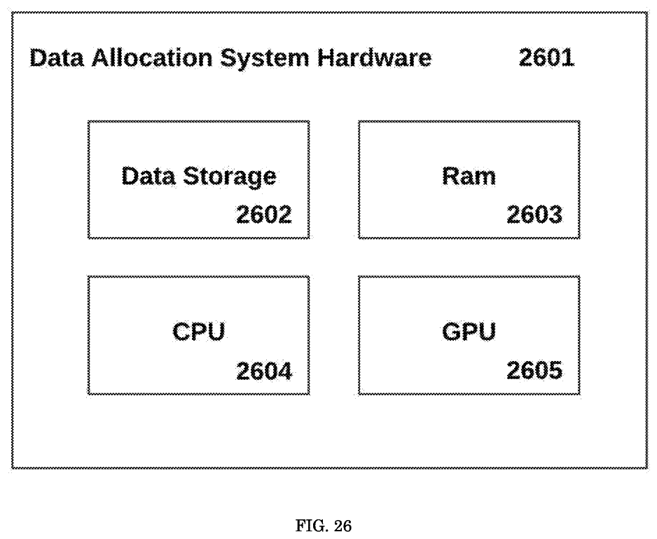

FIG. 26 shows the structure of the Data Allocation Module Hardware 2601, comprising one or more of a Data Storage 2602, a RAM 2603, a CPU 2604, and a GPU 2605. For example, in some embodiments, a Data Storage 2602 can be a Samsung 990 Pro SSD. A RAM 2603 can be Corsair Vengeance RGB DDR5 (6000 MHz-8000 MHz). A CPU 2604 can be Intel Core i9-14900k. A GPU 2605 can be NVIDIA Geforce RTX 4090.

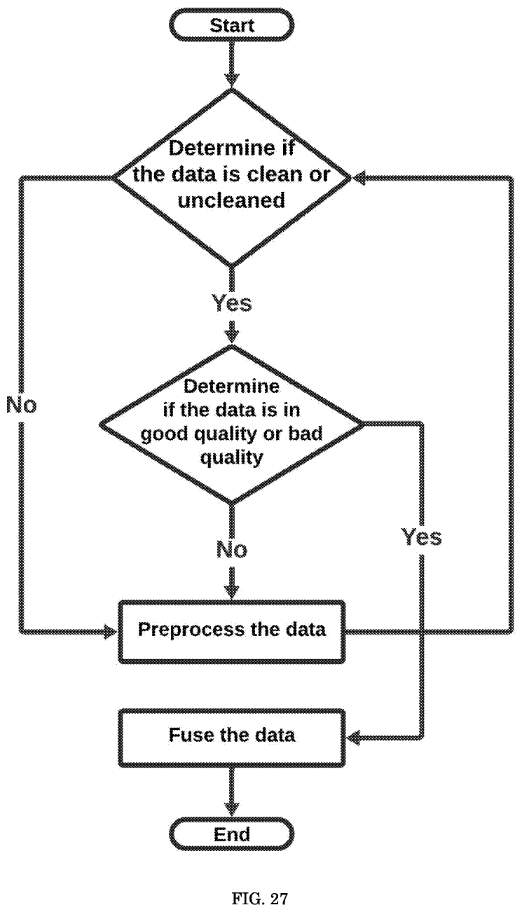

FIG. 27 shows the workflow of the Big Data Preprocessing Unit for cleaning and fusing data. The process begins with determining whether the data are clean or unclean. If the data are unclean, it is first sent for preprocessing and then sent back for re-evaluation. If the data are clean, the next step is to assess its quality. If the data are of good quality, it proceeds directly to the fusion stage. However, if the data are of bad quality, it undergoes preprocessing to improve its integrity. Once the data are preprocessed, it is rechecked to determine whether it is now clean and of good quality. If the data are still unclean or of bad quality, it is sent back for further processing. If it meets the standards, it moves to the fusion stage, wherein different datasets are combined. Finally, the process concludes, ensuring that only high-quality, well-processed data are used for further analysis.

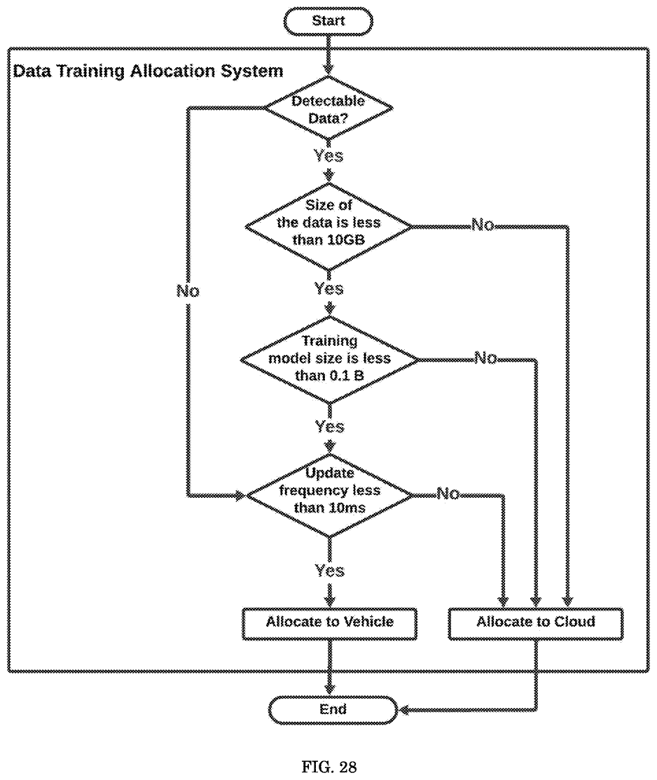

FIG. 28 shows the workflow of the Data Allocation Unit for allocating data for training for a Vehicle-Cloud System. The Data Allocation Unit receives notifications from the Data Measurement Unit, which is responsible for measuring whether the data are detectable, determining the size of the data, assessing the model size that the data are used for training, and evaluating the update frequency. The process begins by checking whether the data are detectable. If the data are detectable, the workflow continues to check its size. If the size of the data are less than 10 GB, the process proceeds to evaluate the training model size. If the training model size is less than 0.1 B parameters (100 million parameters), the workflow moves on to assess the update frequency. If the update frequency is less than 10 ms, the data are allocated to the vehicle for training. At any stage, if the data exceeds the predefined thresholds (i.e., larger than 10 GB in size, training model larger than 0.1 B parameters, or update frequency greater than 10 ms), the data are assigned to the cloud for training. This ensures that data requiring more computational power or less frequent updates are processed in the cloud, while lightweight and time-sensitive data are handled directly within the vehicle. Finally, the process concludes after the allocation is completed.

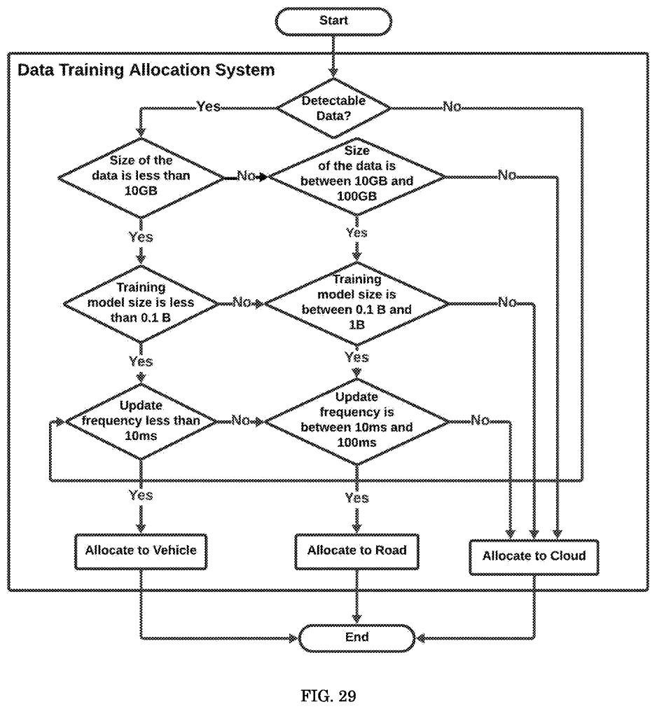

FIG. 29 shows the workflow of the Data Allocation Unit for allocating data for training for a Vehicle-Road-Cloud System. The Data Allocation Unit receives notifications from the Data Measurement Unit, which is responsible for determining whether the data are detectable, measuring the size of the data, assessing the training model size, and evaluating the update frequency. Based on these measurements, the Data Allocation Unit allocates data to the Vehicle, Road, or Cloud for training, ensuring efficient processing based on computational and real-time requirements. The workflow begins by checking if the data are detectable. If the data are not detectable, the system evaluates the update frequency. If the update frequency is less than 10 ms, the data are allocated to the Vehicle. If the update frequency is between 10 ms and 100 ms, the data are allocated to the Road. Otherwise, the data are allocated to the Cloud. If the data are detectable, the system evaluates the size of the data. If the size is less than 10 GB, the system checks if the training model size is less than 0.1 B parameters. If the model size is below this threshold, the system evaluates the update frequency. If the update frequency is less than 10 ms, the data are allocated to the Vehicle. If the update frequency is between 10 ms and 100 ms, the data are allocated to the Road. Otherwise, the data are allocated to the Cloud. If the training model size is greater than 0.1 B parameters but less than 1 B parameters, the system checks the update frequency. If the update frequency is between 10 ms and 100 ms, the data are allocated to the Road. Otherwise, the data are allocated to the Cloud. If the training model size exceeds 1 B parameters, the data are allocated directly to the Cloud. If the size of the data are between 10 GB and 100 GB, the system evaluates whether the training model size is between 0.1 B parameters and 1 B parameters. If this is the case, it checks the update frequency. If the update frequency is between 10 ms and 100 ms, the data are allocated to the Road. Otherwise, the data are allocated to the Cloud. If the training model size is outside the range of 0.1 B parameters to 1 B parameters, the data are allocated to the Cloud. If the data size exceeds 100 GB, the data are allocated to the Cloud. This structured approach ensures an optimized allocation of data across Vehicle, Road, and Cloud resources by balancing real-time processing needs, computational demands, and data constraints.

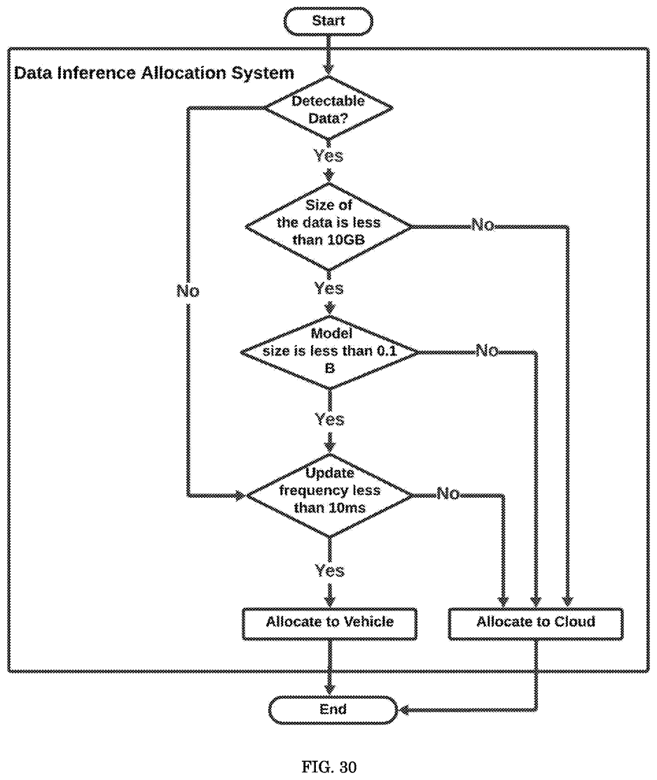

FIG. 30 shows the workflow of the Data Allocation Unit for allocating data for inference for a Vehicle-Cloud System. The Data Allocation Unit receives notifications from the Data Measurement Unit, which is responsible for measuring whether the data are detectable, determining the size of the data, assessing the model size, and evaluating the update frequency. The process begins by checking whether the data are detectable. If the data are detectable, the workflow continues to check its size. If the size of the data are less than 10 GB, the process proceeds to evaluate the model size. If the model size is less than 0.1 B (100 million parameters), the workflow moves on to assess the update frequency. If the update frequency is less than 10 ms, the data are allocated to the vehicle for inference. At any stage, if the data exceeds the predefined thresholds (i.e., data larger than 10 GB in size, model larger than 0.1 B, or update frequency greater than 10 ms), the data are assigned to the cloud for training. This ensures that data requiring more computational power or less frequent updates are processed in the cloud, while lightweight and time-sensitive data are handled directly within the vehicle. Finally, the process concludes after the allocation is completed.

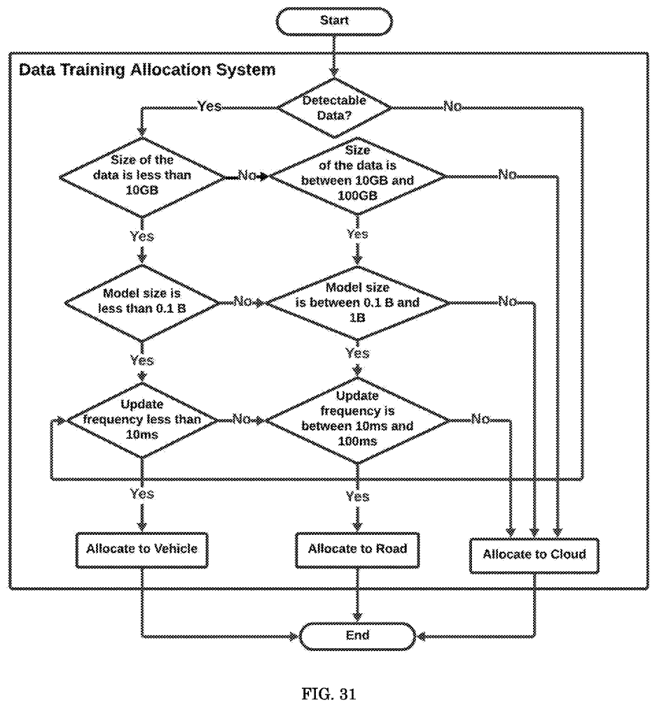

FIG. 31 shows the workflow of the Data Allocation Unit for allocating data for inference for a Vehicle-Road-Cloud System. The Data Allocation Unit receives notifications from the Data Measurement Unit, which is responsible for determining whether the data are detectable, measuring the size of the data, assessing the model size, and evaluating the update frequency. Based on these measurements, the Data Allocation Unit allocates data to the Vehicle, Road, or Cloud for inference, ensuring efficient processing based on computational and real-time requirements. The workflow begins by checking if the data are detectable. If the data are not detectable, the system evaluates the update frequency. If the update frequency is less than 10 ms, the data are allocated to the Vehicle. If the update frequency is between 10 ms and 100 ms, the data are allocated to the Road. Otherwise, the data are allocated to the Cloud. If the data are detectable, the system evaluates the size of the data. If the size is less than 10 GB, the system checks if the model size is less than 0.1 B parameters. If the model size is below this threshold, the system evaluates the update frequency. If the update frequency is less than 10 ms, the data are allocated to the Vehicle. If the update frequency is between 10 ms and 100 ms, the data are allocated to the Road. Otherwise, the data are allocated to the Cloud. If the model size is greater than 0.1 B but less than 1 B, the system checks the update frequency. If the update frequency is between 10 ms and 100 ms, the data are allocated to the Road. Otherwise, the data are allocated to the Cloud. If the model size exceeds 1 B parameters, the data are allocated directly to the Cloud. If the size of the data are between 10 GB and 100 GB, the system evaluates whether the model size is between 0.1 B parameters and 1 B parameters. If it is the case, it checks the update frequency. If the update frequency is between 10 ms and 100 ms, the data are allocated to the Road. Otherwise, the data are allocated to the Cloud. If the model size is outside the range of 0.1 B parameters to 1 B parameters, the data are allocated to the Cloud. If the data size exceeds 100 GB, the data are allocated to the Cloud. This structured approach ensures an optimized allocation of data across Vehicle, Road, and Cloud resources by balancing real-time processing needs, computational demands, and data constraints.

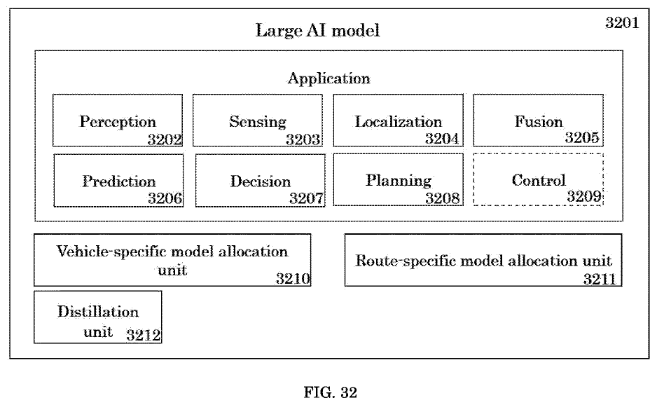

FIG. 32 shows the structure of a Large AI model 3201, comprising an Application layer that includes Perception 3202, Sensing 3203, Localization 3204, Fusion 3205, Prediction 3206, Decision 3207, Planning 3208, and Control 3209. The Large AI model 3201 further incorporates a Vehicle-specific model allocation unit 3210 for tailoring the model to a particular vehicle's hardware or operational constraints, a Route-specific model allocation unit 3211 for adapting AI functions based on route conditions, and a Distillation unit 3212 for refining or compressing the model into smaller variants when required.

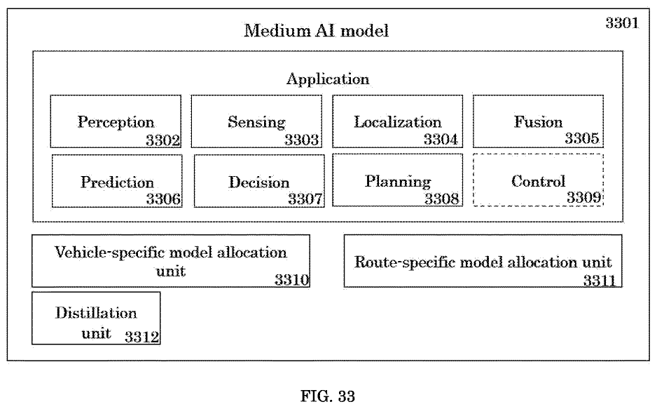

FIG. 33 shows the structure of a Medium AI model 3301, which likewise includes an Application layer comprising Perception 3302, Sensing 3303, Localization 3304, Fusion 3305, Prediction 3306, Decision 3307, Planning 3308, and Control 3309. In addition, the Medium AI model 3301 features a Vehicle-specific model allocation unit 3310, a Route-specific model allocation unit 3311, and a Distillation unit 3312. Compared to the Large AI model, this Medium AI model may employ reduced network sizes or fewer computational resources to balance performance with efficiency.

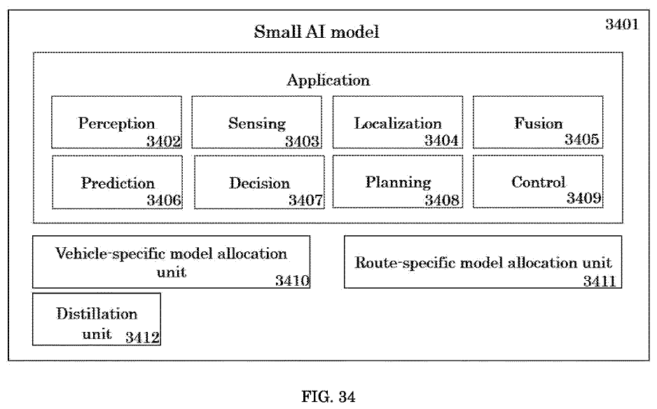

FIG. 34 shows the structure of a Small AI model 3401, including an Application layer that hosts Perception 3402, Sensing 3403, Localization 3404, Fusion 3405, Prediction 3406, Decision 3407, Planning 3408, and Control 3409. The Small AI model 3401 further contains a Vehicle-specific model allocation unit 3410, a Route-specific model allocation unit 3411, and a Distillation unit 3412. This model is typically more resource-constrained or streamlined than the Medium AI model, making it suitable for vehicles with limited on-board computing capacity.

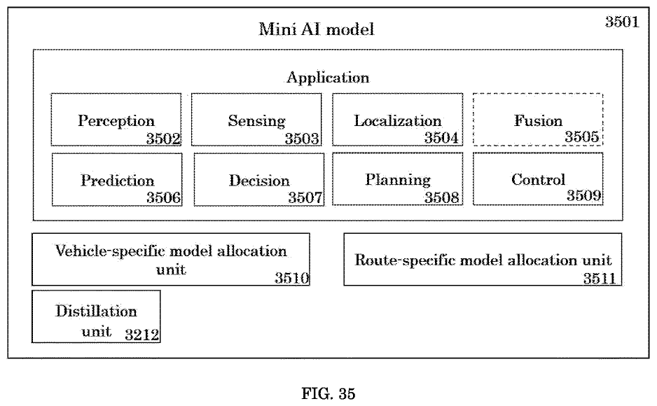

FIG. 35 shows the structure of a Mini AI model 3501, comprising an Application layer with Perception 3502, Sensing 3503, Localization 3504, Fusion 3505, Prediction 3506, Decision 3507, Planning 3508, and Control 3509. The Mini AI model 3501 also includes a Vehicle-specific model allocation unit 3510, a Route-specific model allocation unit 3511, and a Distillation unit 3512. This smallest-scale model prioritizes minimal resource usage on-board while still providing essential autonomous driving functions, leveraging distillation or external computing support for advanced tasks if needed.

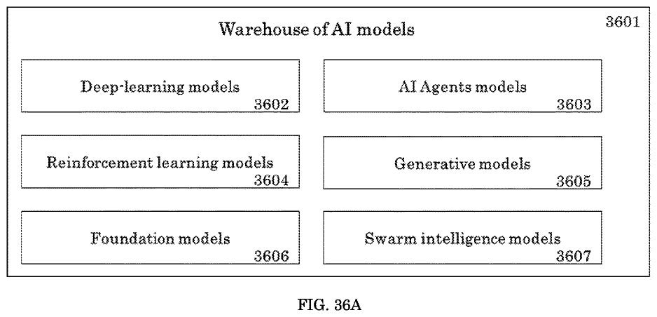

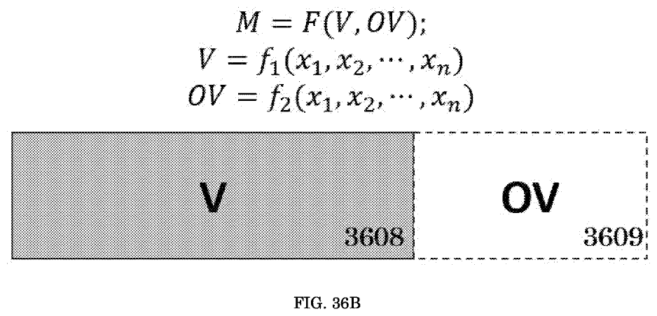

FIG. 36A depicts the Warehouse of AI models 3601 for the AI model component. The warehouse contains multiple types of AI technologies organized into six categories: Deep-learning models 3602, AI Agents models 3603, Reinforcement learning models 3604, Generative models 3605, Foundation models 3606, and Swarm intelligence models 3607. This warehouse structure provides systematic organization, categorization, and retrieval of AI models based on their technological implementation approaches for autonomous driving functions.

FIG. 36B illustrates the Model Allocation Module's mathematical framework for autonomous driving systems. The diagram presents the core equation M=F(V, OV) that governs how AI models are allocated across the system. In this equation, M represents the output combination of AI models selected from the warehouse, V 3608 represents the set of vehicle-based AI models, and OV 3609 represents the set of out-of-vehicle-based AI models. The function F determines how V and OV cooperate to produce M that achieves a certain level of automation while satisfying both safety and computing resource requirements. The figure also shows the subsidiary equations V=f₁(x₁, x₂, . . . , xₙ) and OV=f₂(x₁, x₂, . . . , xₙ), where f₁ and f₂ are functions that determine the vehicle-based and out-of-vehicle-based AI models, respectively. The variables x₁ through x, represent individual models from functional domains such as sensing, perception, localization, fusion, prediction, planning, decision-making, and control.

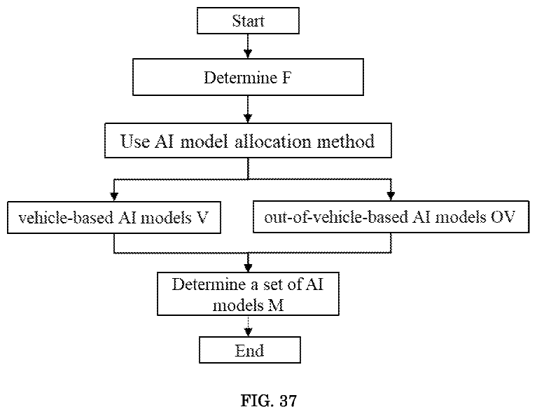

FIG. 37 shows the workflow of the AI Model Allocation Module deployment process. The process begins with determining a function F, which serves as a criterion for model allocation. A set of AI models M is determined based on the function F. The process concludes after the set of AI models M is determined, ensuring that AI models are allocated for subsequent use.

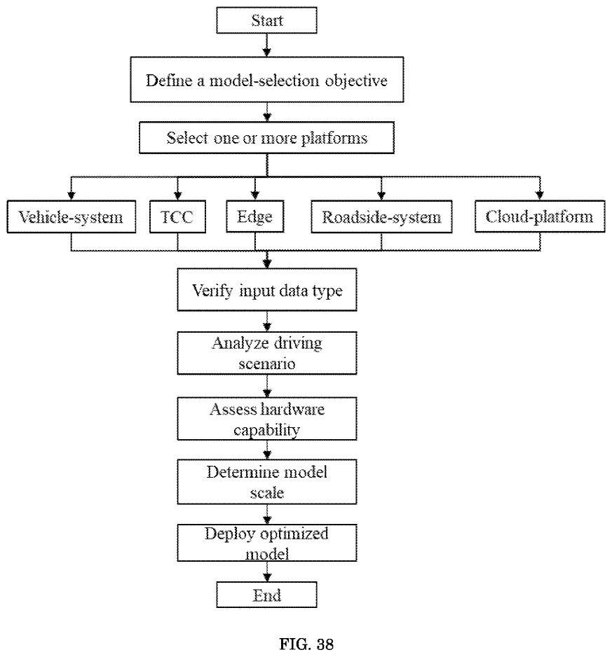

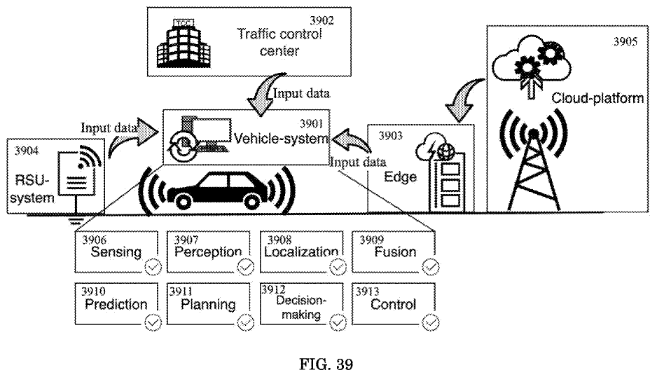

FIG. 38 shows the workflow of the AI Model Allocation Module configuration process. The process begins with defining a model-selection objective. The workflow then proceeds to verify the input data type. Next, the driving scenario is analyzed. The process continues with assessing the hardware capability. The model scale is then determined based on the assessment. The process concludes with deploying the optimized model for use.

FIG. 39 shows an example of AI Model Allocation Module deployment and configuration. The AI Model Allocation Module selects the Vehicle-System 3901 as the deployment platform from the Vehicle-System, the Traffic Control Center (TCC) 3902, the Edge 3903, the RSU System 3904, and Cloud Platform 3905. Additional out-of-vehicle (“OV”) submodules provide data support. Within the Vehicle-System 3901, eight driving models are activated to complete the deployment process: sensing 3906, perception 3907, localization 3908, fusion 3909, prediction 3910, planning 3911, decision-making 3912, and control 3913 models.

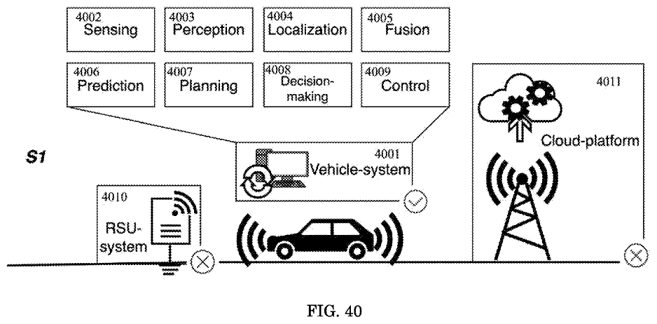

FIG. 40 shows an example of AI Model Allocation Module Deployment and Configuration at the S1 level, which is defined as level 1 according to the SAE definition of automation level. For S1-level autonomous driving, the AI Model Allocation Module primarily assigns and coordinates vehicle-based submodules (the vehicle system 4001) to execute eight driving functions: sensing 4002, perception 4003, localization 4004, fusion 4005, prediction 4006, planning 4007, decision-making 4008, and control 4009. In this stage, out-of-vehicle submodules such as RSU 4010 and cloud platform 4011 remain inactive.

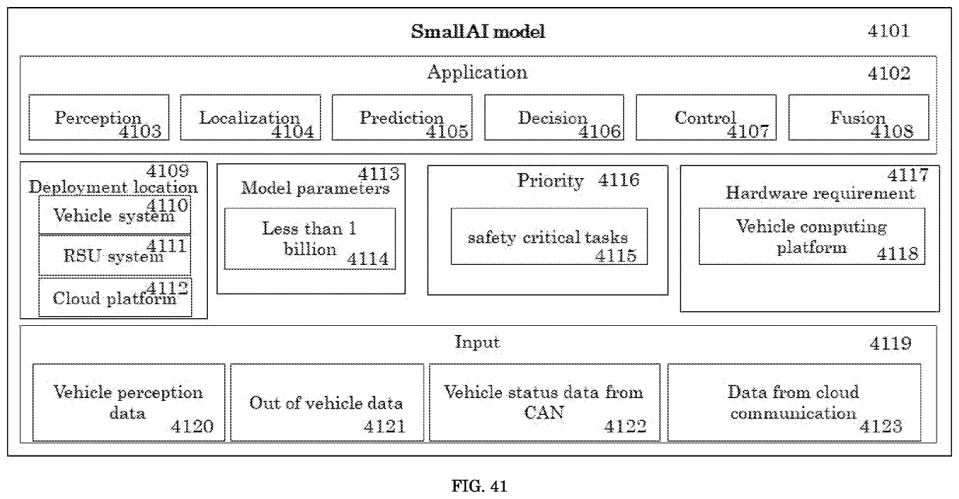

FIG. 41 shows a Small AI model 4101 designed for deployment on vehicle systems, RSUs, or cloud platforms. It includes core modules—Perception 4103, Localization 4104, Prediction 4105, Decision 4106, Control 4107, and Fusion 4108—within an Application layer 4102. With Model Parameters 4113 fewer than 1 billion parameters 4114, it focuses on safety-critical tasks 4115 from Priority part 4116 using standard vehicle computing platforms 4118 as Hardware Requirement 4117. Inputs include vehicle perception 4120, out of vehicle data 4121, status 4122, and data from cloud 4123, providing efficient autonomous functions under limited resources.

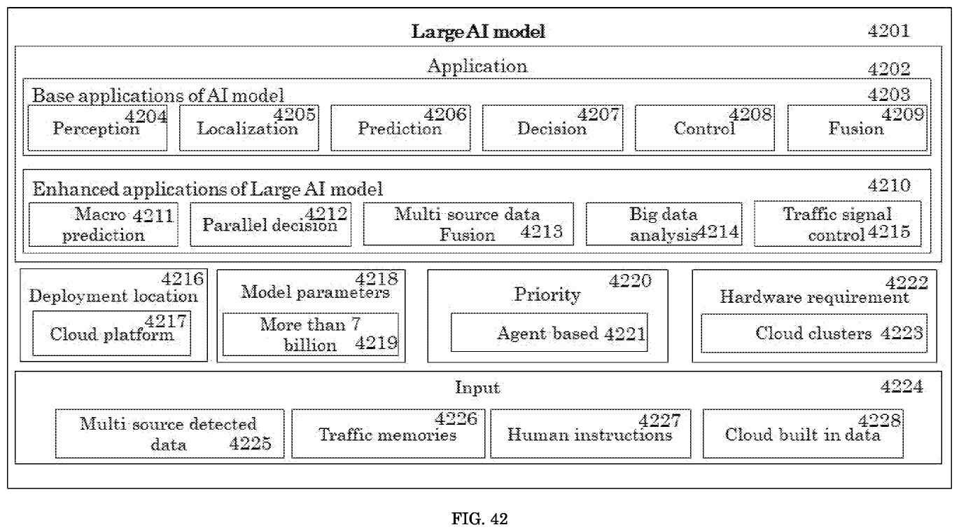

FIG. 42 shows a Large AI model 4201 with an Application layer 4202 comprising base modules-Perception 4204, Localization 4205, Prediction 4206, Decision 4207, Control 4208, and Fusion 4209, and enhanced modules 4210, including Macro Prediction 4211, Parallel Decision 4212, Multi-source Data Fusion 4213, Big Data Analysis 4214, and Traffic Signal Control 4215. It is deployed on a cloud platform 4217 as part of Deployment Location 4216. The model has more than 7 billion parameters 4219 under Model Parameters 4218, prioritizing agent-based tasks 4221 from the Priority module 4220. The Hardware Requirement 4222 specifies deployment on cloud clusters 4223.

The Input module 4224 supports Multi-source detected data 4225, Traffic memories 4226, Human instructions 4227, and Cloud built-in data 4228.

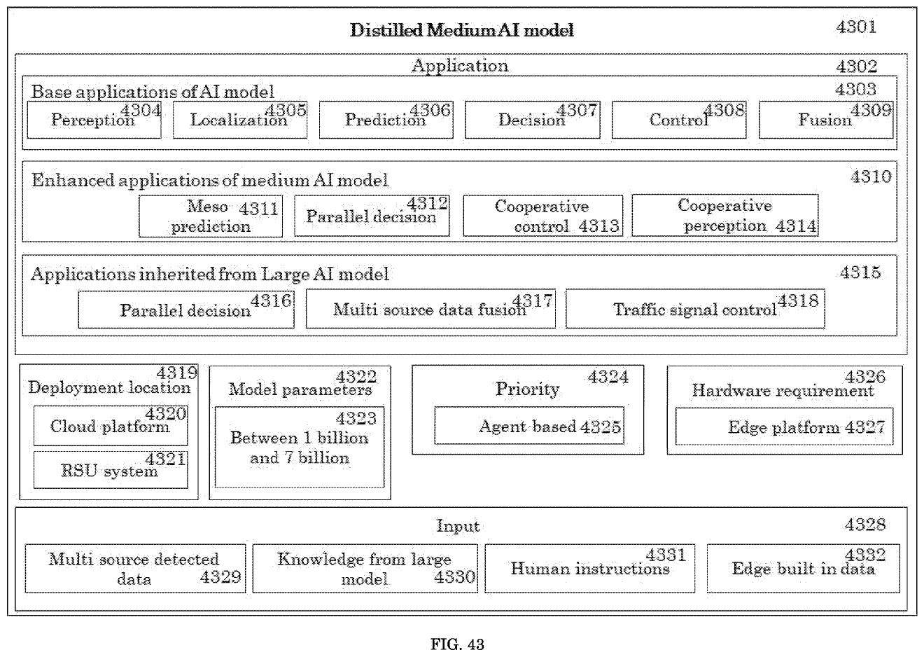

FIG. 43 illustrates a Distilled Medium AI model 4301 with an Application layer 4302 comprising base modules-Perception 4304, Localization 4305, Prediction 4306, Decision 4307, Control 4308, and Fusion 4309. The Enhanced applications 4310 include Meso Prediction 4311, Parallel Decision 4312, Cooperative Control 4313, and Cooperative Perception 4314. Inherited applications from a Large AI model 4315 include Parallel Decision 4316, Multi-source Data Fusion 4317, and Traffic Signal Control 4318. The model is deployed on cloud platforms 4320 and RSU systems 4321 as part of Deployment Location 4319. The Model Parameters 4322 indicate between 1 billion and 7 billion parameters 4323. The Priority module 4324 handles agent-based tasks 4325. The Hardware Requirement 4326 involves Edge platforms 4327. The Input module 4328 includes Multi-source detected data 4329, Knowledge from Large model 4330, Human instructions 4331, and Edge-built-in data 4332.

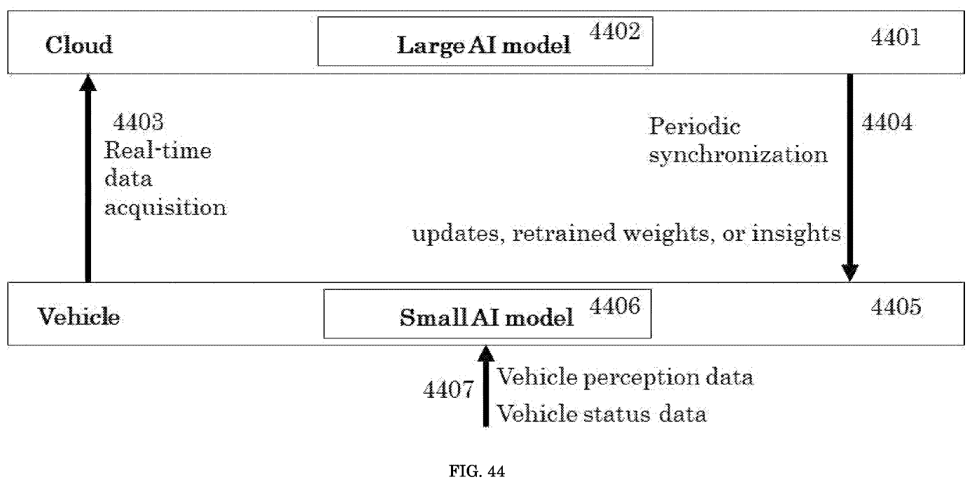

FIG. 44 shows the interaction between a Large AI model 4402 in the Cloud 4401 and a Small AI model 4406 in the Vehicle 4405. The vehicle sends perception and status data 4407 to the cloud for real-time data acquisition 4403. In return, the cloud provides periodic updates 4404, such as retrained weights or insights, ensuring the vehicle model stays current while maintaining local autonomy.

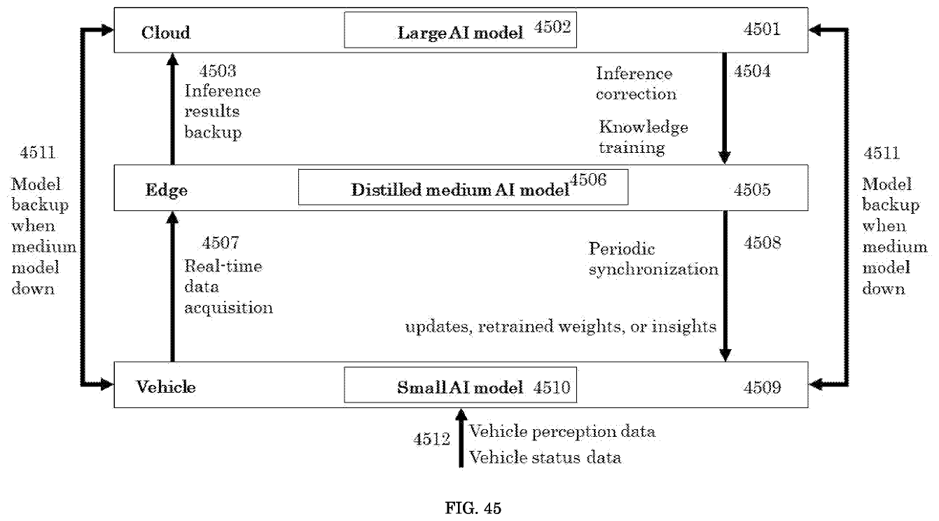

FIG. 45 illustrates the interaction between a Medium AI model 4502 in the vehicle 4505 and a Large AI model 4501 in the cloud. The vehicle sends perception and status data 4506, while the cloud acquires real-time data 4503 and periodically sends back updates or insights 4504. This setup provides the Medium AI model to benefit from enhanced cloud-driven updates while maintaining on-board intelligence.

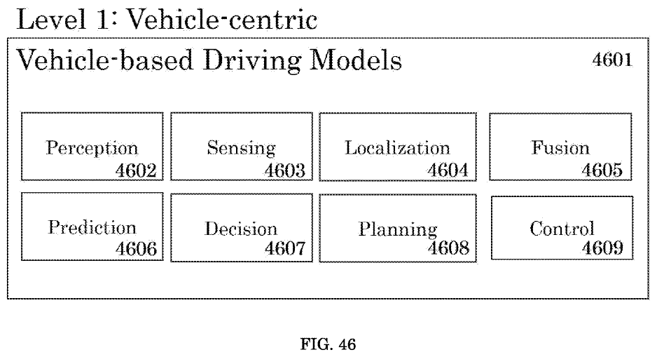

FIG. 46 shows the structure of Level 1: Vehicle-centric 4601, comprising Vehicle-based Driving Models with multiple driving functions, including Perception 4602, Sensing 4603, Localization 4604, Fusion 4605, Prediction 4606, Decision 4607, Planning 4608, and Control 4609. In this vehicle-centric configuration, all eight driving functions reside on the on-board platform, leveraging local sensor data and computation to facilitate autonomous driving operations without requiring external data or computing resources.

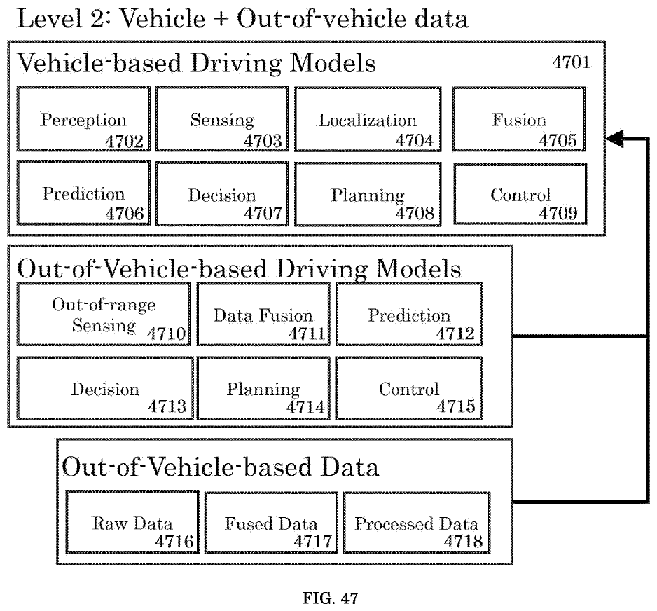

FIG. 47 shows the structure of Level 2: Vehicle+Out-of-vehicle data 4701, where the system's on-board platform hosts vehicle-based driving functions (Perception 4702, Sensing 4703, Localization 4704, Fusion 4705, Prediction 4706, Decision 4707, Planning 4708, and Control 4709) while simultaneously receiving and incorporating Out-of-Vehicle-based Driving Models (including Out-of-range Sensing 4710, Data Fusion 4711, Prediction 4712, Decision 4713, Planning 4714, and Control 4715). This level also includes Out-of-Vehicle-based Data sources, providing Raw Data 4716, Fused Data 4717, and Processed Data 4718. Consequently, the vehicle can augment its local perception and decision processes with external data feeds, providing more comprehensive situational awareness and refined autonomous functions.

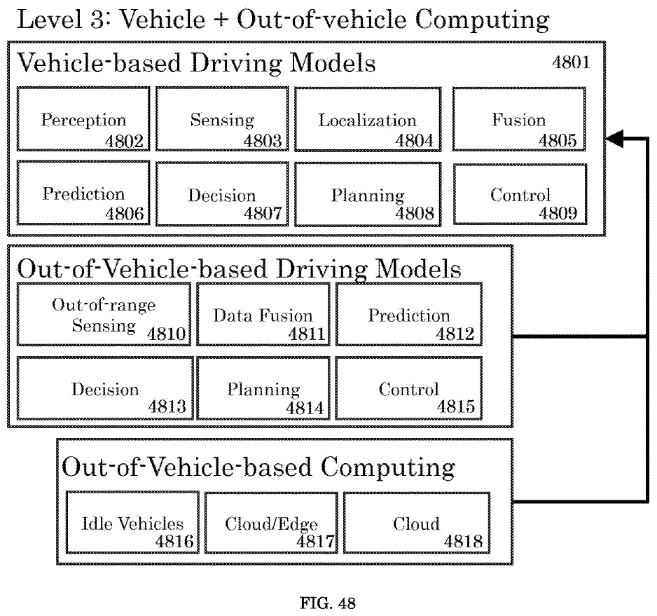

FIG. 48 shows the structure of Level 3: Vehicle+Out-of-vehicle Computing 4801, wherein the vehicle's on-board platform continues to host core driving functions (Perception 4802, Sensing 4803, Localization 4804, Fusion 4805, Prediction 4806, Decision 4807, Planning 4808, and Control 4809), while additional or heavy computational tasks are performed by Out-of-Vehicle-based Driving Models (Out-of-range Sensing 4810, Data Fusion 4811, Prediction 4812, Decision 4813, Planning 4814, Control 4815). In this configuration, Out-of-Vehicle-based Computing resources, such as Idle Vehicles 4816, Cloud/Edge servers 4817, and/or a Cloud platform 4818, are leveraged to handle complex or high-load computations, thereby reducing the processing burden on the vehicle and improving real-time performance under varying operational conditions.

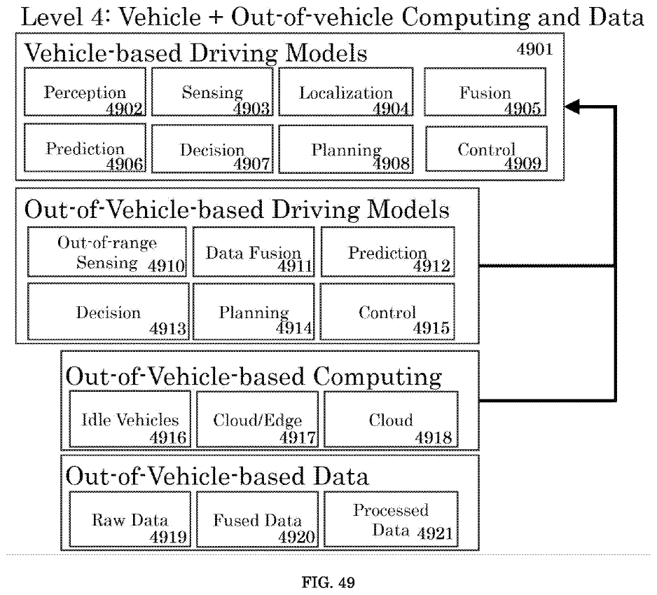

FIG. 49 shows the structure of Level 4: Vehicle+Out-of-vehicle Computing and Data 4901, in which the vehicle-based platform executes essential driving functions (Perception 4902, Sensing 4903, Localization 4904, Fusion 4905, Prediction 4906, Decision 4907, Planning 4908, and/or Control 4909), while additional driving functions are off-loaded to Out-of-Vehicle-based Driving Models (Out-of-range Sensing 4910, Data Fusion 4911, Prediction 4912, Decision 4913, Planning 4914, Control 4915) or shared among external resources. At this level, both Out-of-Vehicle-based Computing (Idle Vehicles 4916, Cloud/Edge 4917, Cloud 4918) and Out-of-Vehicle-based Data (Raw Data 4919, Fused Data 4920, Processed Data 4921) collectively provide robust support for the vehicle's autonomous tasks, ensuring the system can dynamically scale its sensing, computation, and model updates based on network availability, safety requirements, and route complexity.

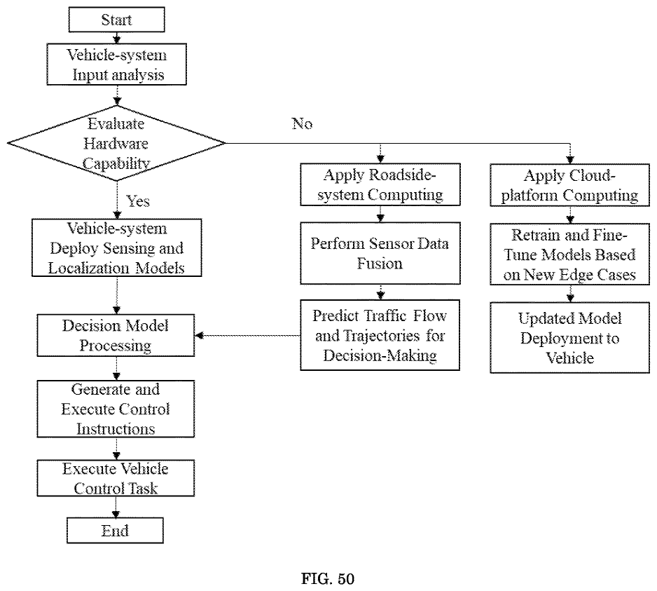

FIG. 50 shows the workflow of the vehicle operation process with roadside system integration and adaptive cloud-platform support. The process begins with vehicle-system input analysis. The workflow then proceeds to evaluate hardware capability. If the hardware capability meets the requirements, the process continues with deploying sensing and localization models on the vehicle system, followed by decision model processing, generating and executing control instructions, and executing the vehicle control task. If the hardware capability does not meet the requirements, the process branches into two paths. The first path applies roadside-system computing to perform sensor data fusion and predict traffic flow and trajectories for decision-making, which then feeds back into decision model processing. The second path applies cloud-platform computing to retrain and fine-tune models based on new corner cases, followed by updated model deployment to the vehicle, which then proceeds to decision model processing. The process concludes after executing the vehicle control task.

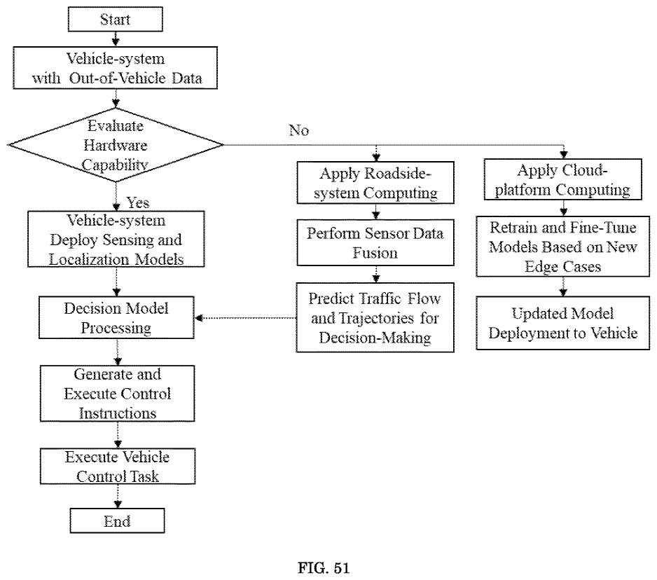

FIG. 51 shows the workflow of the multi-computing resource strategy for vehicle operation and control under varying hardware capabilities. The process begins with vehicle-system analysis using out-of-vehicle data. The workflow then proceeds to evaluate hardware capability. If the hardware capability meets the requirements, the process continues with deploying sensing and localization models on the vehicle system, followed by decision model processing, generating and executing control instructions, and executing the vehicle control task. If the hardware capability does not meet the requirements, the process branches into two paths. The first path applies roadside-system computing to perform sensor data fusion and predict traffic flow and trajectories for decision-making, which then feeds back into decision model processing. The second path applies cloud-platform computing to retrain and fine-tune models based on new corner cases, followed by updated model deployment to the vehicle, which then proceeds to decision model processing. The process concludes after executing the vehicle control task.

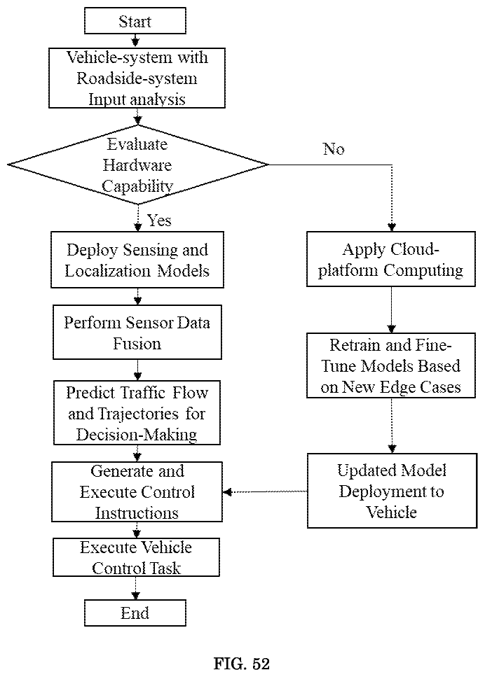

FIG. 52 shows the workflow of the vehicle operation process with roadside and cloud computing integration for control. The process begins with vehicle-system and roadside-system input analysis. The workflow then proceeds to evaluate hardware capability. If the hardware capability meets the requirements, the process continues with deploying sensing and localization models, followed by performing sensor data fusion, predicting traffic flow and trajectories for decision-making, generating and executing control instructions, and executing the vehicle control task. If the hardware capability does not meet the requirements, the process applies cloud-platform computing to retrain and fine-tune models based on new corner cases, followed by updated model deployment to the vehicle, which then proceeds to perform sensor data fusion. The process concludes after executing the vehicle control task.

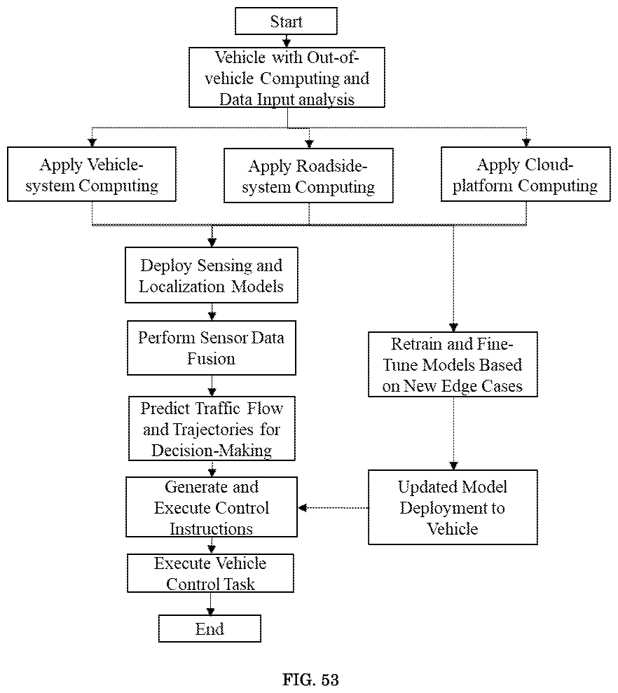

FIG. 53 shows the workflow of the dynamic vehicle control system using vehicle, roadside, and cloud computing for operation. The process begins with vehicle computing and data input analysis using out-of-vehicle data. The workflow then branches into three paths: applying vehicle-system computing, applying roadside-system computing, and applying cloud-platform computing. The vehicle-system computing path proceeds to deploy sensing and localization models, perform sensor data fusion, predict traffic flow and trajectories for decision-making, generate and execute control instructions, and execute the vehicle control task. The roadside-system computing path performs sensor data fusion and predicts traffic flow and trajectories for decision-making, which then feeds into generating and executing control instructions. The cloud-platform computing path retrains and fine-tunes models based on new corner cases, followed by updated model deployment to the vehicle, which then proceeds to perform sensor data fusion. The process concludes after executing the vehicle control task.

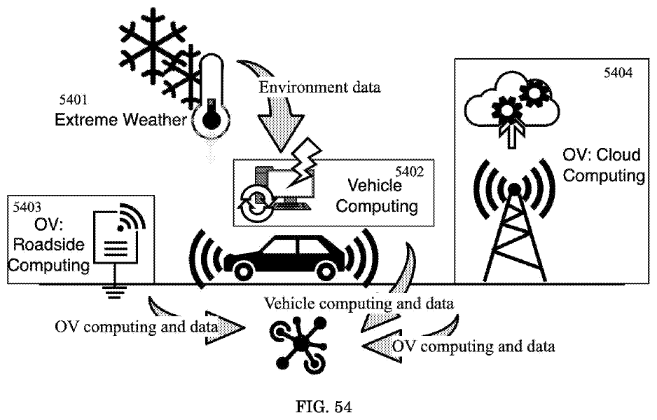

FIG. 54 shows an example of the Dynamic Vehicle Control System. Extreme Weather 5401 and other harsh environmental conditions can lead to the breakdown of the Vehicle Computing's 5402 hardware capabilities, rendering the onboard computing power insufficient. As out-of-vehicle systems, the Roadside Computing 5403 and the Cloud Computing 5404 are designed to offer data and computing support. The vehicle continuously engages in real-time exchanges of information and tasks with these out-of-vehicle systems. In turn, the Roadside Computing 5403 and Cloud Computing 5404 process this data and send back the optimized control instructions and relevant information, enhancing the vehicle's performance and optimizing resource usage under Extreme Weather 5401.

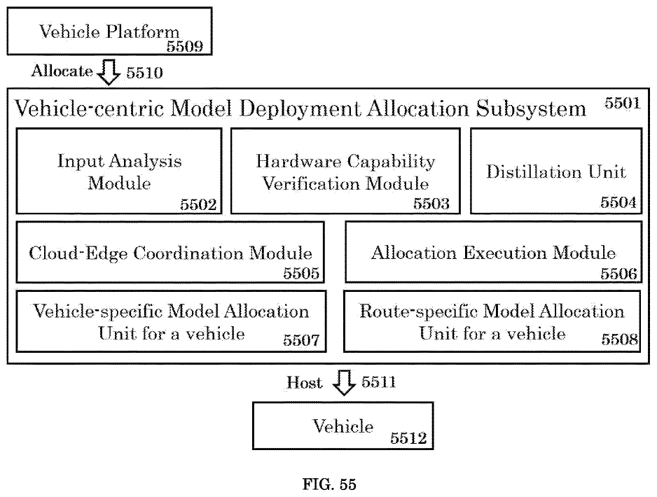

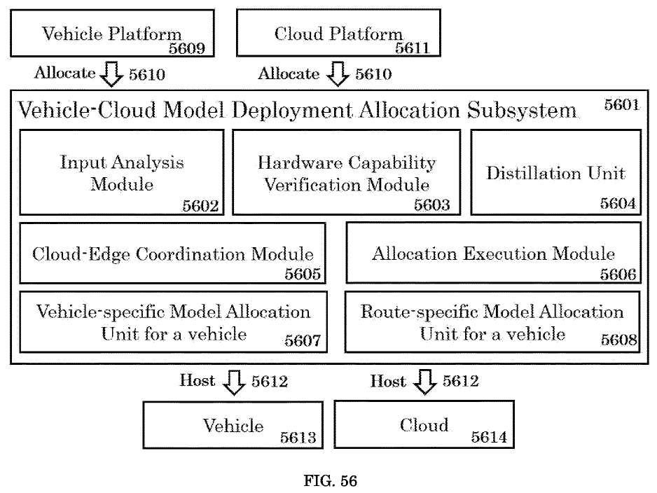

FIG. 55 shows the structure of a Model Deployment Allocation Subsystem 5501 for Vehicle-Centric System, which includes an Input Analysis Module 5502, a Hardware Capability Verification Module 5503, a Distillation Unit 5504, a Cloud-Edge Coordination Module 5505, an Allocation Execution Module 5506, a Vehicle-specific model allocation unit for a vehicle 5507, and a Route-specific model allocation unit for a vehicle 5508. This subsystem 5501 is configured to be hosted 5511 on a Vehicle 5512, receiving model allocation instructions from a Vehicle Platform 5509 through an Allocate 5510 mechanism. By verifying on-board capabilities and coordinating with any remote cloud or edge resources as needed, the subsystem 5501 ensures that the AI models and functions are properly deployed on the vehicle in a vehicle-centric manner.

FIG. 56 shows a Model Deployment Allocation Subsystem 5601 for a Vehicle-Cloud System, comprising an Input Analysis Module 5602, a Hardware Capability Verification Module 5603, a Distillation Unit 5604, a Cloud-Edge Coordination Module 5605, an Allocation Execution Module 5606, a Vehicle-specific model allocation unit for a vehicle 5607, and a Route-specific model allocation unit for a vehicle 5608. This subsystem 5601 is configured to be hosted 5612 on both a Vehicle 5613 and a Cloud 5614, receiving “allocate” instructions 5610 from a Vehicle Platform 5609 and a Cloud Platform 5611. The module coordinates how AI driving models are split or shared between the vehicle and the cloud, optimizing resource usage, bandwidth, and real-time constraints.

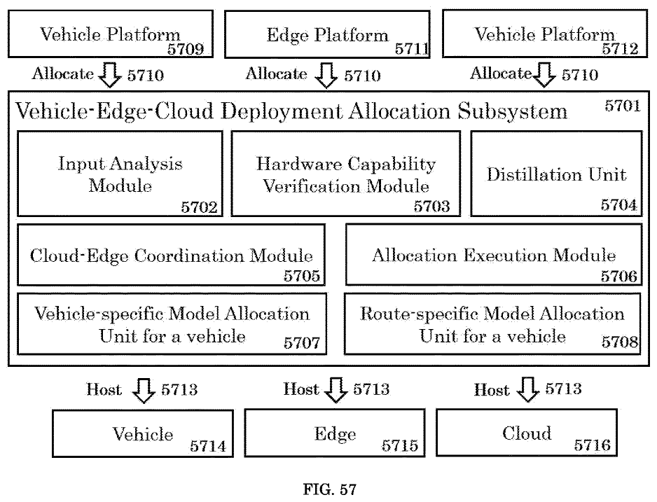

FIG. 57 shows a Deployment Allocation Subsystem 5701 for a Vehicle-Edge-Cloud System, comprising an Input Analysis Module 5702, a Hardware Capability Verification Module 5703, a Distillation Unit 5704, a Cloud-Edge Coordination Module 5705, an Allocation Execution Module 5706, a Vehicle-specific model allocation unit for a vehicle 5707, and a Route-specific model allocation unit for a vehicle 5708. The subsystem 5701 receives “allocate” instructions 5710 from a Vehicle Platform 5709, an Edge Platform 5711, or another Vehicle Platform 5712, and is hosted 5713 across a Vehicle 5714, an Edge 5715, and a Cloud 5716. By distributing AI model components and tasks among these three layers, the subsystem 5701 can dynamically adapt deployment based on network availability, processing load, and route complexity.

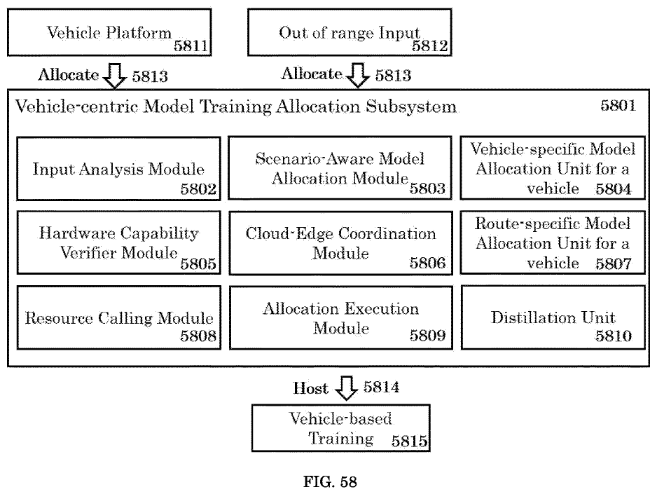

FIG. 58 shows a Model Training Allocation Subsystem 5801 for a Vehicle-Centric System, comprising an Input Analysis Module 5802, a Scenario-Aware Model Allocation Module 5803, a Vehicle-specific model allocation unit for a vehicle 5804, a Hardware Capability Verifier Module 5805, a Cloud-Edge Coordination Module 5806, a Route-specific model allocation unit for a vehicle 5807, a Resource Calling Module 5808, an Allocation Execution Module 5809, and a Distillation Unit 5810. The subsystem 5801 is hosted 5814 on a Vehicle-based Training 5815 platform, and it receives model allocation instructions 5813 from a Vehicle Platform 5811 or an Out-of-range Input 5812. In this vehicle-centric approach, on-board training tasks are managed primarily by the vehicle's local hardware and data resources, though external coordination may be used if desired.

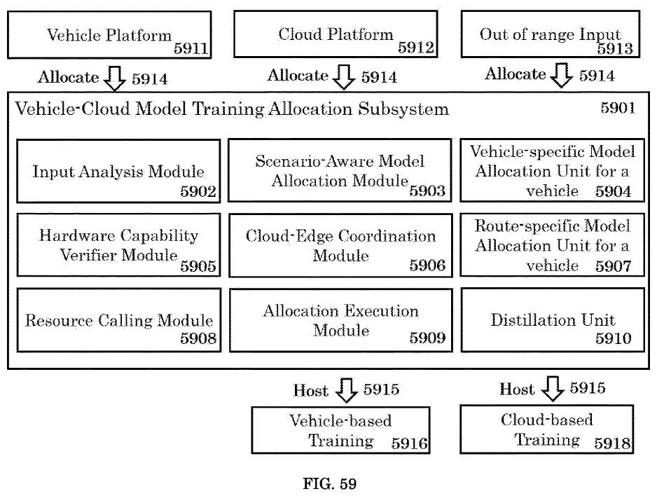

FIG. 59 shows a Model Training Allocation Subsystem 5901 for a Vehicle-Cloud System, comprising an Input Analysis Module 5902, a Scenario-Aware Model Allocation Module 5903, a Vehicle-specific model allocation unit for a vehicle 5904, a Hardware Capability Verifier Module 5905, a Cloud-Edge Coordination Module 5906, a Route-specific model allocation unit for a vehicle 5907, a Resource Calling Module 5908, an Allocation Execution Module 5909, and a Distillation Unit 5910. The subsystem 5901 is hosted 5915 so that training can occur in parallel on Vehicle-based Training 5916 and Cloud-based Training 5918, receiving “allocate” commands 5914 from a Vehicle Platform 5911, one or more Out-of-range Inputs 5912 and 5913, and external cloud resources. This design allows large-scale or compute-intensive training tasks to be offloaded to the cloud while critical real-time updates may continue on the vehicle.

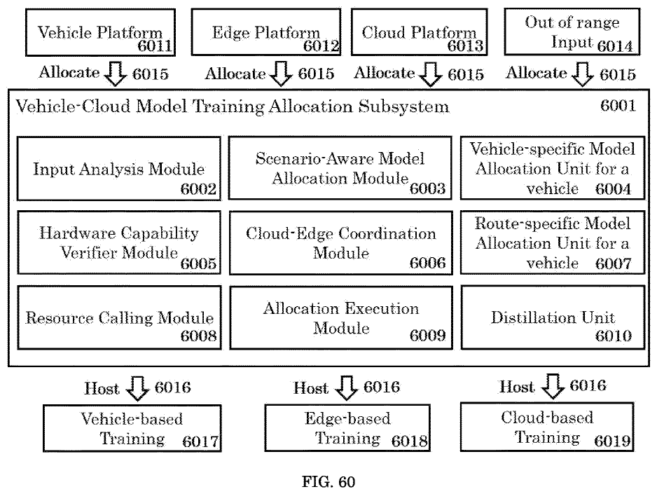

FIG. 60 shows a Model Training Allocation Subsystem 6001 for a Vehicle-Edge-Cloud System, comprising an Input Analysis Module 6002, a Scenario-Aware Model Allocation Module 6003, a Vehicle-specific model allocation unit for a vehicle 6004, a Hardware Capability Verifier Module 6005, a Cloud-Edge Coordination Module 6006, a Route-specific model allocation unit for a vehicle 6007, a Resource Calling Module 6008, an Allocation Execution Module 6009, and a Distillation Unit 6010. This subsystem 6001 receives “allocate” instructions 6015 from a Vehicle Platform 6011, an Edge Platform 6012, a Cloud Platform 6013, or an Out-of-range Input 6014, and is hosted 6016 to support Vehicle-based Training 6017, Edge-based Training 6018, and/or Cloud-based Training 6019. By dynamically distributing training tasks across the vehicle, edge nodes, and the cloud, the subsystem 6001 ensures efficient and scalable model updates tailored to real-time traffic conditions, bandwidth constraints, and evolving safety requirements.

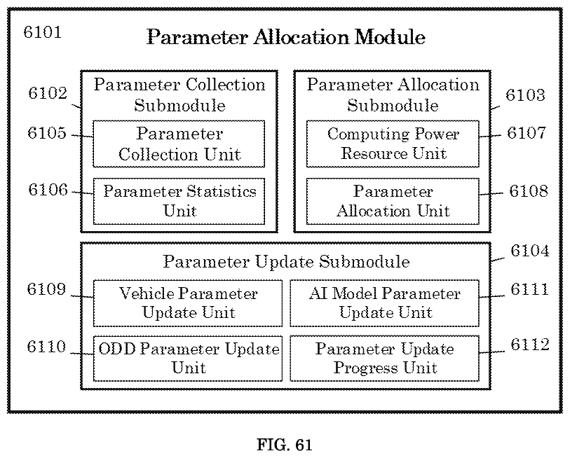

FIG. 61 shows the component structure of the Parameter Allocation Module. The Parameter Allocation Module 6101 comprises 3 submodules: Parameter Collection Submodule 6102, Parameter Allocation Submodule 6103, and Parameter Update Submodule 6104. Further, the Parameter Collection Submodule 6102 comprises structural components: Parameter Collection Unit 6105, and Parameter Statistics Unit 6106. The Parameter Allocation Submodule 6103 comprises structural components: Computing Power Resource Unit 6107, and Parameter Allocation Unit 6108. The Parameter Update Submodule 6104 comprises structural components: Vehicle Parameter Update Unit 6109, ODD Parameter Update Unit 6110, AI Model Parameter Update Unit 6111, and Parameter Update Progress Unit 6112.

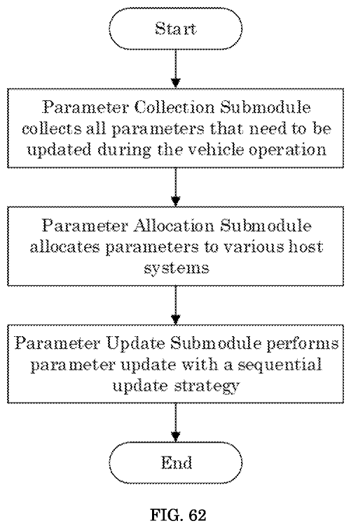

FIG. 62 shows the process of using the Parameter Allocation Module to provide parameter allocation and update during the vehicle operation. The Parameter Collection Unit collects all parameters that need to be updated during the vehicle operation and the Parameter Statistics Unit identifies the types of parameters and calculates the scales of parameters. The Computing Power Resource Unit calculates the available computing power of various host systems, and the Parameter Allocation Unit allocates parameters to various host systems according to the types and scales of parameters, and the computing power availability. The Parameter Update Submodule performs parameter update with a sequential update strategy.

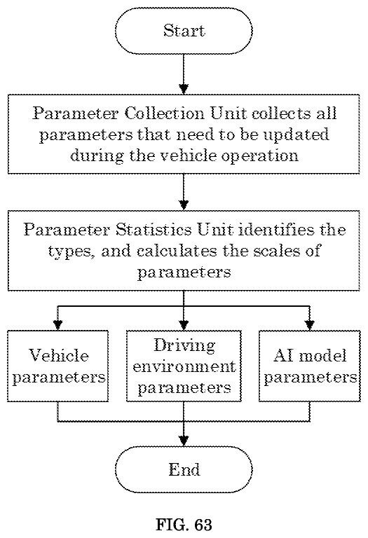

FIG. 63 shows the process of using the Parameter Collection Submodule to provide collection of parameters and/or statistical evaluation of parameters. The Parameter Collection Unit collects all parameters that need to be updated during the vehicle operation through the communication component. The Parameter Statistics Unit identifies the types of parameters, including vehicle parameters, driving environment parameters and AI model parameters. And the Parameter Statistics Unit calculates the scales of various types of parameters.

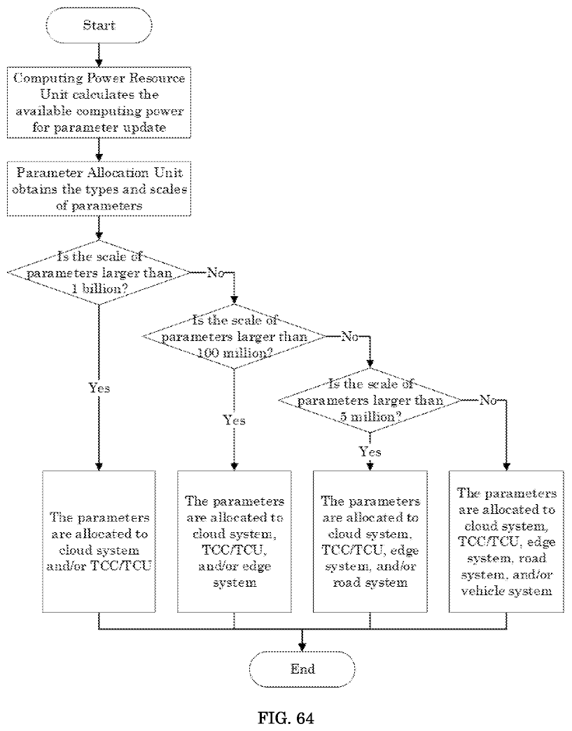

FIG. 64 shows the exemplary parameter allocation flowchart. The Computing Power Resource Unit calculates the available computing power of various host systems for parameter update. The Parameter Allocation Unit obtains the types and scales of parameters from the Parameter Statistics Unit of Parameter Collection Submodule and allocates the parameters to various host system groups according to the computing power availability. If the scale of parameters is larger than 1 billion parameters, the parameters are allocated to the host system group of cloud system and/or TCC/TCU. If the scale of parameters is larger than 100 million parameters and smaller than 1 billion parameters, the parameters are allocated to the host system group of cloud system, TCC/TCU, and/or edge system. If the scale of parameters is larger than 5 million parameters and smaller than 100 million parameters, the parameters are allocated to the host system group of cloud system, TCC/TCU, edge system, and/or road system. Otherwise, the parameters are allocated to the host system group of cloud system, TCC/TCU, edge system, road system, and/or vehicle system.

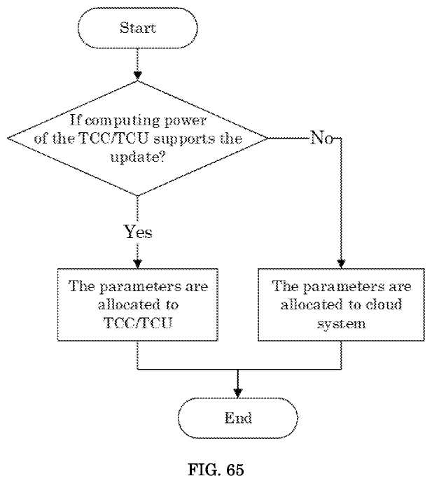

FIG. 65 shows the exemplary parameter allocation flowchart for using the Parameter Allocation Submodule to allocate parameters with a scale of more than 1 billion parameters to various host systems. If the computing power of the TCC/TCU supports the parameter update, the Parameter Allocation Submodule allocates the parameters to the TCC/TCU. Otherwise, the Parameter Allocation Submodule allocates the parameters to the cloud system.

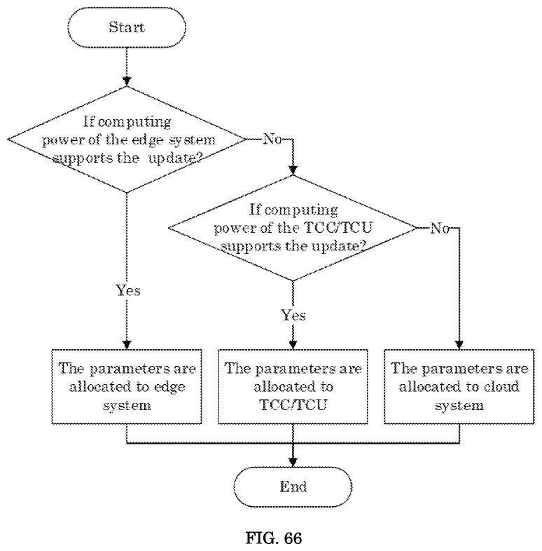

FIG. 66 shows the exemplary parameter allocation flowchart for using the Parameter Allocation Module to allocate parameters with a scale of 100 million parameters to 1 billion parameters to various host systems. If the computing power of the edge system supports the parameter update, the Parameter Allocation Submodule allocates the parameters to the edge system. Subsequently, if the computing power of the TCC/TCU supports the parameter update, the Parameter Allocation Submodule allocates the parameters to the TCC/TCU. Otherwise, the Parameter Allocation Submodule allocates the parameters to cloud system.

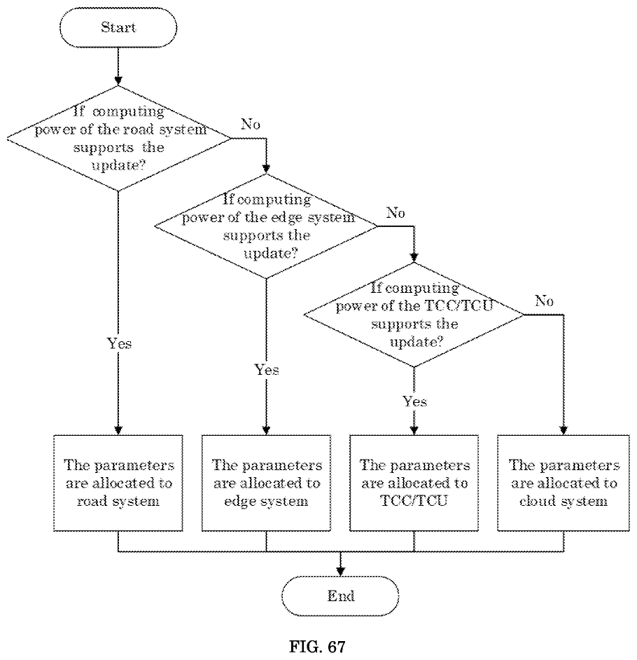

FIG. 67 shows the exemplary parameter allocation flowchart for using the Parameter Allocation Module to allocate parameters with a scale of 5 million parameters to 100 million parameters to various host systems. If the computing power of the road system supports the parameter update, the Parameter Allocation Submodule allocates the parameters to the road system. Subsequently, if the computing power of the edge system supports the parameter update, the Parameter Allocation Submodule allocates the parameters to the edge system. Then, if the computing power of the TCC/TCU supports the parameter update, the Parameter Allocation Submodule allocates the parameters to the TCC/TCU. Otherwise, the Parameter Allocation Submodule allocates the parameters to the cloud system.

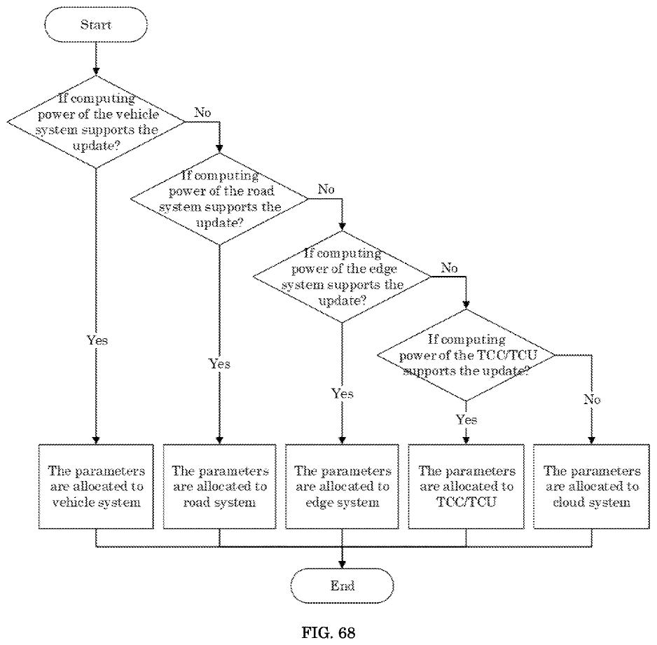

FIG. 68 shows the exemplary parameter allocation flowchart for using the Parameter Allocation Module to allocate parameters with a scale of less than 5 million parameters to various host systems. If the computing power of the vehicle system supports the parameter update, the Parameter Allocation Submodule allocates the parameters to the vehicle system. Then, if the computing power of the road system supports the parameter update, the Parameter Allocation Submodule allocates the parameters to the road system. Subsequently, if the computing power of the edge system supports the parameter update, the Parameter Allocation Submodule allocates the parameters to the edge system. Then, if the computing power of the TCC/TCU supports the parameter update, the Parameter Allocation Submodule allocates the parameters to the TCC/TCU. Otherwise, the Parameter Allocation Submodule allocates the parameters to the cloud system.

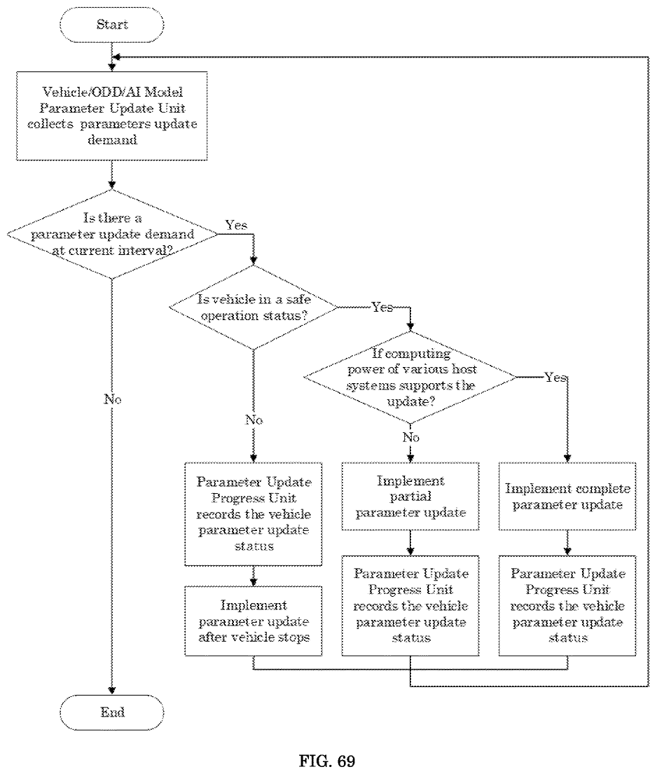

FIG. 69 shows the exemplary parameter update flowchart. The Vehicle Parameter Update Unit, ODD Parameter Update Unit, and/or AI Model Parameter Update Unit collects parameters update demand from the Parameter Allocation Submodule and decides if there is a parameter update demand at the current time interval. If there is no parameter update demand, the parameter update is ended. If there is a parameter update demand, but the vehicle is not in a safe operation status, the Parameter Update Progress Unit records the vehicle parameter update status, and the parameter update will be implemented after the vehicle stops. If there is a parameter update demand, and the vehicle is in a safe operation status, the parameter update will be implemented. If the computing power of various host systems supports the parameter update, the Vehicle Parameter Update Unit, ODD Parameter Update Unit, and/or AI Model Parameter Update Unit will implement complete parameter update, and the Parameter Update Progress Unit will record the vehicle parameter update status. Otherwise, the Vehicle Parameter Update Unit, ODD Parameter Update Unit, and/or AI Model Parameter Update Unit will implement partial parameter update, and the Parameter Update Progress Unit will record the vehicle parameter update status. At the next update interval, the Vehicle Parameter Update Unit, ODD Parameter Update Unit, and/or AI Model Parameter Update Unit will execute the same process considering the parameter update demand and the computing power availability.

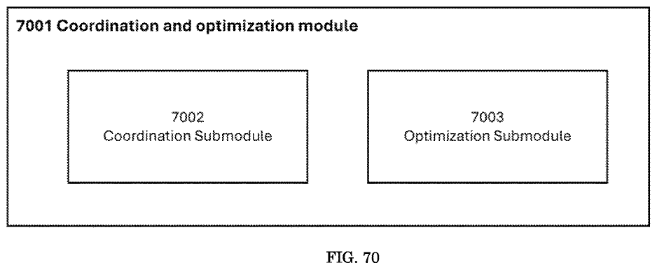

FIG. 70 shows the architecture of the Coordination and Optimization Module. The Coordination and Optimization Module comprises a Coordination Submodule and an Optimization Submodule to manage the AI model, computing power, and data.

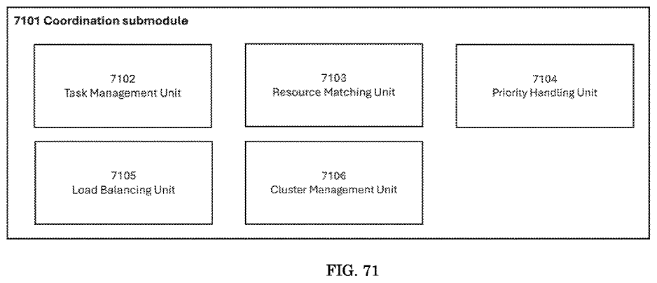

FIG. 71 shows the architecture of the Coordination Submodule. The Coordination Submodule is configured to comprise a Task Management Unit, a Resource Matching Unit, a Priority Handling Unit, a Load Balancing Unit, and a Cluster Management Unit to organize, manage, and sequence the execution of tasks based on the resources that have already been allocated.

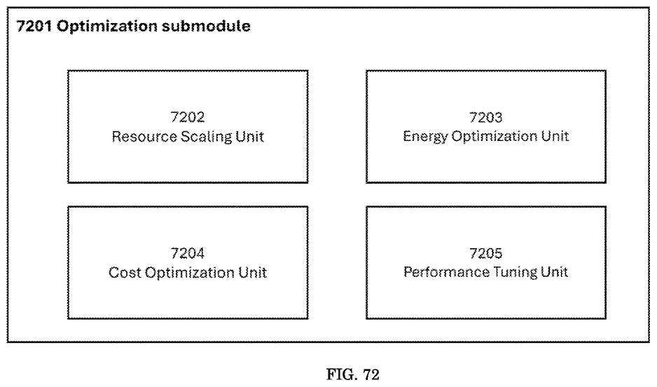

FIG. 72 shows the architecture of the Optimization Submodule. The Optimization Submodule comprises a Resource Scaling Unit, Energy Optimization Unit, Cost Optimization Unit, and Performance Tuning Unit to ensure that the allocated resources are used as efficiently as possible, and the tasks are executed with maximum performance.

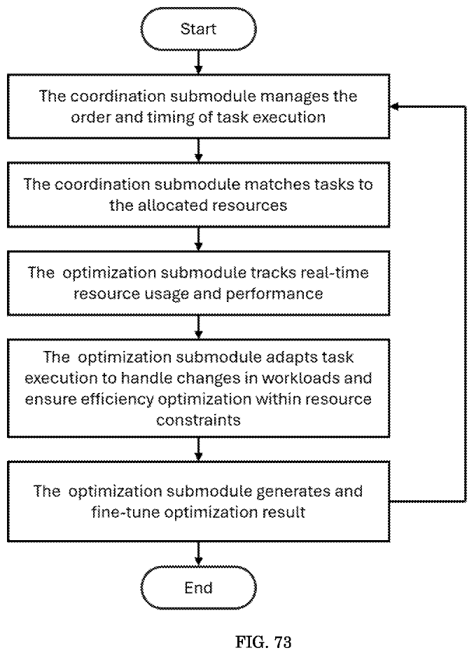

FIG. 73 illustrates the flowchart of the Coordination and Optimization Module. The process begins with the coordination submodule, which manages the order and timing of task execution. Next, it matches tasks to the allocated resources to ensure proper task-resource alignment. Following this, the optimization submodule takes over. It monitors real-time resource usage and system performance, then dynamically adapts task execution to respond to workload fluctuations while maintaining efficiency within resource constraints. Finally, the optimization submodule generates and fine-tunes the optimization results. These results are fed back to the coordination submodule, initiating the next cycle of task execution.

### Distributed AI System

In some embodiments, a distributed Artificial Intelligence (AI) system for autonomous driving comprises one or more of an AI model component, a computing power component, and/or a data component.

In some embodiments, the AI system includes an AI Allocation Subsystem and an Operating and Management Subsystem. In some embodiments, the AI Allocation Subsystem comprises one or more of a Computing Allocation Module, a Data Allocation Module, a Model Allocation Module, and/or a Parameter Allocation Module. In some embodiments, the Operating and Management Subsystem comprises one or more of a Coordination and Optimization Module and an Execution Module.

In some embodiments, the AI system comprises one or more of the following hardware components: a Communication Component, a Computing Component, a Power Supply Component, and/or a Sensing Component.

In some embodiments, the AI system can be hosted on one or more of the five components: a vehicle system, a Roadside Unit (RSU) system, an edge system, a Traffic Control Center/Traffic Control Unit (TCC/TCU), and/or a cloud platform.

In some embodiments, the AI system is configured to be customized and/or personalized for a vehicle, incorporating the AI Allocation Subsystem and the Operating and Management Subsystem tailored for that specific vehicle. The personalized AI system can be trip-specific, route-specific, road-specific, operational design domain (ODD)-specific, and/or vehicle-specific, wherein the ODD-specific AI system is customized based on season, weather, and/or light conditions. In some embodiments, the customized AI system applies a data distillation method to refine trip parameters for optimized decision-making. Customization can be based on user or trip priority, including factors such as fee payment and urgency.

In some embodiments, the AI model component comprises one or more of a mini model, a small model, a medium model, and a large model, allocated and selected based on system capabilities and requirements. The mini model and the small model are deployed in the vehicle system; the mini model, the small model, and the medium model are deployed in the RSU and/or the edge systems. Furthermore, the mini model, the small model, the medium model, and the large model are deployed in the TCC/TCU and/or the cloud platform.

In some embodiments, the Model Allocation Module is configured to allocate and host these models as needed. In some embodiments, the AI model component is trained and deployed for a vehicle by the cloud platform and/or the edge system, using one of the following training and deployment methods: (a) both the trained model and the data are dynamically updated; (b) the trained model is deployed in a vehicle and updated in real-time, while the data are updated using a dynamic update method; (c) the trained model is deployed in a vehicle and updated dynamically, while the data are updated in real-time; and (d) both trained model and the data are updated simultaneously in real-time using an integrated training and deployment method.

In some embodiments, for safety reasons, the dynamic update method or real-time update method is used for updating the AI model in the vehicle. In some embodiments, the real-time updates use intervals ranging from 1 millisecond to 1 second, while the dynamic updates use intervals from 1 second to several days. The AI model can incorporate new data instantaneously upon receipt for adaptive responses without latency and undergo periodic data-driven modifications for performance refinement over time.

In some embodiments, the AI model component supports integrated training and deployment through the RSU system, the edge system, and/or the cloud platform, facilitating personalized AI systems for autonomous vehicles.

In some embodiments, the Communication Component provides real-time data exchange through various networks, including 3G, 4G, 5G, 5.5G, 6G, digital radio, Bluetooth, Wi-Fi, and satellite communication, which ensures reliable deployment and updating of the AI system using real-time or dynamic update methods. The communication component also supports traditional networks, such as 3G, 4G, and digital radio, to maintain AI system functionality even when advanced communication networks are unavailable.

In some embodiments, the AI System configured to be hosted in the vehicle provides a customized and/or personalized AI system, that is trip-specific, route-specific, road-specific, ODD-specific, and/or vehicle-specific for the vehicle's operation, applying a distillation method to refine trip parameters and optimize decision-making based on the vehicle's operational constraints, user-defined priorities, and trip-specific requirements.

### Computing Power Allocation Module

In some embodiments, the Computing Power Allocation Module comprises one or more of a Static Computing Power Allocation Submodule and a Dynamic Computing Power Allocation Submodule. In some embodiments, the Computing Power Allocation Module integrates both Static and Dynamic Computing Power Allocation Submodules to achieve a hybrid strategy for computing resource management. The Static Submodule performs pre-trip assessments, identifying available computing resources and forecasting expected demand based on planned routes and operational parameters. Complementarily, the Dynamic Submodule responds to real-time internal and external changes during vehicle operation, continuously adjusting allocations based on current computing power availability and situational requirements. This combined approach ensures both anticipatory and adaptive allocation of computing resources, enhancing reliability and efficiency across diverse driving scenarios.

In some embodiments, the Static Computing Power Allocation Submodule conducts a pre-trip or periodically scheduled resource assessment. In some embodiments, the Static Computing Power Identification Unit of the Static Computing Power Allocation Submodule enumerates all known computing resources that may be available to the vehicle, while in some embodiments the Computing Power Needs Identification Unit calculates the estimated load by analyzing sensor configuration (e.g., multiple LiDARs, millimeter-wave radars, high-resolution cameras), route complexity, ODD constraints, and any specialized AI algorithms employed by the vehicle.

In some embodiments, the Deficiency Computation Unit of the Static Computing Power Allocation Submodule quantifies whether the onboard CPU/GPU or other computing resources (e.g., Quantum Processing Unit (QPU)) can handle the load or if off-vehicle resources, such as idle vehicle GPUs or regional edge servers, are necessary. In some embodiments, the Computing Power Allocation Unit performs a baseline allocation plan—for example, reserving 40% of onboard GPU capacity for immediate perception tasks, 20% for local path planning, and 40% for delegation to a cloud platform for advanced route optimization and large-scale data fusion.

In some embodiments, the static computing power allocation is complemented by a vehicle-centric or vehicle-based computing platform that serves as the host environment for the Static Computing Power Allocation Submodule's implementation, ensuring that even if connectivity to the RSU or the cloud is lost, the vehicle maintains a functional baseline of computing capacity for safe operation.

In some embodiments, the Dynamic Computing Power Allocation Submodule takes over once the trip is underway, continuously monitoring both internal factors (using the Internal Change Identification Unit to detect variations in sensor states, battery levels, CPU/GPU loads) and external factors (using the External Change Identification Unit to evaluate variations such as traffic congestion, weather changes, and road conditions) to fine-tune resource distribution.

In some embodiments, the Computing Power Needs Identification Unit recalculates the immediate or near real-time computing requirements of the vehicle's autonomy stack. In some embodiments, if demand outstrips onboard resources, the Deficiency Computation Unit computes the shortfall in GPU cycles, CPU threads, Quantum Processing Unit (QPU), Tensor Processing Uni (TPU), Data Processing Unit (DPU), or memory, and in some embodiments the Computing Power Allocation Unit promptly reallocates resources. For example, if the onboard NVIDIA GeForce RTX 4090 is operating at maximum capacity, in some embodiments the system may offload 3D object segmentation tasks to an idle vehicle equipped with an NVIDIA Tesla T4 GPU (16 GB GDDR6 memory) or to a local edge computing server with an INTEL XEON Gold 6258R (28 cores, 56 threads, 2.7 GHz base).

In some embodiments, the Distillation Unit personalizes the distribution of computing resources by factoring in route-specific, road-specific, vehicle-specific, and ODD-specific conditions, such that when the route transitions from a straightforward highway to a complex city center, the Distillation Unit redirects additional processing capacity toward advanced computer vision algorithms. In some embodiments, if the ODD expands to include nighttime operation in inclement weather, the Distillation Unit increases sensor data fusion tasks to ensure the GPU and CPU allocations can handle inputs from thermal cameras, emergency brake assist logic, and overhead from streaming updates via 5G or satellite communication.

In some embodiments, the Vehicle-Specific Computing Power Resource Allocation Unit ensures that vehicles with unique hardware setups or usage profiles receive resource allocations best suited to their tasks, while in some embodiments the Route-Specific Computing Power Resource Allocation Unit optimizes allocations for segments with known complexities, such as mountain passes or busy urban corridors with frequent traffic light changes.

In some embodiments, the Road-Specific Computing Power Resource Allocation Unit manages computing distribution based on real-time feedback about road surface conditions, lane closures, or construction zones, and in some embodiments the ODD-specific Computing Power Resource Allocation Unit tailors computing resources when the operational design domain changes, for example, switching from fully autonomous mode to driver-supervised mode in restricted areas or increasing real-time computations in heavy snow or severely reduced visibility conditions.

In some embodiments, advanced connectivity technologies such as 5G or 6G cellular, Bluetooth, Wi-Fi 6E, or satellite communication underpin the real-time reallocation of computing tasks. In some embodiments, if a sudden event-specific condition arises (e.g., a pop-up street fair blocking several downtown blocks), the External Change Identification Unit flags the situation, and the Distillation Unit quickly determines that additional (e.g., additional 10%, 15%, 20%, 25%, or 30%) GPU overhead is needed for frequent path recalculations, leading to the engagement of an idle vehicle's GeForce RTX 3070 GPU or the signaling of an edge node to spin up extra GPU containers.

In some embodiments, the synergy of the static and dynamic approaches ensures a robust operational framework for all levels of autonomy and all ODDs. In some embodiments, by planning a foundational resource distribution (e.g., verifying each vehicle's baseline GPU usage, memory reservations, and fallback options to idle vehicle resources) and combining this with agile, on-the-fly adjustments, the system smoothly meets computational surges. In some embodiments, this agile distribution architecture ensures that even in worst-case or unexpected scenarios-such as extreme weather shifts or critical sensor malfunctions, no single vehicle is overwhelmed, as the system leverages every available platform from the nearest RSU's modest Intel Xeon E3 resources to a distant but highly capable cloud HPC service with clusters of NVIDIA A100 or H100 GPUs.

### Data Allocation Module

In some embodiments, the data utilized in the system comprises Vehicle data, Operational Design Domain (ODD) data, and System data.

In some embodiments, the Vehicle data comprises vehicle parameters, mechanical condition data, sensor data, and/or historical driving pattern data. In some embodiments, vehicle parameters define the state and behavior of the vehicle, including current speed, acceleration, braking activity, fuel level, battery status (for electric vehicles), and/or real-time vehicle diagnostics. In some embodiments, mechanical condition data includes information on engine performance, oil pressure, tire pressure, brake wear levels, and/or suspension status. In some embodiments, sensor data consists of outputs from LiDAR, radar, cameras, and ultrasonic sensors, capturing the surrounding environment, and detecting obstacles, lane markings, and traffic signs. In some embodiments, historical driving pattern data include data on past driving behaviors, such as average speed, frequent routes taken, acceleration tendencies, and braking patterns, which can be used for predictive analytics and personalized driving assistance.

In some embodiments, ODD data provides contextual information that affects vehicle operations. The ODD data includes weather condition data, road condition data, infrastructure data, and external hazard data. In some embodiments, weather condition data includes real-time temperature, precipitation levels (e.g., rain, snow, fog), wind speed, and visibility conditions that can impact vehicle performance and safety measures. In some embodiments, road condition data includes details on pavement quality, road friction levels, potholes, and temporary road work zones that may require route adjustments or speed modifications. In some embodiments, infrastructure data include information about road networks, traffic signals, toll booths, speed limits, and parking availability, providing intelligent route planning and compliance with traffic regulations. In some embodiments, external hazard data contain information on unexpected obstacles such as fallen trees, construction zones, pedestrian crossings, and emergency vehicle activities.

In some embodiments, the System data include metadata, communication protocols, data transaction logs, and/or system configuration parameters. In some embodiments, metadata includes timestamps, data source identification, and sensor calibration details, ensuring accurate synchronization and interpretation of collected data. In some embodiments, communication protocols define the data exchange standards between different components, such as vehicle-to-vehicle (V2V) and vehicle-to-infrastructure (V2I) communication. In some embodiments, data transaction logs provide a record of all data exchanges and updates, ensuring traceability and reliability in decision-making. In some embodiments, system configuration parameters include details on software versions, algorithm configurations, security settings, and optimization parameters that govern the AI systems' decision-making and performance.

In some embodiments, the Data Allocation Module serves as the core component responsible for managing the distribution, integration, and prioritization of data across the vehicle, the RSU, the Edge, the Cloud, and the Traffic Control Center (TCC). The Data Allocation Module provides intelligent allocation of data resources by dynamically adjusting strategies based on data characteristics such as urgency, volume, update frequency, and intended use. By supporting fine-grained control over how data are shared across different levels of the system including individual vehicles, infrastructure units, and cloud platforms, the Data Allocation Module ensures that each component receives the most relevant subset of information tailored to its operational needs. Such granularity in data allocation improves efficiency, reduces redundant transmission, and enhances the system's ability to respond to real-time demands. The Data Allocation Module is configured for On-board Data Allocation Application and an Off-board Data Allocation Application.

In some embodiments, for Off-board Data Allocation Application, the Data Allocation Module is responsible for collecting data from various sources, including vehicles, the RSU, the Edge, the Cloud, and the Traffic Control Center (TCC). The Data Allocation Application Module then distributes the collected data to other vehicles, the RSUs, the Edge, the Cloud, and the Traffic Control Center (TCC), providing a seamless exchange of critical information across the entire system. In some embodiments, an RSU gathers traffic data from multiple vehicles and transmits it to the Edge or the Cloud for processing; once processed, the data are redistributed to other RSUs and vehicles through the Data Allocation Module, ensuring an updated and coherent flow of information for improved decision-making.

In some embodiments, for On-board Data Allocation Application, the Data Allocation Module operates within individual vehicles, collecting data from external sources such as RSUs, Edge computing nodes, Cloud infrastructure, TCC, and other vehicles. The Data Allocation Module then distributes or integrates the data specifically among vehicles to enhance localized situational awareness and coordination. In some embodiments, where multiple connected vehicles are operating within a network, each vehicle's Data Allocation Module receives data from the RSU, the Edge, the Cloud, and the TCC, as well as from neighboring vehicles; the Data Allocation Module within each car processes this data, determines its relevance, and redistributes it among the vehicles in the network, which allows the fleet to dynamically adjust to road conditions, potential hazards, and optimal routing strategies while maintaining a decentralized yet synchronized data-sharing mechanism. Such an approach ensures that every vehicle has access to comprehensive and up-to-date information, enhancing overall system intelligence and decision-making efficiency.

In some embodiments, the Data Allocation Module includes various functional units to ensure efficient data processing and distribution, which comprises a Data Collection Unit, a Data Measurement Unit, a Data Allocation Unit, a Big Data Preprocessing Unit, and/or a Data Distillation Preparation Unit.

In some embodiments, the Data Collection Unit includes an Offboard Collection Subunit and an Onboard Collection Subunit. The Offboard Collection Subunit is configured to collect onboard sensors data and vehicle condition data. The Onboard Data Collection Subunit is configured to collect data from other vehicles, RSUs, TCCs, TCUs, the Edge, and the Cloud.

In some embodiments, the Data Measurement Unit comprises several components to evaluate different aspects of the collected data. The Detectable Data Identification Component identifies if the collected data are detectable for further processing. The Data Sizing Component determines the size of the data. The Model Sizing Component identifies the size of models utilizing the data for training or inference. The Update Frequency Determination Component determines how frequently the data needs to be updated.

In some embodiments, the Data Allocation Unit plays a crucial role in providing granularity in data allocation by dynamically adjusting allocation strategies based on real-time system demands. The Data Allocation Unit receives measurement results from the Data Measurement Unit, including data size, model size, detectability, and update frequency. Using these measurements, the Data Allocation Unit ensures precise allocation tailored to varying system conditions.

In some embodiments, the Data Management Component queues data for transmission, ensuring that data are well-organized and prioritized based on relevance and urgency. The Data Allocation Strategy Component dynamically refines allocation strategies by considering multiple factors such as data urgency, network conditions, processing capacity, and system requirements.

In some embodiments, the data urgency is determined based on the criticality of information for real-time decision-making, with higher priority given to safety-critical data such as collision warnings, sensor anomalies, and emergency braking events. In some embodiments, network conditions are assessed based on available bandwidth, latency, and signal strength, dynamically adjusting data transmission rates and prioritization to maintain efficient communication among the vehicle, infrastructure, and cloud. In some embodiments, the processing capacity is evaluated based on computational load and available resources of the vehicle and the cloud, providing intelligent offloading of high-complexity tasks to the cloud while ensuring time-sensitive computations are processed locally for optimal performance. By continuously optimizing the allocation approach, the system provides fine-grained control over data distribution, ensuring that critical data are allocated where and when it is needed most while minimizing resource waste.

In some embodiments, the Big Data Preprocessing Unit comprises the Data Quality Measurement Component, the Data Preprocessing Component, and the Data Fusion Component. The Data Quality Measurement Component evaluates data quality, including missing values, duplications, and validity. The Data Preprocessing Component cleans and preprocesses data, including handling missing values, removing duplicates, and formatting data for validity. The Data Fusion Component integrates preprocessed data from multiple sources for enhanced reliability.

In some embodiments, the Data Distillation Preparation Unit is designed to refine and optimize data distribution for model training and validation. In some embodiments, the Data Distillation Preparation Unit comprises the Vehicle-Specific Data Preparation Component for training vehicle models, the Route-Specific Data Preparation Component for training models based on specific routes, the Road-Specific Data Preparation Component for road-dependent model training, the ODD-Specific Data Preparation Component for optimizing models according to different operational design domains, and the Trip-Specific Data Preparation Component for refining models based on trip characteristics.

In some embodiments, the AI system is hosted in a vehicle, a cloud, or both, incorporating a Data Allocation Module to provide customized and personalized data allocation based on vehicle-specific, route-specific, road-specific, and ODD-specific parameters. In some embodiments, the data allocation optimization is achieved using a distillation method, ensuring the efficient selection and distribution of data based on its relevance and impact on model training and inference.

### Model Allocation Module

In some embodiments, the AI model component comprises a warehouse of AI models that serve as a comprehensive repository of various artificial intelligence algorithms designed to perform a range of autonomous driving functions. This warehouse of AI models contains models capable of achieving sensing functions for data collection, perception functions for environmental awareness, localization functions for precise positioning, fusion functions for integrating multiple data sources, prediction functions for anticipating traffic scenarios, planning functions for route optimization, decision-making functions for determining appropriate actions, and control functions for vehicle operation. The warehouse architecture provides systematic organization, categorization, and retrieval of AI models based on their functional capabilities, computational requirements, and operational domains.

In some embodiments, the warehouse of AI models comprises multiple types of AI technologies, including deep-learning models for pattern recognition and feature extraction, AI agents for decision-making in complex environments, reinforcement learning models for optimizing driving behaviors through reward mechanisms, generative models for simulating driving scenarios, foundation models pre-trained on large datasets for transfer learning applications, and swarm intelligence models for coordinated multi-vehicle operations. This diverse collection allows for flexible deployment of appropriate AI technologies based on specific autonomous driving needs and computational constraints.

In some embodiments, the AI model component is configured as a unified AI driving model that integrates multiple specialized models from the warehouse into a cohesive system. This unified model harmonizes the interactions among perception, prediction, planning, and control functions to provide comprehensive driving intelligence. Unlike traditional autonomous driving systems with distinct modules operating in sequence, the unified approach allows for information sharing across components, resulting in more contextually aware decision-making and smoother vehicle operation.

In some embodiments, the AI model component is configured as an end-to-end model for autonomous driving, which maps raw sensory inputs directly to vehicle control outputs. This approach minimizes the need for intermediate representations and handcrafted features, instead of learning the optimal transformations from data. The end-to-end model reduces system complexity and potential points of failure by eliminating distinct perception, prediction, and planning modules, while potentially improving performance through holistic optimization

In some embodiments, the AI model component is configured as a point-to-point or a parking-to-parking model for autonomous driving, which manages the complete journey from the initial parking position to destination parking position. The point-to-point or parking-to-parking model comprises the entire travel experience, handling both the complexities of navigating structured roadways and the intricacies of parking area operations with varied surface markings, dynamic pedestrian movements, and constrained maneuvering spaces. The point-to-point or parking-to-parking model integrates specialized perception capabilities for identifying available parking spaces, and precise localization in parking structures.

In some embodiments, the AI model component is configured as a world model for autonomous driving, which maintains an internal representation of the external environment and simulates its evolution over time. This world model captures the dynamics of traffic participants, predicts their future states, and provides the vehicle to anticipate changes before they occur. The world model approach enhances decision-making by allowing the system to mentally simulate the outcomes of different actions before execution, leading to safer and more proactive driving behaviors.

In some embodiments, the Model Allocation Module allocates AI models from the warehouse according to the mathematical equation M=F(V,OV), where M represents the output combination of AI models, V represents the set of vehicle-based AI models, OV represents the set of out-of-vehicle-based AI models, and Fis a function determining how V and OV cooperate to produce M. This allocation aims to achieve a specific level of automation while satisfying both safety requirements through redundancy and robust performance as well as computing resource constraints. The function F incorporates factors such as model compatibility, data flow requirements, and computational load balancing to optimize the overall system performance.

In some embodiments, the function F in the equation is implemented as an Empirical Function derived from experimental data and practical experience, a Statistical Function based on probabilistic analysis of performance metrics, or an AI/Learning Function that continuously adapts allocation decisions based on operational feedback. These implementations provide the Model Allocation Module to optimize model selection based on historical performance data, current operational conditions, and predictive analytics of future scenarios.

In some embodiments, the set of vehicle-based AI models V is configured to operate within strict constraints imposed by the vehicle's computational environment. These constraints include computing power limitations of onboard processors, data availability from vehicle sensors, power consumption restrictions based on the vehicle's energy capacity, and communication bandwidth limitations for data exchange. The vehicle-based models are specifically optimized to deliver reliable performance while respecting these operational boundaries.

In some embodiments, the set of out-of-vehicle-based AI models OV is configured to complement onboard processing by utilizing external computing resources while still respecting the vehicle's operational constraints. These models are designed to operate within the limits of available computing power accessible to the vehicle, the constraints of data that can be transmitted to and from the vehicle, power limitations of the communication systems, and bandwidth constraints of the available communication channels.

In some embodiments, the system supports four scales of AI models (Large, Medium, Small, and Mini), that each incorporates the same general set of eight driving functions (Sensing, Perception, Localization, Fusion, Prediction, Planning, Decision, and Control), but at varying levels of depth and computational complexity. The Large AI Model provides a full-fidelity suite of advanced algorithms, often including dense neural networks for perception, comprehensive sensor-fusion pipelines, and sophisticated decision logic to handle the broadest range of driving scenarios. This scale typically operates either on vehicles with substantial on-board computing capabilities or in conjunction with robust edge or cloud resources, thereby allowing it to address long-tail and safety-critical situations with minimal compromise. The Medium AI Model retains all eight core functions but scales back certain resource-intensive elements, such as using fewer parameters for prediction or simplified decision-making heuristics when compared to the Large AI Model; it is designed to accommodate vehicles or trips that have moderate processing resources yet still require robust autonomy for typical road and traffic conditions. The Small AI Model remains faithful to the same core functions but is further tailored to fit into more constrained environments, effectively balancing the need for basic autonomous capabilities with limited computational and energy budgets. In practice, the Small AI Model may rely more heavily on external data or processing assistance when confronted with complex driving contexts. The Mini AI Model is the most lightweight variant, offering only the minimal essential logic for real-time perception, planning, and control, while delegating or omitting the bulk of higher-fidelity tasks, such as advanced sensor fusion or intricate predictive models, to remote computing platforms. Across all four scales, a vehicle-specific model allocation unit and a route-specific model allocation unit coordinate which sub-modules or configurations are deployed, and a distillation unit optionally reduces or adapts a larger-scale model into smaller-scale variants when the vehicle's onboard computing capacity or the route's complexity so demands.

The personalized AI models can be trip-specific, route-specific, road-specific, operational design domain (ODD)-specific, and/or vehicle-specific, wherein the ODD-specific AI model is customized based on season, weather, and/or light conditions. In some embodiments, the customized AI model applies a distillation method to refine trip parameters for optimized decision-making. Customization can be based on user or trip priority, including factors such as fee payment and urgency. In some embodiments, a small or mini AI driving model comprises one or more of a trip-specific model, a route-specific model, a road-specific model, an ODD-specific model, and/or a vehicle-specific model. In some embodiments, a medium AI driving model comprises one or more of a trip-specific model, a route-specific model, a road-specific model, an ODD-specific model, and/or a vehicle-specific model.

In some embodiments, the Model Allocation Module is configured to allocate models using one of the following methods.

1) The vehicle-centric method uses all eight driving functions or models, including sensing, perception, localization, fusion, prediction, planning, decision, and control, which run exclusively on-board the vehicle, with minimal reliance on external infrastructure.

2) The vehicle and out-of-vehicle data method hosts most driving models on-board the vehicle but supplements its real-time processing with out-of-vehicle data, including raw, fused, or processed data, which are received from the edge or cloud sources.

3) The vehicle and out-of-vehicle computing method utilizes external idle vehicles, and cloud and/or edge computing resources to distribute computation-intensive or specialized functions, such as large-scale sensor fusion or advanced prediction, offloaded to external systems, while the vehicle retains on-board driving functions to maintain safety if connectivity is limited.

4) The vehicle and out-of-vehicle computing and data method combines both out-of-vehicle computing and data, creating a highly collaborative environment in which the vehicle continuously exchanges real-time information and tasks with external servers (edge, cloud, or even idle vehicles), thereby optimizing performance and resource usage for various road conditions, traffic complexities, and trip priorities.

In some embodiments, the autonomous driving system utilizes a vehicle-centric model deployment allocation subsystem hosted solely on the vehicle platform. This subsystem comprises an Input Analysis Module that gathers operational parameters-such as real-time sensor data, trip requirements, and vehicle state; and a Hardware Capability Verification Module that compares the computational, memory, and energy capacities of the vehicle's processors to the demands of the AI models. A Cloud-Edge Coordination Module may optionally be present for fallback or supplementary data retrieval, but the primary focus is on ensuring that the vehicle alone manages the allocation and execution of AI models. Once the Input Analysis and Hardware Capability Verification Modules have determined the feasible set of models and configurations, the Allocation Execution Module proceeds to deploy the selected models on the vehicle, leveraging a Vehicle-specific Model Allocation Unit to tailor the chosen AI model to the vehicle's constraints and a Route-specific Model Allocation Unit to adapt it to the anticipated route conditions. A Distillation Unit may optionally reduce large models to smaller variants if the vehicle's resources are insufficient, thus ensuring that all key perception, planning, and control functions can be performed in real-time on-board the vehicle.

In some embodiments, the Model Allocation Module includes a vehicle-centric model training allocation subsystem, hosted primarily on the vehicle platform. Here, an Input Analysis Module gathers new driving data such as out-of-range inputs from sensors and identifies potential improvements or updates to the model. A Hardware Capability Verifier Module evaluates whether the vehicle can handle on-board training workloads, perhaps in shorter sessions during idle times or while parked. A Resource Calling Module may trigger additional sensor resources or submodules when training specific AI functions (e.g., updating a perception algorithm to handle new lighting conditions). A Cloud-Edge Coordination Module can coordinate the retrieval of relevant training inputs or parameter updates from external repositories, but the main training loop remains on-vehicle. The Scenario-Aware Model Allocation Module determines when and how to adapt the current model based on newly observed driving scenarios. Finally, the Allocation Execution Module performs or schedules the updated training tasks as “Vehicle-based Training,” providing the vehicle to refine its AI model incrementally without the off-vehicle infrastructure.

In some embodiments, the Model Allocation Module implements a comprehensive training and deployment method for autonomous driving systems that operate across three possible host combinations: vehicle-only, vehicle-cloud, or vehicle-edge-cloud. This method provides flexibility in system architecture based on available infrastructure, operational requirements, and performance objectives. The vehicle-only configuration maximizes autonomy, the vehicle-cloud combination balances onboard and offboard processing, and the vehicle-edge-cloud arrangement enables a fully distributed approach with hierarchical data processing and model deployment.

In some embodiments, the training and deployment method uses multiple update methods for AI driving models. The simultaneous real-time training and deployment method continuously refines and applies model parameters at intervals ranging from 1 millisecond to 1 second, providing immediate adaptation to changing conditions. The simultaneous dynamic training and deployment method updates both aspects at longer intervals from 1 second to multiple days, accommodating larger datasets and complex training processes. The separate training and deployment method combines dynamic training cycles with real-time deployment, allowing comprehensive model updates while maintaining responsive vehicle operation. The real-time training with dynamic deployment method updates model parameters continuously while implementing these changes on a more deliberate schedule to ensure stability and validation.

In some embodiments, the Model Allocation Module hosted in the vehicle allocates specialized models tailored to specific operational contexts. These include user-customized models that adapt to individual preferences and driving habits, route-specific models optimized for particular travel paths, road-specific models designed for particular road types and conditions, vehicle-specific models that account for the unique characteristics of the vehicle platform, ODD-specific models tailored to particular operational design domains, and trip-specific models that optimize performance for a particular journey based on its unique requirements and constraints.

In some embodiments, the Model Allocation Module implements a distillation method that supports hierarchical knowledge transfer across cloud, edge, and vehicle models. This process begins with knowledge extraction from the cloud, where the large AI model processes extensive sensor data to generate soft labels and inference backups. The edge model distillation phase refines this knowledge through feature-based distillation techniques and periodic updates. The vehicle model then receives this distilled knowledge in a compressed, quantized format optimized for real-time decision-making with limited computational resources. This hierarchy is maintained through periodic synchronization, where the vehicle syncs with edge systems for updates while the cloud serves as a comprehensive backup system when needed.

### Parameter Allocation Module

In some embodiments, the parameter allocation module implements the parameter allocation and update on one or more of the vehicle system, the road system, the edge system, the TCC/TCU, and the cloud system.

In some embodiments, the parameter comprises one or more of AI model parameters, vehicle parameters, and operational design domain (ODD) parameters.

In some embodiments, the AI model parameter is a set of learnable numerical values that define how the AI model processes data and generates outputs and provide the AI model to perform tasks comprising one or more of sensing, data fusion, prediction, planning and decision making, and control.

In some embodiments, the AI model parameter comprises one or more elements of: a) driving model element; b) vehicle-based model element; c) out-of-vehicle-based model element; and d) model combination element, wherein the elements refer to a logically or functionally distinct component, module, or part of a system, structure, or model that performs a specific role or contributes to a specific capability of the system.

In some embodiments, an element may refer to a component of an AI model that encapsulates certain functional tasks (e.g., sensing, planning, control), a module or building block of a parameter allocation subsystem, or a sub-portion of a parameter category (e.g., vehicle-based model element, roadway parameter element).

In some embodiments, the AI model parameter comprises but not limited to the types of: a) fundamental model parameters, such as model weights, bias terms, normalization parameters, and specialized module parameters; b) training and optimization parameters, such as meta-parameters, and hyperparameters; and c) deployment and adaptation parameters, such as quantization/compression parameters, and deployment-specific parameters.

In some embodiments, the vehicle parameter comprises but not limited to the types of:
a) vehicle status parameters, such as kinematic parameters including vehicle speed, acceleration; position and orientation parameter including latitude, longitude, and altitude coordinates, and heading; powertrain and engine parameter including engine temperature, fuel/battery charge level, torque; mechanical and diagnostic parameter including tire pressure, suspension status, diagnostic trouble codes; and
b) operation information parameters, such as control information parameters comprising vehicle control parameters including throttle, brakes, and horizontal/vertical alignment; information exchange parameters including lateral placement, longitudinal location, vehicle speed, and cross sections; guidance information parameters comprising vehicle maneuvers, safety maintenance, traffic highway interaction, and special information;
navigation information parameters comprising pre-trip information including destinations, food, gas, lodging, and emergency; route planning parameters including road/route number, cardinal direction, interchange/intersection, and designation; and operational mode parameters comprising driving mode, activation of specific systems.

In some embodiments, the operational design domain (ODD) parameter comprises but not limited to the types of: a) roadway parameters, such as lane marking, signing, pavement condition, road geometry, roadside infrastructure, traffic control elements including traffic signals, crosswalks and stop lines, speed bumps, and environmental and lightning conditions including roadway lightning and reflectivity; b) objects parameters, such as vehicles, pedestrians, cyclists, animals, dropped objects, construction and temporary objects, miscellaneous road obstructions, and other mobile objects; and c) driving environment parameters, such as weather, light and event including work zone, traffic incidents, crash, special events, road construction, near-miss, railway cross, hazard evacuation, etc.

In some embodiments, the parameter allocation module is configured to comprise one or more of a parameter collection submodule, a parameter allocation submodule and a parameter update submodule for a specific vehicle, and is hosted on one or more of the vehicle system, road system, edge system, TCC/TCU, and cloud system.

In some embodiments, the parameter collection submodule comprises one or more of: a) a parameter collection unit, configured to collect AI model parameters, vehicle parameters, and ODD parameters that need updating on one or more of the vehicle system, road system, edge system, TCC/TCU, and cloud system; and b) a parameter statistics unit, configured to process and back up the types and scales of parameters that need updating.

In some embodiments, the parameter allocation submodule is configured to comprise one or more of: a) a computing power resource unit, configured to calculate the available computing power of one or more of the vehicle system, road system, edge system, TCC/TCU, and cloud system for parameter updates; and b) a parameter allocation unit, configured to allocate the parameter update tasks to one or more of vehicle system, road system, edge system, TCC/TCU, and cloud system based on the availability of computing power and the types and scales of parameters that need updating.

In some embodiments, the parameter allocation submodule is configured to allocate one or more of the vehicle parameters, ODD parameters, and AI model parameters, by using the following allocation method:
a) the computing power resource unit calculates the available computing power of various host systems for parameter update;
b) the parameter allocation unit obtains the types and scales of parameters through the communication component;
c) the parameter allocation unit allocates the parameters to host system groups according to the types and scales of parameters; and
d) the parameter allocation unit allocates the parameters to host systems according to the available computing power of various host systems.

In some embodiments, the parameter update submodule is configured to comprise one or more of: a) a vehicle parameter update unit, configured to perform parameter updates for one or more of vehicle status parameters and operation information parameters; b) an ODD parameter update unit, configured to perform parameter updates for one or more of roadway parameters and objects parameters; c) an AI model parameter update unit, configured to perform parameter updates for one or more of fundamental model parameters, training and optimization parameters, and deployment and adaptation parameters; and d) a parameter update progress unit, configured to record the progress of parameter updates.

In some embodiments, the parameter update submodule is configured to update one or more of the vehicle parameters, ODD parameters, and AI model parameters, by using the following update method:
a) the vehicle parameter update unit, the ODD parameter update unit, and/or the AI model parameter update unit collect parameter update demand;
b) the parameter update progress unit records the parameter update status and implements parameter update after the vehicle stops if the vehicle is not in a safe operation status;
c) the vehicle parameter update unit, the ODD parameter update unit, and/or the AI model parameter update unit implement the parameter update according to the computing power availability of host systems;
d) the parameter update progress unit records the parameter update status; and
e) the parameter update submodule implements the update method again for the next interval if there is an update demand.

In some embodiments, the parameter update submodule is configured to implement a sequential update strategy, wherein, based on the update demands of each parameter category and the available computing power, the vehicle parameters are updated first, followed by the ODD parameters, and finally the AI model parameters.

In some embodiments, the parameter update submodule is configured to update one or more of the vehicle parameter, ODD parameter, and AI model parameter by using a real-time update method and/or a dynamic update method, wherein: a) the real-time update method for the parameters uses update intervals ranging from 0.1 millisecond to 1 second; b) the dynamic update method for the parameters uses update intervals from 1 second to days.

In some embodiments, the parameter update submodule is configured to update parameter only if there exists an update demand and the vehicle is in a safe operation status. Otherwise, the parameter update submodule will operate the parameter update process after the vehicle stops.

In some embodiments, the parameter allocation module is configured to be hosted in the vehicle, comprises one or more of a parameter collection unit, a parameter allocation unit, and a parameter update unit for a specific vehicle.

In some embodiments, the parameter allocation module is configured to apply customized and/or personalized parameter allocation module for one or more of vehicle-specific, trip-specific, route-specific, road-specific, and operational design domain (ODD)-specific scenarios for the vehicle's operation based on the vehicle's operational constraints, user-defined priorities, and trip-specific requirements.

### Coordination and Optimization Module

In some embodiments, the Operating and Management Subsystem comprises one or more of a Coordination and Optimization Module and/or an Execution Module. The Coordination and Optimization Module is configured to include a Coordination Submodule, which organizes, manages, and sequences the execution of tasks based on the resources allocated to AI models, computing power, and data. The Coordination and Optimization Module also includes an Optimization Submodule, which ensures that these allocated resources are used as efficiently as possible, and that tasks are executed with maximum performance.

In some embodiments, the tasks managed by the system comprise one or more of the following: sensing, perception, localization, fusion, prediction, planning, decision-making, and/or control. In this context, the maximum performance refers to the optimal execution of system tasks through the intelligent allocation and utilization of available resources, including AI models, computing power, and data.

In some embodiments, the optimization of the Coordination and Optimization Module is measured and achieved through a combination of the following factors: low latency, high throughput, task accuracy and reliability, system responsiveness and adaptability, and fault tolerance and resilience.

In some embodiments, the Coordination Submodule comprises a Task Management Unit, a Resource Matching Unit, a Priority Handling Unit, a Load Balancing Unit, and a Cluster Management Unit. In some embodiments, the Optimization Submodule comprises a Resource Scaling Unit, an Energy Optimization Unit, a Cost Optimization Unit, and a Performance Tuning Unit.

In some embodiments, the Coordination and Optimization Module is configured for integration into vehicles to manage AI models, computing power, and data in order to enhance overall system performance. The Coordination Submodule is configured to dynamically adjust the vehicle AI model execution priorities based on real-time data from the vehicle's operational state, including acceleration, braking, and navigation demands. In some embodiments, the Optimization Submodule is configured to dynamically reallocate computing power between safety-critical AI tasks such as collision avoidance, and non-essential tasks, thereby maximizing overall system efficiency.

### Examples

### Distributed AI System

In some embodiments, autonomous vehicles may feature robust cellular connectivity to support real-time data exchange with infrastructure, other vehicles, and cloud services. For example, a Snapdragon Auto 5G Modem-RF system may provide high-speed 5G and 5.5G communication across sub-6 GHZ and mmWave bands, with a fallback to 4G LTE in areas with limited coverage. A Quectel AG558x module may further enhance connectivity with dual SIM support, GNSS for positioning, and satellite IoT capabilities for edge data relay.

In some embodiments, for short-range communication, vehicles may include Bluetooth 5.3 modules (e.g., Nordic Semiconductor nRF5340) to connect with smartphones, wearables, and diagnostic tools. Wi-Fi 6E (802.11ax), via modules such as the Murata Type 2AE, may support fast data transfer for over-the-air updates, map syncing, and local diagnostics when the vehicle is within range of trusted infrastructure. In remote areas, satellite communication may be provided through systems like the Iridium 9770 modem or Starlink RV, allowing low-bandwidth global connectivity when terrestrial communication networks are unavailable. In some embodiments, some platforms may integrate early-stage 6G systems, such as Huawei's testbeds, to explore terahertz-band communication and AI-driven spectrum optimization for next-generation autonomous mobility.

In some embodiments, the Power Supply Component of the AI system may include a Vicor BCM4414 DC-DC converter module, used to power high-performance computing and sensor subsystems. The backup power may be ensured through an Eaton 48V lithium-ion battery pack with an integrated battery management system (BMS) and fast discharge response to support fail-operational behavior. The auxiliary circuits may draw regulated 12V and 5V power via Texas Instruments LM5146 synchronous buck converters, supporting noise-sensitive sensor and communication modules.

In some embodiments, the vehicle Sensing Component may include a Velodyne Alpha Prime LiDAR system for high-resolution 3D environmental mapping and object detection. The long-range perception is augmented by a Continental ARS540 radar unit. The visual data can be captured using a Sony IMX490 automotive HDR CMOS sensor, integrated into front-facing cameras mounted on the windshield. The precise localization is achieved via an OxTS RT3000 v3 inertial navigation system, which fuses dual-antenna GNSS and high-grade IMU data to maintain sub-decimeter positioning.

### Computing Power Allocation Module

In some embodiments, a Computing Power Allocation Module is employed within an autonomous driving system to coordinate and optimize the distribution of computing resources across multiple platforms, including vehicle-based computing platforms, RSU-based computing platforms, edge computing nodes, cloud-based data centers, and/or TCC-based platforms, by matching demand with available capacity to address both predictable operational requirements and unanticipated real-time demands. In some embodiments, a vehicle might include an NVIDIA® GeForce® RTX™ 4090 GPU (24 GB GDDR6X memory, base clock of 2.23 GHz), a 12th Generation Intel® Core™ 19-12900K CPU (16 cores, 24 threads, max turbo frequency of 5.2 GHz), and 64 GB of DDR5 RAM for onboard processing. In some embodiments, the RSU platform might comprise an AMD® EPYC™ 7313P CPU (16 cores, 32 threads, base frequency of 3.0 GHz) with 32 GB DDR4 RAM, while in some embodiments, the cloud platform could integrate multiple NVIDIA® H100 GPUs (80 GB HBM3 memory each, interconnected with NVLink) running on dual AMD® EPYC™ 7V13 CPU servers (each CPU with 64 cores and 256 GB to 512 GB of system memory).

In some embodiments, to illustrate a highly connected Vehicle-Road-Cloud system, a vehicle with an AMD Ryzen 9 5950X CPU (16 cores, 32 threads) and an NVIDIA GeForce RTX 3080 Ti GPU (12 GB GDDR6X) continuously communicates with an edge data center located near an interchange, where the edge data center's AMD EPYC servers and mid-range NVIDIA GPUs host local map-building tasks and a remote cloud cluster with NVIDIA H100 GPUs handles advanced model re-training and large-batch analytics.

In some embodiments, a vehicle may be equipped with Tesla Hardware 3 (HW3), a custom-designed system-on-chip (SoC) tailored for autonomous driving applications, which integrates a high-performance CPU with a dedicated neural network accelerator optimized for deep learning inference. In some embodiments, Tesla HW3 is designed to deliver efficient real-time sensor fusion and decision-making, contributing to the overall resource allocation strategy by providing specialized processing power for autonomous functions.

In some embodiments, Tesla HW3 may be deployed as part of the onboard computing platform, where its optimized architecture for processing neural network workloads supports critical autonomous driving tasks. In some embodiments, the hardware's capabilities such as rapid processing speeds and low power consumption complement the baseline computing profiles, ensuring that even vehicles with Tesla HW3 can participate in the distributed computing framework of the Vehicle-Road-Cloud system.

In some embodiments, a vehicle may be equipped with Tesla Dojo, a high-performance AI training supercomputer designed for large-scale deep learning applications, including autonomous driving. In some embodiments, Tesla Dojo's D1 chip, featuring a 7 nm process, 362 teraflops of compute per chip, and a high-bandwidth interconnect fabric, provides efficient training of neural networks. In some embodiments, a Dojo Training Tile, comprising 25 D1 chips with a total of 9 petaflops of compute and 36 TB/s of fabric bandwidth, may be deployed within Tesla's cloud infrastructure to accelerate model updates and support distributed computing in the Vehicle-Road-Cloud system.

In some embodiments, a Waymo autonomous driving system may utilize an onboard computation unit incorporating custom-designed AI accelerators optimized for real-time perception and decision-making. In some embodiments, the system may integrate an NVIDIA DRIVE Orin SoC, featuring 254 TOPS of AI computing, an 8-core ARM Cortex-A78AE CPU, and 12-core NVIDIA Ampere GPU, providing advanced sensor fusion and path planning. In some embodiments, Waymo's cloud computing infrastructure may employ Google Cloud TPU v4 pods, each containing up to 4,096 Tensor Processing Units (TPUs) with an aggregated computing power of over 100 exaflops, facilitating large-scale model training and real-time fleet optimization.

### Data Allocation Module

In some embodiments, the workflow of data allocation for vehicle data follows a structured process to ensure efficiency and accuracy. The Vehicle status data, such as speed, acceleration, and fuel/battery level, is first collected by the Data Collection Unit. This raw data are then processed by the Big Data Preprocessing Unit to remove noise, correct inconsistencies, and enhance overall data accuracy. Once preprocessed, the Data Measurement Unit evaluates key properties, including data frequency, relevance, and update rate, and transmits these measurements to the Data Allocation Module. Based on the measurements received, the Data Allocation Module formulates an optimized allocation strategy and scheduling plan. The Data Allocation Unit subsequently executes this strategy, distributing the processed vehicle status data to one or more of the Vehicle, RSU, Edge, Cloud, and TCC. This ensures that real-time data are efficiently shared for immediate processing, while also being stored for long-term analysis and decision-making. For example, Tesla's fleet of connected vehicles continuously collects real-time vehicle status data, such as battery charge levels and driving efficiency metrics. This data are transmitted to the cloud for large-scale analysis, while local processing occurs at the Edge to support immediate decision-making, such as adaptive cruise control and autonomous driving adjustments. The RSU may also relay relevant data to surrounding vehicles, providing enhanced safety features like collision avoidance and cooperative adaptive cruise control. Through this multi-layered data allocation approach, the system ensures that vehicle data are efficiently utilized at various levels, improving responsiveness, safety, and overall performance.

In some embodiments, the workflow of data allocation for external hazard data follows a structured process to ensure efficiency and accuracy. In some embodiments, the External hazard data, such as accident reports, sudden congestion, and pedestrian activity, is first collected by the Data Collection Unit. This raw data are then processed by the Big Data Preprocessing Unit to remove noise, correct inconsistencies, and enhance overall accuracy. After the raw data are preprocessed, the Data Measurement Unit evaluates key properties, including data frequency, relevance, and update rate, and transmits these measurements to the Data Allocation Module. In some embodiments, based on the measurements received, the Data Allocation Module formulates an optimized allocation strategy and scheduling plan. The Data Allocation Unit subsequently executes this strategy, distributing the processed external hazard data to one or more of the Vehicle, RSU, Edge, Cloud, and TCC, with priority given to the specific region where the hazard occurs. This targeted allocation enhances safety by ensuring timely responses and real-time hazard awareness for vehicles and infrastructure components. For example, Waymo's autonomous vehicle fleet continuously collects external hazard data through onboard sensors and shared infrastructure data. If a sudden road closure due to an accident is detected, the hazard information is rapidly processed and transmitted to the surrounding Waymo vehicles, allowing them to reroute in real time. Additionally, the RSUs relay the hazard information to other vehicles in the vicinity, while the cloud infrastructure stores and analyzes long-term trends for future route optimization. By leveraging an adaptive data allocation approach, Waymo enhances its fleet's safety, efficiency, and decision-making capabilities in dynamic driving environments.

### Model Allocation Module

In some embodiments, an autonomous driving system employs an AI-based allocation module to coordinate driving models between vehicle-based (“V”) and off-vehicle (“OV”) submodules. This provides eight key driving functions: sensing, perception, localization, fusion, prediction, planning, decision-making, and control.

In some embodiments, a vehicle may be equipped with Tesla FSD, an automated driving assistance system. Its architecture mainly consists of three modules: perception, control, and execution. The perception layer uses the HydraNets architecture to integrate multiple visual tasks into a single network, providing parallel processing. It also incorporates the BEV (Bird's Eye View)+Transformer architecture. By fusing data from multiple cameras, it converts 2D image information into 3D environmental perception, enhancing understanding of the surroundings. The Occupancy Network further improves the ability to recognize object motion in complex scenarios. In the control layer, a hybrid planning framework is constructed by combining traditional planning methods with neural network algorithms. The Interactive Search Framework is introduced. Neural networks are used to learn scene features and obtain value functions, and MCTS (Monte Carlo Tree Search) is then used to guide pathfinding, optimizing decision-making efficiency and real-time performance.

In some embodiments, a vehicle is equipped with Waymo Driver OpenEMMA, an open-source end-to-end automated system powered by Multi-Modal Large Language Models (MLLMs). OpenEMMA processes forward-facing camera images and text-based historical vehicle states as inputs. The driving task is treated as a Visual Question Answering (VQA) problem, leveraging Gemini's extensive world knowledge. By employing Chain-of-Thought reasoning, the model generates detailed descriptions of key objects, behavioral insights, and meta-driving decisions. OpenEMMA also incorporates a fine-tuned YOLO model optimized for 3D bounding box prediction, significantly enhancing detection accuracy.

In some embodiments, the perception models may be YOLOv8, PointNet, and/or DeepLabv3+. These perception models are employed to process the data collected by the sensors. Various types of data, including image data, radar data, and GPS data, are integrated by models such as CNN and GNN. The processed sensor data and the fused data are then fed into models like RNN, LSTM, and GAN to analyze and predict traffic conditions. For decision-making, a DQN (Deep Q-Network) is utilized.

In some embodiments, an end-to-end model may be Tesla's Full Self-Driving (FSD) V12.3 system, an end-to-end model composed of multiple hierarchical neural layers. This system primarily relies on visual data captured by the vehicle's surrounding cameras to provide comprehensive environmental perception. It also integrates inputs from ultrasonic sensors for short-range object detection and data from the Inertial Measurement Unit (IMU) to track the vehicle's dynamic state. The perception module utilizes the HydraNet object detection network, which combines RegNet and a Feature Pyramid Network (FPN), to analyze input data such as images and identify surrounding objects. Based on the detection results, an Occupancy Network is employed to reconstruct a three-dimensional model of the surrounding environment. Based on this perception, the model applies mechanisms such as Chain-of-Thought reasoning to directly output control commands, providing actions including steering, acceleration, deceleration, lane changing, and parking.

In some embodiments, autonomous driving is categorized into five levels of automation (S1-S5) based on SAE definition, each with its own system objectives. The AI Model Allocation Module allocates and coordinates driving models among vehicle-based submodule (Vehicle system) and out-of-vehicle-based submodule (e.g., RSU system, Edge system, or Cloud platform). Eight driving functions are activated to complete the deployment process: sensing, perception, localization, fusion, prediction, planning, decision-making, and control. Table 1 presents an example of vehicle-based driving functions and out-of-vehicle-based driving functions for each level of automation (S1-S5). In Table 1, the number “1” represents that a driving function is implemented in the system, and the number “0” represents that a driving function is not implemented in the system. For example, for system objective S1, all eight driving functions are implemented in the vehicle system only. For system objective S2, all eight driving functions are implemented in the vehicle system and four driving functions (sensing, perception, localization, fusion) are implemented in the Cloud platform. For system objectives S3-S5, all eight driving functions are implemented in the vehicle system and the Cloud platform. For system objective S4, the sensing function is implemented in the RSU system to provide BEV (Bird's Eye View) capabilities. For system objective S5, four driving functions (sensing, perception, localization, fusion) are implemented in the RSU system as additional capabilities.

TABLE 1
Example of Vehicle-Based and Out-of-Vehicle-Based Driving Functions

| | | S1 | | | S2 | | | S3 | |
|---|---|---|---|---|---|---|---|---|---|
| | | System Objective | | | System Objective | | | System Objective | |
| | | Vehicle | RSU | Cloud | Vehicle | RSU | Cloud | Vehicle | RSU |
| | | system | system | platform | system | system | platform | system | system |
| Driving | Perception | 1 | 0 | 0 | 1 | 0 | 1 | 1 | 0 |
| Function | Sensing | 1 | 0 | 0 | 1 | 0 | 1 | 1 | 0 |
| | Localization | 1 | 0 | 0 | 1 | 0 | 1 | 1 | 0 |
| | Fusion | 1 | 0 | 0 | 1 | 0 | 1 | 1 | 0 |
| | Prediction | 1 | 0 | 0 | 1 | 0 | 0 | 1 | 0 |
| | Decision | 1 | 0 | 0 | 1 | 0 | 0 | 1 | 0 |
| | Planning | 1 | 0 | 0 | 1 | 0 | 0 | 1 | 0 |
| | Control | 1 | 0 | 0 | 1 | 0 | 0 | 1 | 0 |

| | | S3 | S4 | | | S5 | | |
|---|---|---|---|---|---|---|---|---|
| | | System Objective | System Objective | | | System Objective | | |
| | | Cloud | Vehicle | RSU | Cloud | Vehicle | RSU | Cloud |
| | | platform | system | system | platform | system | system | platform |
| Driving | Perception | 1 | 1 | 0 | 1 | 1 | 1 | 1 |
| Function | Sensing | 1 | 1 | 1 | 1 | 1 | 1 | 1 |
| | Localization | 1 | 1 | 0 | 1 | 1 | 1 | 1 |
| | Fusion | 1 | 1 | 0 | 1 | 1 | 1 | 1 |
| | Prediction | 1 | 1 | 0 | 1 | 1 | 0 | 1 |
| | Decision | 1 | 1 | 0 | 1 | 1 | 0 | 1 |
| | Planning | 1 | 1 | 0 | 1 | 1 | 0 | 1 |
| | Control | 1 | 1 | 0 | 1 | 1 | 0 | 1 |

### Parameter Allocation Module

An exemplary autonomous driving system utilizes an AI model with an extensive parameter set distributed across various host systems. This AI model is designed to perform a comprehensive suite of functions that are critical to vehicle autonomous driving, including sensing, perception, localization, fusion, prediction, planning, decision-making, and control. Below is a detailed breakdown of the model's functionalities, the specific parameter types involved, their estimated quantities, and the allocation strategy for parameter updates across different host systems.
AI Model Functionality:
   Perception and Sensor Fusion:
      a) Example: A convolutional neural network (CNN) in the perception module extracts features from raw sensor inputs and generates high-resolution object detection maps. These maps are then fused with LiDAR point clouds to create a precise 3D representation of the vehicle's surroundings.
      b) Function: Processes multi-modal sensor data (from cameras, LiDAR, radar, and ultrasonic sensors) to detect and classify objects, lane markings, road signs, and other environmental features.
   Prediction:
      a) Example: Recurrent neural networks (RNNs) or transformer-based models predict the motion patterns of surrounding objects over a short time horizon, providing the system to anticipate potential hazards.
      b) Function: Forecasts the future trajectories of dynamic objects (e.g., vehicles, pedestrians, cyclists) based on their current motion and contextual information.
   Planning and Decision Making:
      a) Example: The planning module employs reinforcement learning and optimization techniques to determine the optimal route and maneuver strategies, considering road geometry, traffic conditions, and safety constraints.
      b) Function: Integrates the outputs of the perception and prediction modules to generate a safe and efficient driving path.
   Control:
      a) Example: A model predictive control (MPC) algorithm computes the required control signals to track the planned path while ensuring smooth and responsive vehicle operation.
      b) Function: Converts high-level driving decisions into low-level commands (e.g., acceleration, braking, steering) that are executed by the vehicle's actuators.
Parameters:
The AI model comprises approximately 1,000,000,000 (1 billion) or more learnable parameters, subdivided into three main categories:
   Fundamental Model Parameters:
      a) Definition: Basic building blocks that directly transform sensor inputs into internal representations.
      b) Example Breakdown:
      Convolutional Weights: ~ 500 million parameters used for feature extraction in the perception module.
      Bias Terms and Normalization Parameters: ~ 200 million parameters distributed across network layers to ensure stable activations.
      Specialized Module Parameters: ~ 100 million parameters in components such as attention mechanisms and sensor fusion layers that refine object recognition.
   Training and Optimization Parameters:
      a) Definition: Parameters that regulate the learning process and fine-tune the model over time.
      b) Example Breakdown:
      Meta-Parameters: Settings such as momentum (e.g., 0.9) and weight decay (e.g., 0.0001).
      Hyperparameters: Training configurations such as learning rate (e.g., 0.001), batch size (e.g., 128), and the number of training epochs (e.g., 100), totaling roughly 50,000 parameters.
   Deployment and Adaptation Parameters:
      a) Definition: Parameters optimized for efficient operation in various hardware and environmental conditions.
      b) Example Breakdown:
      Quantization/Compression Settings: Adjusting data representations (e.g., 32-bit to 8-bit) to meet hardware constraints.
      Deployment-Specific Adjustments: Platform-specific parameters for the vehicle system, edge devices, and cloud servers, approximately 150 million parameters.
Parameter Allocation:
To update the vast parameter set effectively, the parameter allocation subsystem dynamically distributes update tasks across multiple host systems based on available computing power and update frequency requirements:
   Vehicle System:
      a) Function: Handles real-time updates of vehicle-specific parameters (e.g., kinematic data, control signals, diagnostic information).
      b) Update Interval: Typically 0.1 milliseconds to 1 second.
      c) Parameter Types: Vehicle parameters including real-time sensor inputs, control commands, and instantaneous vehicle state data.
   Road System:
      a) Function: Integrates fixed roadside sensors and infrastructure data, providing continuous updates on roadway conditions (e.g., traffic signal timings, road geometry, pavement condition).
      b) Update Interval: Generally 1 second to several minutes.
      c) Parameter Types: Roadway parameters derived from infrastructure sensors, such as lane markings, signage, and pavement conditions.
   Edge System:
      a) Function: Offers local processing near the vehicle to update dynamic driving environment parameters, including localized weather, lighting, and traffic events.
      b) Update Interval: Typically 1 second to 5 minutes.
      c) Parameter Types: Localized operational design domain (ODD) parameters capturing rapidly changing environmental conditions.
   TCC/TCU:
      a) Function: Acts as an intermediary hub to coordinate data from the vehicle, road, and edge systems, providing aggregated and regional traffic control information.
      b) Update Interval: Generally 5 minutes to tens of minutes.
      c) Parameter Types: Aggregated ODD parameters including incident reports, traffic signal synchronization data, and road event updates.
   Cloud System:
      a) Function: Manages computationally intensive updates for AI model parameters, particularly training and optimization parameters, using high-performance computing resources.
      b) Update Interval: Batch updates ranging from several minutes to hours.
      c) Parameter Types: AI model parameters (especially training & optimization and deployment/adaptation parameters) updated through batch processing and global data aggregation.

Exemplary Operational Design Domain (ODD) parameters that find use in the Parameter Allocation Subsystem include, but are not limited to, the following:
combinatorial variations in weather conditions (e.g., rain, snow, fog, clear skies) and lighting conditions (e.g., daylight, twilight, nighttime);
roadway infrastructure data, including over 360,000 signalized intersections and more than 200,000 railway crossings in the United States;
traffic safety events such as approximately 12 million collisions and over 1 billion near-miss incidents per year in the United States;
additional factors from work zones, construction areas, and other road anomalies accessible via public data sources.

The ODD provides billions of distinct parameters to the AI model, underscoring the critical role that precise parameter allocation and timely updates play in ensuring the robust performance of autonomous driving systems.

An exemplary parameter allocation module is implemented in an autonomous driving system for a specific vehicle, such as a Level 4 autonomous passenger car operating within an urban operational design domain (ODD). The system integrates a prediction model to forecast ego and surrounding vehicle trajectories, pedestrian movements, and traffic states. The parameter allocation module is hosted across multiple systems, including the vehicle system, an edge system at a roadside unit, a Traffic Control Center/Traffic Control Unit (TCC/TCU), and a cloud system, to manage the allocation and updating of parameters for the prediction model.

The prediction model in this example is a deep neural network (DNN) with approximately 50 million parameters, comprising AI model parameters, vehicle parameters, and ODD parameters. These parameters are categorized as follows:
AI Model Parameters:
The DNN includes 48 million learnable numerical values that define its ability to process sensor data and predict outcomes such as vehicle trajectories and pedestrian behavior. These parameters include:
   Driving Model Element: 20 million parameters governing driving behavior prediction (e.g., acceleration, lane changes);
   Vehicle-Based Model Element: 10 million parameters for interpreting vehicle sensor inputs (e.g., LiDAR, radar);
   Out-of-Vehicle-Based Model Element: 15 million parameters for modeling external entities (e.g., nearby vehicles, pedestrians);
   Fundamental Model Parameters: 30 million weights and biases forming the DNN's core structure;
   Training and Optimization Parameters: 10 million parameters, including learning rates and optimization gradients; and
   Deployment and Adaptation Parameters: 8 million parameters for real-time adaptation to new driving scenarios.
Vehicle Parameters:
Approximately 1 million parameters, including:
   Vehicle Status Parameters: 500,000 parameters tracking speed, tire pressure, and battery level.
   Operation Information Parameters: 500,000 parameters logging current route, trip duration, and driver preferences.
ODD Parameters:
Approximately 1 million parameters defining the operational environment, including:
   Roadway Parameters: 400,000 parameters for road geometry and lane markings;
   Objects Parameters: 300,000 parameters identifying traffic lights and pedestrian;
   Driving Environment Parameters: 300,000 parameters for weather conditions and time of day.

The exemplary parameter allocation module implements the parameter allocation and update by the following steps:
Parameter Collection
The parameter collection submodule operates on the vehicle system and the TCC/TCU. The parameter collection unit gathers real-time data from the vehicle's sensors and the TCC/TCU's traffic updates. The parameter statistics unit processes this data, determining that 5 million AI model parameters, 200,000 vehicle parameters, and 150,000 ODD parameters require updates based on a new urban intersection scenario. These parameters are backed up in the cloud system for redundancy.
Parameter Allocation:
The parameter allocation submodule allocates these updates across the host systems based on computing power availability and parameter types/scales. The allocation process uses the following method:
   Computing Power Resource Unit: calculates available computing power as 10 TFLOPS (teraflops) on the vehicle system, 50 TFLOPS on the edge system, 100 TFLOPS on the TCC/TCU, and 1,000 TFLOPS on the cloud system;
   Parameter Allocation Unit: obtains parameter types and scales via a communication component (e.g., 5G network);
   Allocation to Host System Groups: assigns 200,000 vehicle parameters and 150,000 ODD parameters to the vehicle system (low latency required), and 5 million AI model parameters to the cloud system (high computational demand);
   Allocation by Computing Power: distributes tasks proportionally—the vehicle system handles 2% of updates, the edge system handles 10% of updates, the TCC/TCU handles 20% of updates, and the cloud system handles 68% of updates.

This allocation is customized for a trip-specific scenario, such as navigating a congested urban route, based on operational constraints (e.g., vehicle's limited onboard GPU) and user-defined priorities (e.g., payment made).
Parameter Update
The parameter update submodule executes updates as follows:
   Vehicle Parameter Update Unit: updates 200,000 vehicle status parameters (e.g., speed adjustment) in real-time (0.5-second interval);
   ODD Parameter Update Unit: updates 150,000 roadway parameters (e.g., new lane closure) dynamically (5-second interval);
   AI Model Parameter Update Unit: updates 5 million training parameters in the cloud system after the vehicle stops, leveraging 1,000 TFLOPS for retraining; and
   Parameter Update Progress Unit: logs completion status (e.g., 80% of AI model parameters updated).

The above update method is applied in the following sequence: the units collect update demands (e.g., new pedestrian data), delay updates until the vehicle is parked if unsafe, and implement updates based on available computing power. The process repeats at the next interval (e.g., every 10 minutes) if new demands arise.

After allocation and updates, the prediction model accurately forecasts pedestrian movements at a busy intersection, reducing collision risk by 15% compared to pre-update performance. This demonstrates the parameter allocation module's ability to handle large-scale, multi-type parameters across distributed systems for vehicle-specific and ODD-specific scenarios, tailored to operational constraints and trip requirements.

Although the disclosure herein refers to certain illustrated embodiments, it is to be understood that these embodiments are presented by way of example and not by way of limitation.

### DEFINITIONS

To facilitate an understanding of the present technology, a number of terms and phrases are defined below. Additional definitions are set forth throughout the detailed description.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a”, “an”, and “the” include plural references. The meaning of “in” includes “in” and “on.”

As used herein, the terms “about”, “approximately”, “substantially”, and “significantly” are understood by persons of ordinary skill in the art and will vary to some extent on the context in which they are used. If there are uses of these terms that are not clear to persons of ordinary skill in the art given the context in which they are used, “about” and “approximately” mean plus or minus less than or equal to 10% of the particular term and “substantially” and “significantly” mean plus or minus greater than 10% of the particular term.

As used herein, disclosure of ranges includes disclosure of all values and further divided ranges within the entire range, including endpoints and sub-ranges given for the ranges.

As used herein, the suffix “-free” refers to an embodiment of the technology that omits the feature of the base root of the word to which “-free” is appended. That is, the term “X-free” as used herein means “without X”, where X is a feature of the technology omitted in the “X-free” technology. For example, a “calcium-free” composition does not comprise calcium, a “mixing-free” method does not comprise a mixing step, etc.

Although the terms “first”, “second”, “third”, etc. may be used herein to describe various steps, elements, compositions, components, regions, layers, and/or sections, these steps, elements, compositions, components, regions, layers, and/or sections should not be limited by these terms, unless otherwise indicated. These terms are used to distinguish one step, element, composition, component, region, layer, and/or section from another step, element, composition, component, region, layer, and/or section. Terms such as “first”, “second”, and other numerical terms when used herein do not imply a sequence or order unless clearly indicated by the context. Thus, a first step, element, composition, component, region, layer, or section discussed herein could be termed a second step, element, composition, component, region, layer, or section without departing from technology.

As used herein, the word “presence” or “absence” (or, alternatively, “present” or “absent”) is used in a relative sense to describe the amount or level of a particular entity (e.g., component, action, element). For example, when an entity is said to be “present”, it means the level or amount of this entity is above a pre-determined threshold; conversely, when an entity is said to be “absent”, it means the level or amount of this entity is below a pre-determined threshold. The pre-determined threshold may be the threshold for detectability associated with the particular method used to detect the entity or any other threshold. When an entity is “detected” it is “present”; when an entity is “not detected” it is “absent”.

As used herein, an “increase” or a “decrease” refers to a detectable (e.g., measured) positive or negative change, respectively, in the value of a variable relative to a previously measured value of the variable, relative to a pre-established value, and/or relative to a value of a standard control. An increase is a positive change preferably at least 10%, more preferably 50%, still more preferably 2-fold, even more preferably at least 5-fold, and most preferably at least 10-fold relative to the previously measured value of the variable, the pre-established value, and/or the value of a standard control. Similarly, a decrease is a negative change preferably at least 10%, more preferably 50%, still more preferably at least 80%, and most preferably at least 90% of the previously measured value of the variable, the pre-established value, and/or the value of a standard control. Other terms indicating quantitative changes or differences, such as “more” or “less,” are used herein in the same fashion as described above.

As used herein, the term “number” shall mean one or an integer greater than one (e.g., a plurality).

As used herein, a “system” refers to a plurality of real and/or abstract components operating together for a common purpose. In some embodiments, a “system” is an integrated assemblage of hardware and/or software components. In some embodiments, each component of the system interacts with one or more other components and/or is related to one or more other components. In some embodiments, a system refers to a combination of components and software for controlling and directing methods. For example, a “system” or “subsystem” may comprise one or more of, or any combination of, the following: mechanical devices, hardware, components of hardware, circuits, circuitry, logic design, logical components, software, software modules, components of software or software modules, software procedures, software instructions, software routines, software objects, software functions, software classes, software programs, files containing software, etc., to perform a function of the system or subsystem. Thus, the methods and apparatus of the embodiments, or certain aspects or portions thereof, may take the form of program code (e.g., instructions) embodied in tangible media, such as floppy diskettes, CD-ROMs, hard drives, flash memory, or any other machine-readable storage medium wherein, when the program code is loaded into and executed by a machine, such as a computer, the machine becomes an apparatus for practicing the embodiments. In the case of program code execution on programmable computers, the computing device generally includes a processor, a storage medium readable by the processor (e.g., volatile and non-volatile memory and/or storage elements), at least one input device, and at least one output device. One or more programs may implement or utilize the processes described in connection with the embodiments, e.g., through the use of an application programming interface (API), reusable controls, or the like. Such programs are preferably implemented in a high-level procedural or object-oriented programming language to communicate with a computer system. However, the program(s) can be implemented in assembly or machine language, if desired. In any case, the language may be a compiled or interpreted language, and combined with hardware implementations.

As used herein, the term “Connected Automated Vehicle Highway System” (“CAVH System”) refers to an autonomous driving system (ADS) providing full vehicle operations and control for connected and automated vehicles (CAV), and, more particularly, to a system controlling CAVs by sending individual vehicles with detailed and time-sensitive control instructions for vehicle following, lane changing, route guidance, and related information. A CAVH system comprises sensing, communication, and control components connected through segments and nodes that manage an entire transportation system. CAVH systems comprise four control levels or components: vehicle; roadside unit (RSU), which, in some embodiments, is similar to or the same as a roadside intelligent unit (RIU); traffic control unit (TCU); and traffic control center (TCC). See U.S. Pat. Nos. 10,380,886; 10,867,512; and/or 10,692,365, each of which is incorporated herein by reference.

As used herein, the term “Intelligent Road Infrastructure System” (“IRIS”) refers to a system that facilitates vehicle operations and control for CAVH systems or ADS. See U.S. Pat. Nos. 10,867,512 and/or 10,692,365, each of which is incorporated herein by reference. In some embodiments, an IRIS further comprises a cloud component. In some embodiments, an IRIS provides transportation management and operations and individual vehicle control for connected and automated vehicles (CAV). For example, in some embodiments, an IRIS provides a system for controlling CAVs by sending individual vehicles with customized, detailed, and time-sensitive control instructions and traffic information for automated vehicle driving, such as vehicle following, lane changing, route guidance, and other related information.

As used herein, the term “Intelligence Allocation” refers to systems and methods that allocate, arrange, and distribute certain types of functions and intelligence, for CAVH systems or ADS, to facilitate vehicle operations and controls, to improve the general safety of the transportation system, and to ensure the efficiency, intelligence, reliability, and resilience of CAVH systems or ADS. In some embodiments, the present technology also provides methods to define CAVH system intelligence and its levels, which are based on two dimensions: the vehicle intelligence and infrastructure intelligence. See U.S. Pat. No. 11,495,126, which is incorporated herein by reference.

As used herein, the term “vehicle” refers to any type of powered transportation device, which includes, and is not limited to, an automobile, truck, bus, motorcycle, or boat. The vehicle may normally be controlled by an operator or may be unmanned and remotely or autonomously operated in another fashion, such as using controls other than the steering wheel, gear shift, brake pedal, and accelerator pedal.

As used herein, the term “automated vehicle” or “autonomous vehicle” (abbreviated as “AV”) refers to an automated vehicle in an automated mode, e.g., at any level of automation (e.g., as defined by SAE International Standard J3016, “Taxonomy and Definitions for Terms Related to Driving Automation Systems for On-Road Motor Vehicles” (published in 2014 (J3016_201401) and as revised in 2016 (J3016_201609) and 2018 (J3016_201806), each of which is incorporated herein by reference)).

As used herein, the term “allocate”, “allocating”, and similar terms referring to resource distribution also include distributing, arranging, providing, managing, assigning, controlling, and/or coordinating resources.

As used herein, the term “configured” refers to a component, module, system, subsystem, etc. (e.g., hardware and/or software) that is constructed and/or programmed to carry out the indicated function.

As used herein, the terms “determine,” “calculate,” “compute,” and variations thereof, are used interchangeably to any type of methodology, processes, mathematical operation, or technique.

As used herein, the term “artificial intelligence model” (or “AI model”) refers to a program that has been trained on a set of data to recognize certain patterns or make certain decisions without further human intervention. AI models apply different algorithms to relevant data inputs to achieve the tasks, or output, for which they have been programmed. The AI model is defined by its ability to autonomously make decisions or predictions, rather than simulate human intelligence. In some embodiments, the AI models comprise machine learning models and/or learning-based models.

As used herein, the term “cloud” or “Cloud Platform” or “Cloud System” within the context of a Connected Automated Vehicle Highway (CAVH) system or an autonomous driving system (ADS) refers to a structured, tiered architecture composed of edge, regional, and central clouds. Each level is designed to fulfill specific roles tailored to the operational demands of the CAVH system or the ADS. The edge cloud or edge system or edge computing node (abbreviated as “edge”) operates at the closest proximity to vehicular and roadside units, facilitating real-time data processing and immediate decision-making for individual vehicles and local infrastructure. The regional cloud provides intermediate-level data integration and analytics, focusing on broader area traffic management and coordination between multiple edge clouds to optimize regional traffic flows and infrastructure usage. Finally, the central cloud oversees overarching functions such as high-level traffic planning, large-scale data analytics, and overall system control, integrating inputs from the regional clouds to enhance the efficiency and safety of the entire transportation network. See U.S. Pat. Nos. 12,057,011 and 12,266,262; and/or U.S. patent application Ser. Nos. 17/779,372, 19/090,663, and 19/090,669, each of which is incorporated herein by reference.

As used herein, the term “roadside unit” (abbreviated “RSU”) within the context of a Connected Automated Vehicle Highway (CAVH) system or an autonomous driving system (ADS) may refer to one RSU, a plurality of RSU, and/or a network of RSU. In some embodiments, the RSU provides one or more of a communications function, a sensing function, and/or a computing function. In some embodiments, the RSU provides one or more functions for autonomous driving. See U.S. Pat. Nos. 10,867,512 and 11,881,101, each of which is incorporated herein by reference.

As used herein, the term “roadside intelligent unit” (abbreviated “RIU”) is similar to or the same as a roadside unit (RSU); and the term “roadside intelligent unit” may refer to one RIU, a plurality of RIU, and/or a network of RIU. See U.S. U.S. patent application Ser. Nos. 17/667,683 and 17/537,593, each of which is incorporated herein by reference.

As used herein, the term “mobile roadside intelligent unit” (abbreviated “MRIU” or “MRSU”) may refer to one MRIU, a plurality of MRIU, and/or a network of MRIU. See U.S. Pat. No. 12,043,288, which is incorporated herein by reference.

As used herein, the term “IRT” refers to a system configured to provide a virtual automated driving service to vehicles. In some embodiments, the term “IRT” may refer to one RSU. In some embodiments, the IRT system is configured to share information and/or driving instructions between vehicles and other automated driving information entities. See U.S. Pat. App. Ser. No. 63/004,551, which is incorporated herein by reference.

As used herein, the term “Operational Design Domain” (abbreviated “ODD”) refers to the operating conditions under which a given automated driving system and/or feature thereof is specifically designed to function, including, but not limited to, characteristics and/or restrictions related to environmental, geographical, and/or time-of-day factors, and/or related to the presence or absence of certain traffic or roadway characteristics. In some embodiments, the ODD is defined by SAE International Standard J3016, “Taxonomy and Definitions for Terms Related to Driving Automation Systems for On-Road Motor Vehicles” (J3016_201806), which is incorporated herein by reference.

As used herein, the term “real-time” refers to the capability of an AI system to process and respond to inputs, events, or changes in the environment within a short and predefined time window, typically ranging from 0.1 millisecond to one second, to support immediate decision-making and control actions.

As used herein, the term “dynamic” refers to the capability of an AI system to adapt or update its data, parameters, or models over a flexible and variable time range, typically from one second to multiple days, depending on the availability of resources and system constraints. In some embodiments, dynamic processes are categorized as periodic dynamic, event-driven dynamic, and/or batch dynamic.

As used herein, the term “distillation” refers to a model compression technique wherein a large, high-performance AI model transfers its knowledge to a smaller, more efficient model, thus allowing the smaller model to approximate the behavior and output of the larger one while operating under more constrained computing environments.

As used herein, the terms “large AI model,” “medium AI model,” “small AI model,” and “mini AI model” refer to AI driving models characterized by distinct complexity levels, computational requirements, parameter counts, inference capabilities, and scalability designed for deployment across varied computing platforms such as cloud, edge, roadside units (RSUs), traffic control centers (TCC), and vehicle-based systems.

As used herein, the term “large AI model” typically refers to an AI model with over a billion parameters; the term “medium AI model” typically refers to an AI model with one hundred million to a billion parameters; the term “small AI model” typically refers to an AI model with five million to one hundred million parameters; and the term “mini AI model” typically refers to an AI model with less than five million parameters.

As used herein, the term “resources” or “computing resources” refers to hardware and/or software components (e.g., CPUs, GPUs, QPUs, DPUs, TPUs, memory, specialized accelerators) capable of performing data processing, algorithms, or computational tasks that are essential for vehicle operations or autonomous driving functions.

As used herein, the term “computing power deficiency” refers to the shortfall or gap between the available computing resources and the computational requirements for a particular operational scenario, thereby signaling the need for resource supplementation or redistribution.

As used herein, the term “trip” refers to a defined journey or route that a vehicle undertakes, which includes start and end points, potential intermediate stops, and any relevant conditions or constraints influencing vehicle operation.

As used herein, the phrase “in-vehicle conditions” refers to the internal state or circumstances within a vehicle (e.g., sensor functionality, power usage, running applications) that can affect the availability or demand of computing resources.

As used herein, the term “internal changes” refers to modifications, fluctuations, or unexpected events originating within a vehicle (e.g., a sensor failure, a new software process starting, battery status changes) that can alter computing power supply or demand.

As used herein, the phrase “external environment conditions” refer to factors outside of the vehicle (e.g., weather, traffic levels, road infrastructure) that may affect how computing resources need to be allocated or how vehicle operations proceed.

As used herein, the term “external changes” refers to modifications or events occurring outside the vehicle (e.g., sudden traffic congestion, changing road conditions, environmental hazards) that prompt reevaluation of computing power requirements or availability.

As used herein, the phrase “event-specific conditions” refers to contextual factors arising from a particular planned or unplanned event (e.g., road closures, traffic diversions, scheduled gatherings) that may influence resource needs or distribution strategies.

As used herein, the term “ego vehicle” refers to the primary vehicle of interest, typically responsible for managing its own autonomy-related functions, sensors, and computational requirements, while also potentially sharing or receiving computing resources as needed.

As used herein, the phrase “idle vehicle” refers to a vehicle with unoccupied or underutilized computing resources that can be assigned or lent to another system or vehicle requiring additional computing power.

As used herein, the phrase “optimized distribution of computing resources” refers to any strategic allocation method designed to achieve the highest possible system performance, reliability, or efficiency by matching appropriate resources to each active task.

As used herein, the term “offboard application” refers to the distribution and processing of data across a broader connected system beyond a single vehicle, including but not limited to vehicles, roadside units (RSUs), edge servers, cloud platforms, and traffic control centers (TCCs), providing cooperative perception, coordination, and large-scale analytics.

As used herein, the term “onboard application” refers to data collection, processing, and allocation tasks that are vehicle-centric, emphasizing real-time responsiveness and prioritization of safety-critical functions necessary for vehicle operation.

As used herein, the term “Onboard Data Collection” refers to the process of collecting data from a node's own local sensors, such as cameras, radars, lidars, and other sensing devices directly connected to or embedded within the system.

As used herein, the term “Offboard Data Collection” refers to the process of collecting data from external sources, including other nodes, by receiving or retrieving information that was not directly sensed by the node's own hardware.

As used herein, the term “data urgency” refers to the priority level of data based on its criticality to real-time operation, where high-urgency data includes time-sensitive information like sensor anomalies, emergency braking events, and collision warnings.

As used herein, the term “update frequency” refers to the rate at which a specific type of data are refreshed or re-collected, determined based on operational relevance and application sensitivity to changes in the environment or vehicle condition.

As used herein, the term “network conditions” refers to the state and performance of the communication network connecting various system components, characterized by factors such as available bandwidth, latency, jitter, packet loss, and signal strength, which collectively influence the efficiency and reliability of data transmission.

As used herein, the term “processing capacity” refers to the computational ability of a system or platform to execute tasks, determined by factors such as available CPU/GPU/QPU resources, memory, current processing load, and the number and complexity of tasks being handled at a given time.

As used herein, the term “safety-critical data” refers to information that is essential for maintaining the safe operation of a system in real-time, including but not limited to collision warnings, sensor faults, emergency braking events, obstacle detections, and system failures. This type of data requires immediate processing to prevent hazardous situations.

As used herein, the term “time-sensitive data” refers to data that is processed or acted upon within a short time window to remain effective, such as perception results, localization updates, vehicle control commands, or short-term traffic predictions. While not always safety-critical, delays in handling this data can degrade performance or responsiveness.

As used herein, the term “non-urgent data” refers to information that may not require immediate processing and can be deferred without impacting real-time operations. Examples include long-term logs, performance metrics, historical driving records, or data used for periodic model retraining or system updates.

As used herein, the term “high-volume data” refers to data that is generated in large quantities, often due to high-resolution, high-frequency, or continuous streams from sources such as video cameras, LiDAR sensors, or real-time telemetry.

As used herein, the term “data quality” refers to the degree to which data are complete, valid, and reliable for use in analysis or processing, accounting for aspects such as missing values, duplication, noise, and formatting consistency.

As used herein, the term “AI driving model” refers to an artificial intelligence-based computational model designed specifically for autonomous driving tasks, including but not limited to sensing, perception, localization, fusion, prediction, planning, decision-making, and/or control functionalities.

As used herein, the term “sensing model” refers to an AI driving model that processes raw sensor inputs, including but not limited to camera, radar, LiDAR, ultrasonic, and similar sensing data, for real-time environmental assessment.

As used herein, the term “perception model” refers to an AI driving model designed to detect, classify, and interpret information about the vehicle's surrounding environment using sensors, cameras, LiDAR, radar, or similar devices.

As used herein, the term “localization model” refers to an AI driving model designed to determine the precise geographical location and orientation of the vehicle in real-time using positioning systems such as GPS, inertial measurement units (IMU), visual odometry, and/or map-based techniques.

As used herein, the term “fusion model” refers to an AI driving model configured to combine and integrate information from multiple sensors or data sources to enhance the accuracy, reliability, and completeness of the vehicle's environmental understanding and internal state representation.

As used herein, the term “prediction model” refers to an AI driving model designed to anticipate future scenarios, such as predicting trajectories and behaviors of surrounding entities, including vehicles, pedestrians, or cyclists, based on historical and current data.

As used herein, the term “planning model” refers to an AI driving model designed to compute precise, executable paths or trajectories, including lateral and longitudinal movements, based on outcomes generated from the decision-making model.

As used herein, the term “decision-making model” refers to an AI driving model configured to evaluate possible driving scenarios, generate actionable strategies, and select the optimal actions according to safety, efficiency, and user-defined constraints.

As used herein, the term “control model” refers to an AI driving model configured to convert planned actions or trajectories into executable control commands, managing actuators such as steering, throttle, braking systems, and other related vehicle control mechanisms.

As used herein, the term “Distillation Unit” refers to a software component configured to simplify, compress, or transfer knowledge from larger AI models into smaller or specialized AI models while preserving or optimizing essential model performance attributes relevant to autonomous driving tasks.

As used herein, the terms “Vehicle-Specific Model”, “Route-Specific Model”, “Road-Specific Model”, “Trip-Specific Model”, “ODD-Specific Model”, and similar terms refer to software components configured to comprise AI driving models according to specific characteristics or constraints associated with a vehicle, route, road segment, trip, or operational design domain (ODD), ensuring tailored and optimized autonomous driving functionality.

As used herein, the term “Safety Verification Unit” refers to a software component configured to systematically validate, assess, and ensure that AI driving models and associated operational procedures comply with defined safety standards and requirements for autonomous driving.

As used herein, the term “Hardware Verification Unit” refers to a software component configured to systematically validate and verify hardware resources, capabilities, and performance levels, ensuring compatibility with deployed AI driving models and computing resource allocation strategies.

As used herein, the term “Computing Unit” refers to a hardware component comprising processors (e.g., CPUs, GPUs, TPUs, DPUs, QPUs, FPGAs, dedicated accelerators) capable of executing computationally intensive AI model inference, decision-making, planning, control, and associated tasks for autonomous driving.

As used herein, the term “Sensing Unit” refers to a hardware component including, but not limited to, cameras, radars, LiDARs, ultrasonic sensors, inertial measurement units (IMU), GPS receivers, and other sensors that capture environmental and operational data for autonomous driving tasks.

As used herein, the term “Memory Unit” refers to a hardware component providing data storage and retrieval capacity for AI driving models, sensor data, maps, configurations, historical records, and computational results necessary for real-time or dynamic autonomous vehicle operation.

As used herein, the term “Communication Unit” refers to a hardware component configured to facilitate reliable data exchange between vehicle and external entities (e.g., edge, cloud, RSU) through advanced cellular networks (4G, 5G, 5.5G, 6G), Bluetooth, Wi-Fi, satellite communication, or other available communication methods.

As used herein, the term “Power Supply Unit” refers to a hardware component configured to provide electrical power and manage energy resources, ensuring stable operation of all vehicle-based computing and sensing equipment necessary for autonomous driving.

As used herein, the terms “Vehicle-based AI Driving Models” (“V”) and “Out-of-Vehicle-based AI Driving Models” (“OV”) refer to AI driving models specifically allocated for execution onboard a vehicle (e.g., the ego vehicle, idle vehicles) or outside the vehicle on external platforms (e.g., RSUs, edge, cloud, TCC), respectively.

As used herein, the term “Localized AI” or “AI System” refers to a subset of artificial intelligence systems that are specifically designed and deployed to operate within a localized environment, such as an autonomous vehicle (AV), roadside infrastructure, roadside units (RSUs), cloud, edge cloud, traffic control unit (TCU), and/or traffic control center (TCC). A/ocalized AI system or AI System is characterized by its capacity to process and utilize local knowledge, information, data, and models that are sourced from one or more of nearby vehicles, roadside units (RSUs), edge cloud, centralized cloud infrastructure, traffic control unit (TCU), and/or traffic control center (TCC). The localized AI system or AI System is configured with a computational component that provides comprehensive functionalities including sensing the local environment, predicting behaviors of surrounding entities, making autonomous decisions, and controlling the vehicle in response to dynamic local conditions. Additionally, the local AI system or AI System is capable of self-evolution and enhancement through heuristic learning and model training, which are informed by data inputs received from local traffic control centers or units (TCC/TCU) and integrated cloud resources. See U.S. Pat. No. 12,002,361; and/or U.S. patent application Ser. No. 18/672,739, each of which is incorporated herein by reference. As used herein, the phrase “Vehicle-centric,” “Vehicle-Cloud,” and “Vehicle-Edge-Cloud” refers to different computing and deployment paradigms defining how AI driving models are allocated, trained, and executed across vehicle and out-of-vehicle computing resources.

As used herein, the term “Allocation Function” (“F,” “f₁,” “f₂”) refers to mathematical, logical, or algorithmic functions or methods that select, determine, adapt, or coordinate the allocation and deployment of AI driving models between in-vehicle and out-of-vehicle computing resources to meet safety, computing power, and operational efficiency requirements.

As used herein, the term “Vehicle-specific model” refers to an AI driving model customized according to unique vehicle constraints, including hardware/software parameters specific to vehicle manufacturers, sensor configurations, and operational requirements, ensuring optimal integration and vehicle-specific autonomous driving performance.

As used herein, the terms “real-time” and “dynamic” refer to distinct update or operational intervals for processing, deployment, and model updates, wherein “real-time” denotes intervals typically ranging from 0.1 millisecond to 1 second to support immediate response needs, while “dynamic” denotes intervals from 1 second to multiple days to support periodic, incremental, or comprehensive updates.

As used herein, the term “Distillation Method” or “comprehensive distillation method” refers to a structured mechanism of hierarchical knowledge transfer, refinement, and model optimization method across cloud, edge, and vehicle platforms, providing progressively simplified yet effective AI driving models tailored to available computing resources and operational constraints.

As used herein, the term “hierarchical knowledge transfer” refers to methods of systematically transferring insights, features, parameters, or knowledge representations from larger AI models hosted on cloud or edge platforms down to smaller, vehicle-centric AI models, providing resource-efficient, optimized, and adaptive vehicle-level autonomous operations.

As used herein, the term “parameter” refers to a set of learnable numerical values that define how the model processes data and generates outputs. In some embodiments, a parameter is categorized as an AI model parameter. In some embodiments, a parameter is categorized as a “vehicle parameter”. And in some embodiments, a parameter is categorized as a “operational design domain (ODD) parameter.”

As used herein, the term “element” refers to a logically or functionally distinct component, module, or part of a system, structure, or model that performs a specific role or contributes to a specific capability of the system. In some embodiments, an element may be implemented in software, hardware, or a combination thereof. In some embodiments, an “element” may refer to a component of an AI model that encapsulates certain functional tasks (e.g., sensing, planning, control), a module or building block of a parameter allocation subsystem, or a sub-portion of a parameter category (e.g., vehicle-based model element, roadway parameter element).

In some embodiments, an element may be categorized based on its function or its operational location.

As used herein, a “driving model element” refers to an AI model element configured or trained to perform one or more autonomous driving tasks, such as sensing, perception, fusion, localization, prediction, planning, decision-making, and/or control.

As used herein, a “vehicle-based model element” refers to an AI model element that operates on the vehicle system or onboard units (OBUs) and is configured to use vehicle-collected data for autonomous driving functions. The vehicle-based model element involves model parameters deployed, executed, and/or updated within the vehicle.

As used herein, an “out-of-vehicle-based model element” refers to an AI model element that operates outside the vehicle, including but not limited to roadside systems (e.g., RSUs), edge systems, TCC/TCU systems, and/or cloud systems, and is configured to use infrastructure-side or cloud-side data to assist autonomous driving. The out-of-vehicle-based model element involves model parameters that are deployed, processed, or updated beyond the vehicle's onboard system.

As used herein, a “model combination element” refers to an AI model element that integrates, coordinates, or switches among multiple AI sub-models (e.g., from vehicle-based and out-of-vehicle-based domains) to provide cooperative or hybrid decision-making for autonomous driving.

Each element may contain or be associated with distinct parameters, and may be individually subject to parameter collection, allocation, deployment, and/or update by the parameter allocation subsystem.

As used herein, the term “AI model parameter” refers to a set of learnable numerical values that defines how the AI model processes input data to generate outputs. These parameters provide the model to perform tasks such as sensing, perception, data fusion, prediction, planning, decision making, and control. In some embodiments, an AI model parameter is categorized as a fundamental model parameter, a training and optimization parameter, and/or a deployment and adaption parameter. As used herein, a “fundamental model parameter” refers to the basic building blocks of the AI model that directly transform inputs into outputs, including but not limited to model weights, bias terms, normalization parameters, and specialized module parameters. As used herein, a “training and optimization parameter” refers to parameters that control the learning process of the AI model and the adjustment of its fundamental model parameters, including but not limited to meta-parameters (e.g., momentum, weight decay) and hyperparameters (e.g., learning rate, batch size, number of epochs, optimizer selection). As used herein, a “deployment and adaptation parameter” refers to parameters that are optimized for the model's operation in various deployment scenarios, ensuring efficient performance under different computational resource conditions, including but not limited to quantization/compression parameters and deployment-specific parameters.

As used herein, the term “vehicle parameter” refers to parameters that describes the vehicle's internal state and operation. In some embodiments, a vehicle parameter is categorized as a vehicle status parameter and/or an operation information parameter. As used herein, a “vehicle status parameter” refers to parameters that describe the current physical and operational state of the vehicle, including but not limited to kinematic parameters (e.g., vehicle speed, acceleration, angular velocity, and yaw rate), position and orientation parameters (e.g., GPS coordinates, heading, pitch, and roll), powertrain and engine parameters (e.g., engine RPM, temperature, fuel or battery level, and torque), and mechanical and diagnostic parameters (e.g., tire pressure, suspension status, and diagnostic trouble codes). As used herein, an “operation information parameter” refers to parameters that provide information regarding the control, guidance, navigation, and operational mode of the vehicle, including but not limited to control information parameters (e.g., throttle, brake, steering angle, and lateral/longitudinal placement), guidance information parameters (e.g., vehicle maneuvers, safety maintenance, and traffic interaction data), navigation information parameters (e.g., pre-trip information and route planning details), and operational mode parameters (e.g., driving mode and activation status of specific systems).

As used herein, the term “operational design domain (ODD) parameter” refers to parameters that describe the external conditions and objects in the vehicle's surroundings that may affect its operation. In some embodiments, an ODD parameter is categorized as a roadway parameter, an objects parameter and/or a driving environment parameter. As used herein, a “roadway parameter” refers to parameters that describe the physical characteristics of the road and its surrounding infrastructure, including but not limited to lane marking (e.g., color, reflectivity, width, continuity, and condition), signing (e.g., type, placement, condition, and visibility), pavement condition (e.g., surface quality, roughness, skid resistance, cracks, and potholes), road geometry (e.g., lane width, curvature, grade, and intersection design), roadside infrastructure (e.g., guardrails, medians, sidewalks, shoulders, and curbs), traffic control elements (e.g., traffic signals, crosswalks, stop lines, and speed control devices), and environmental and lighting conditions (e.g., roadway lighting and surface reflectivity). As used herein, an “objects parameter” refers to parameters that describe the various objects present on or near the roadway that may affect vehicle operation, including but not limited to vehicles (e.g., motorcars, trucks, buses), people (e.g., pedestrians), bikers (e.g., cyclists), animals, dropped objects (e.g., debris or spilled cargo), construction and temporary objects (e.g., construction cones, temporary barriers, maintenance equipment), miscellaneous road obstructions (e.g., fallen tree branches, rocks, debris, litter), and other mobile objects. As used herein, a “driving environment parameter” refers to parameters that capture external dynamic conditions which may affect vehicle operation, including but not limited to weather (e.g., precipitation, wind conditions, ambient temperature, snowstorm, heavy rain, and other adverse weather), light (e.g., visibility conditions, sunlight or glare, artificial lighting, and time of day), and event (e.g., work zone, traffic incidents, crash, special events, road construction, near-miss, railway cross, and hazard evacuation).

1-199. (canceled)

200. A distributed Artificial Intelligence (AI) system for an Autonomous Vehicle (AV), comprising an AI Allocation Subsystem and an Operating and Management Subsystem, configured to be personalized for the AV's operation,
wherein the AI system is configured to be hosted on the AV;
wherein the AI system is configured to apply a distillation method to refine trip parameters for decision-making;
wherein the AI Allocation Subsystem comprises a Computing Power Allocation Module, a Data Allocation Module, a Model Allocation Module, and a Parameter Allocation Module;
wherein the Computing Power Allocation Module comprises a Dynamic Computing Power Allocation Submodule comprising an External Change Identification Unit and a Distillation Unit;
wherein the Dynamic Computing Power Allocation Submodule is configured to allocate computing power of computing resources of other vehicles, and cloud computing resources;
wherein the External Change Identification Unit is configured to detect and evaluate variations of external environment conditions, comprising event-specific conditions and unexpected scenarios, and wherein the Distillation Unit is configured to customize allocation of cloud computing resources based on specific vehicle conditions for distribution of computing resources;
wherein the unexpected scenarios comprise construction and/or accidents;
wherein the Model Allocation Module is configured to allocate a vehicle-specific model, and provide a customized model allocation that is vehicle-specific for the AV's operation, using the distillation method for refining computing resource distributions;
wherein the distillation method is configured to use a Knowledge Extraction method by providing large AI models on a cloud for processing sensor data, generating soft labels and inference backups for the AV; and to use an Adaptive Distillation method by providing small AI models in the AV for receiving compressed, quantized knowledge from the cloud for real-time decision-making.

201. The system of claim 200, wherein the Data Allocation Module is configured to allocate vehicle data and operational design domain (ODD) data to a vehicle-specific scenario, and wherein the Data Allocation Module comprises a Data Allocation Unit and a Distillation Preparation Unit,
wherein the Data Allocation Module is configured to provide a customized and/or personalized data allocation for the AV;
wherein the customized and/or personalized data allocation is configured to be achieved using the distillation method for refining data distributions;
wherein the Data Allocation Unit is configured to update the allocation process in response to real-time system demands; and
wherein the Distillation Preparation Unit is configured to prepare training and validation data for a vehicle-specific model.

202. The system of claim 200, wherein the Model Allocation Module comprises a Vehicle-centric Model Deployment Allocation Submodule and a Vehicle-centric Model Training Allocation Submodule,
wherein the Vehicle-centric Model Deployment Allocation Submodule comprises a Vehicle-specific Model Allocation Unit and a Distillation Unit; and
wherein the Vehicle-centric Model Training Allocation Submodule comprises a Scenario-Aware Model Allocation Unit, a Vehicle-specific Model Allocation Unit, and a Distillation Unit.

203. The system of claim 200, wherein the Model Allocation Module is configured to implement an on-board model training and deployment method for autonomous driving by using one of the following approaches:
a) approach 1: on-board training and deployment operate exclusively on a vehicle-based computing platform by using a real-time update method and/or a dynamic update method, allowing the AI driving model's parameters and operative version to be refined and/or applied in real time or dynamically solely through in-vehicle resources; and
b) approach 2: on-board deployment with out of vehicle training is performed, wherein the AV maintains a locally deployed AI driving model for real-time or dynamic operation by using a real-time update method and/or a dynamic update method, while training tasks are offloaded to out of vehicle resources comprising an edge, idle vehicle, or cloud, that provide real-time or dynamic updates of model parameters or data.

204. The system of claim 200, wherein the Parameter Allocation Module comprises a Parameter Allocation Submodule and a Parameter Update Submodule for the AV, and wherein the Parameter Allocation Module is configured to apply customized and/or personalized parameter allocation for vehicle-specific scenarios for the AV's operation,
wherein said parameters comprise one or more of AI model parameters, vehicle parameters, and ODD parameters;
wherein the AI model parameters comprise a set of learnable numerical values that define how an AI model processes data and generates outputs;
wherein the vehicle parameters comprise one or more of vehicle status parameters and operation information parameters; and
wherein the ODD parameters comprise one or more of roadway parameters, object parameters, and driving environment parameters.

205. The system of claim 200, wherein the Operating and Management Subsystem comprises one or more of a Coordination and Optimization Module and an Execution Module;
wherein the Coordination and Optimization Module comprises a Coordination Submodule and an Optimization Submodule;
wherein the Coordination Submodule is configured to organize, manage, and sequence the execution of tasks based on resources that have already been allocated;
wherein the Optimization Submodule is configured to ensure that the allocated resources are used to execute tasks; and
wherein the Coordination and Optimization Module is configured for integration into the AV to manage AI models, computing power, and data.

206. The system of claim 200, wherein the AI system comprises one or more of a Communication Component, a Computing Component, a Power Supply Component, and a Sensing Component,
wherein the Communication Component is configured to provide real-time data exchange, comprising one or more of advanced cellular networks (4G, 5G, 5.5G, 6G), Bluetooth, Wi-Fi, and/or satellite communication, enabling the AI system to be deployed and updated in the AV using a real-time update method; and
wherein the Communication Component is configured to provide dynamic data exchange, comprising one or more of advanced cellular networks (4G, 5G, 5.5G, 6G), Bluetooth, Wi-Fi, and/or satellite communication, enabling the AI system to be deployed and updated in the AV using a dynamic update method.

207. A distributed Artificial Intelligence (AI) system for an Autonomous Vehicle (AV), comprising an AI Allocation Subsystem and an Operating and Management Subsystem, configured to be personalized for the AV's operation,
wherein the AI system is configured to be hosted on the AV;
wherein the AI system is configured to apply a distillation method to refine trip parameters for decision-making;
wherein the AI Allocation Subsystem comprises a Distillation Unit, configured to customize the allocation of cloud computing resources based on specific vehicle conditions for distribution of computing resources;
wherein the AI Allocation Subsystem is configured to allocate a vehicle-specific model, and provide a customized model allocation that is vehicle-specific for the AV's operation, using the distillation method for refining computing resource distributions;
wherein the distillation method is configured to use a Knowledge Extraction method by providing large AI models on a cloud for processing sensor data, generating soft labels and inference backups for the AV; and to use an Adaptive Distillation method by providing small AI models in the AV for receiving compressed, quantized knowledge from the cloud for real-time decision-making.

208. The system of claim 207, wherein the AI Allocation Subsystem further comprises one or more of a Computing Power Allocation Module, a Data Allocation Module, a Model Allocation Module, and a Parameter Allocation Module.

209. The system of claim 208, wherein the AI Allocation Subsystem comprises a Data Allocation Module, the Data Allocation Module configured to allocate vehicle data and operational design domain (ODD) data to a vehicle-specific scenario, and wherein the Data Allocation Module comprises a Data Allocation Unit and a Distillation Preparation Unit,
wherein the Data Allocation Module is configured to provide a customized and/or personalized data allocation for the AV;
wherein the customized and/or personalized data allocation is configured to be achieved using the distillation method for refining data distributions;
wherein the Data Allocation Unit is configured to update the allocation process in response to real-time system demands; and
wherein the Distillation Preparation Unit is configured to prepare training and validation data for a vehicle-specific model.

210. The system of claim 208, wherein the AI Allocation Subsystem comprises a Model Allocation Module, the Model Allocation Module comprising a Vehicle-centric Model Deployment Allocation Submodule and a Vehicle-centric Model Training Allocation Submodule,
wherein the Vehicle-centric Model Deployment Allocation Submodule comprises a Vehicle-specific Model Allocation Unit and a Distillation Unit; and
wherein the Vehicle-centric Model Training Allocation Submodule comprises a Scenario-Aware Model Allocation Unit, a Vehicle-specific Model Allocation Unit, and a Distillation Unit.

211. The system of claim 208, wherein the AI Allocation Subsystem comprises a Model Allocation Module, the Model Allocation Module configured to implement an on-board model training and deployment method for autonomous driving by using one of the following approaches:
a) approach 1: on-board training and deployment operate exclusively on a vehicle-based computing platform by using a real-time update method and/or a dynamic update method, allowing the AI driving model's parameters and operative version to be refined and/or applied in real time or dynamically solely through in vehicle resources; and
b) approach 2: on-board deployment with out of vehicle training is performed, wherein the AV maintains a locally deployed AI driving model for real-time or dynamic operation by using a real-time update method and/or a dynamic update method, while training tasks are offloaded to out-of-vehicle resources comprising an edge, idle vehicle, or cloud, that provide real-time or dynamic updates of model parameters or data.

212. The system of claim 208, wherein the AI Allocation Subsystem comprises a Parameter Allocation Module, the Parameter Allocation Module comprising a Parameter Allocation Submodule and a Parameter Update Submodule for the AV, and wherein the Parameter Allocation Module is configured to apply customized and/or personalized parameter allocation for vehicle-specific scenarios for the AV's operation,
wherein said parameters comprise one or more of AI model parameters, vehicle parameters, and ODD parameters;
wherein the AI model parameters comprise a set of learnable numerical values that define how an AI model processes data and generates outputs;
wherein the vehicle parameters comprise one or more of vehicle status parameters and operation information parameters; and
wherein the ODD parameters comprise one or more of roadway parameters, object parameters, and driving environment parameters.

213. The system of claim 207, wherein the Operating and Management Subsystem comprises one or more of a Coordination and Optimization Module and an Execution Module;
wherein the Coordination and Optimization Module comprises a Coordination Submodule and an Optimization Submodule;
wherein the Coordination Submodule is configured to organize, manage, and sequence the execution of tasks based on resources that have already been allocated;
wherein the Optimization Submodule is configured to ensure that the allocated resources are used to execute tasks; and
wherein the Coordination and Optimization Module is configured for integration into the AV to manage AI models, computing power, and data.

214. A distributed Artificial Intelligence (AI) system for an Autonomous Vehicle (AV), comprising an AI Allocation Subsystem and an Operating and Management Subsystem, configured to be personalized for the AV's operation,
wherein the AI system is configured to be hosted on the AV;
wherein the AI system is configured to apply a distillation method to refine trip parameters for decision making;
wherein the AI system comprises a Distillation Unit for Computing, configured to customize the allocation of cloud computing resources based on specific vehicle conditions for distribution of computing resources;
wherein the AI system comprises a Distillation Unit for AI models, configured to refine AI driving models using on-board or out of vehicle computing resources, applying adaptive learning mechanisms to incorporate new data, reduce model complexity when necessary, and maintain safety margins;
wherein the AI system is configured to allocate a vehicle-specific model, and provide a customized model allocation that is vehicle-specific for the AV's operation, using the distillation method for refining computing resource distributions;
wherein the distillation method is configured to use a Knowledge Extraction method by providing large AI models on a cloud for processing sensor data, generating soft labels and inference backups for the AV; and to use an Adaptive Distillation method by providing small AI models in the AV for receiving compressed, quantized knowledge from the cloud for real-time decision-making.

215. The system of claim 214, wherein the AI Allocation Subsystem comprises one or more of a Computing Power Allocation Module, a Data Allocation Module, a Model Allocation Module, and a Parameter Allocation Module.

216. The system of claim 215, wherein the AI Allocation Subsystem comprises a Data Allocation Module, the Data Allocation Module configured to allocate vehicle data and operational design domain (ODD) data to a vehicle-specific scenario, and wherein the Data Allocation Module comprises a Data Allocation Unit and a Distillation Preparation Unit,
wherein the Data Allocation Module is configured to provide a customized and/or personalized data allocation for the AV;
wherein the customized and/or personalized data allocation is configured to be achieved using the distillation method for refining data distributions;
wherein the Data Allocation Unit is configured to update the allocation process in response to real-time system demands; and
wherein the Distillation Preparation Unit is configured to prepare training and validation data for a vehicle-specific model.

217. The system of claim 215, wherein the AI Allocation Subsystem comprises a Model Allocation Module, the Model Allocation Module comprising a Vehicle-centric Model Deployment Allocation Submodule and a Vehicle-centric Model Training Allocation Submodule,
wherein the Vehicle-centric Model Deployment Allocation Submodule comprises a Vehicle-specific Model Allocation Unit and a Distillation Unit; and
wherein the Vehicle-centric Model Training Allocation Submodule comprises a Scenario-Aware Model Allocation Unit, a Vehicle-specific Model Allocation Unit, and a Distillation Unit.

218. The system of claim 215, wherein the AI Allocation Subsystem comprises a Parameter Allocation Module, the Parameter Allocation Module comprising a Parameter Allocation Submodule and a Parameter Update Submodule for the AV, and wherein the Parameter Allocation Module is configured to apply customized and/or personalized parameter allocation for vehicle-specific scenarios for the AV's operation,
wherein said parameters comprise one or more of AI model parameters, vehicle parameters, and ODD parameters;
wherein the AI model parameters comprise a set of learnable numerical values that define how an AI model processes data and generates outputs;
wherein the vehicle parameters comprise one or more of vehicle status parameters and operation information parameters; and
wherein the ODD parameters comprise one or more of roadway parameters, object parameters, and driving environment parameters.

219. The system of claim 214, wherein the Operating and Management Subsystem comprises one or more of a Coordination and Optimization Module and an Execution Module;
wherein the Coordination and Optimization Module comprises a Coordination Submodule and an Optimization Submodule;
wherein the Coordination Submodule is configured to organize, manage, and sequence the execution of tasks based on resources that have already been allocated;
wherein the Optimization Submodule is configured to ensure that the allocated resources are used to execute tasks; and
wherein the Coordination and Optimization Module is configured for integration into the AV to manage AI models, computing power, and data.
